(19) United States
(12) Patent Application Publication
(10) Pub. No.: US 2021/0012425 A1
(43) Pub. Date: Jan. 14, 2021

(54) COMPUTER-IMPLEMENTED SYSTEM AND METHOD FOR NON-PRICE BASED INDEXATION IN AUTOMATED PASSIVE ASSET MANAGEMENT

(71) Applicant: Peter J. Johansson, Greenwich, CT (US)

(72) Inventor: Peter J. Johansson, Greenwich, CT (US)

(21) Appl. No.: 16/888,042

(22) Filed: May 29, 2020

Related U.S. Application Data
(63) Continuation-in-part of application No. 16/221,374, filed on Dec. 14, 2018.
Application No. 16/221,374 is a continuation of application No. 14/687,879, filed on Apr. 15, 2015, now abandoned.
Application No. 14/687,879 is a continuation-in-part of application No. 11/957,703, filed on Dec. 17, 2007, now abandoned.
(60) Provisional application No. 60/871,676, filed on Dec. 22, 2006.

(51) Int. Cl. G06Q 40/06; G06F 16/22

(52) U.S. Cl. CPC G06Q 40/06; G06F 16/2291

(57) ABSTRACT

Passively managed portfolios (also known as passive asset management) rely on computer technology to provide for improved cost efficiency which in turn improves investment performance over actively managed portfolios (also known as active asset management). However, standard market capitalization weighted indexes, commonly employed in passive asset management, such as in index funds and exchange traded funds (ETFs), suffer from behavioral systematic biases. A new category of indexes used in passive asset management has emerged, known as alternative or smart beta indexes. Aspects provide for a process that provides for a solution to behavioral biases in market cap weighting while improving performance and cost efficiency in existing smart beta indexes. Other aspects provide for an improved selection process that improves over the conventional industry standards. Other aspects provide for useful tools, processes, methods and procedures that useful in conjunction with some embodiments.

### RELATED APPLICATIONS

This application is a Continuation-in-part of U.S. application Ser. No. 16/221,374, filed Dec. 14, 2018, entitled “COMPUTER-IMPLEMENTED METHOD FOR PORTFOLIO CONSTRUCTION AND INDEXATION OF SECURITIES UNDER A NOISY MARKET HYPOTHESIS”, which is a Continuation of U.S. application Ser. No. 14/687,879, filed Apr. 15, 2015, entitled “COMPUTER-IMPLEMENTED METHOD FOR PORTFOLIO CONSTRUCTION AND INDEXATION OF SECURITIES UNDER A NOISY MARKET HYPOTHESIS”, which is a Continuation-in-part of U.S. application Ser. No. 11/957,703, filed Dec. 17, 2007, entitled “SYSTEM AND METHOD FOR DETERMINING PROFITABILITY OF STOCK INVESTMENTS”, which is a Non-Provisional of Provisional (35 USC 119(e)) of U.S. Application Ser. No. 60/871,676, filed Dec. 22, 2006, entitled “SYSTEM AND METHOD FOR DETERMINING PROFITABILITY OF STOCK INVESTMENTS” which is incorporated herein by reference in its entirety.

### TECHNICAL FIELD

Aspects of some embodiments relate generally to automated passive asset management and indexation, methods and techniques thereof.

### BACKGROUND

Automated passive asset management, i.e., index funds and exchange traded funds, and smart-beta indexation rests on a machine-implemented technology process, to allow for improved cost efficiency in the asset management industry. Conventionally, there are two broad categories of securities portfolio management. One is active management which refers to the human element, such as a single manager, co-managers or a team of managers, to actively make the decisions for selection and weighting and managing an investment portfolio. The other category is passive management, also called indexing, which uses a machine-implemented technology in a systematic or rules based process for portfolio selection and weighting. The securities in a passive portfolio management are conventionally weighted by relative market capitalization weighting. However, there are problems with both these alternatives. Active management comes with higher costs and for that reason commonly underperforms passively managed index funds. Conventional market cap-weighted indexes build on the assumption of the efficient market hypothesis (EMH) but stock markets may not always be rational or efficient. As a result, market cap-weighted indexes that rely on stock price as the only indicator of fundamental value by design overweight all overpriced stocks and underweighted in undervalued stocks, exposing investors to a sub-optimal portfolio. Smart beta (non-price based) indexation of securities improves upon conventional passive asset management (which are based on market cap weighted indexes) by removing behavioral (human) biases.

### SUMMARY

The present invention, as disclosed in various embodiments herein, improves upon existing machine implemented smart beta indexes by providing for a particular solution to problems, (referred to as unintended systematic biases) by allowing for determination of index weights for individual securities, considering multiples factor in a particular way independent from a price, which in turn provides for improved accuracy, improved liquidity, reduced tracking errors, reduced implementations costs, and reducing capacity constraints, relative exiting machine implemented smart beta indexes.

For the purpose of portfolio selection and weighting of securities, it is appreciated that conventional asset pricing models and existing valuation models are impractical applications in passive asset management as they fail to adequately determine a fundamental value for individual securities. This problem in turn leads to suboptimal implementation characteristics, such as suboptimal tracking errors and turnover costs. These standard models include; the Capital Asset Pricing Model (CAPM), the Discounted Cash Flow Model (DCF), and the Dividend Discount Model (DDM) and Fama and French three and five factor models.

For that reason, a new category of portfolio construction in passive asset management has emerged. This new category is commonly referred to as factor indexing or smart beta indexing. The important high level objective of smart beta indexation is to develop index weights that reflects individual stocks (as well as the index as a whole) fundamental value independent for the market price. Early adoption of factor investing did not attempt to solve the problem in asset pricing but rather focused on anomalous factors found merely in empirical observations. It is appreciated that these smart beta portfolios (typically referred to as single factor portfolios or indexes) commonly suffer from suboptimal portfolio characteristics, such as lower liquidity, lower investment capacity and higher turnover costs relative market cap weighted indexes. Another disadvantage is that single factor indexes typically exhibit performance cyclicality which typically lead to long periods of underperformance relative to a market cap weighted index. Another problem includes timing. Most investors avoid timing decisions given their inherent difficulty. For that reason, a key part of the decision process includes implementing factor allocations to avoid factor cyclicality.

To solve these problems, market practitioners, index providers and the like, focuses on developing multifactor indexes in where two or more factors are combined. Multifactor portfolios (also known as multifactor indexes) have the advantage of relying on multiple factor premiums designed to reduce the performance cyclicality of single factor indexes. A highly desired factor combination among investors are a combination of value, (i.e., overweighting or selecting undervalued stocks), low volatility (i.e., low risk), high quality (e.g., high profitability) and high yields (e.g., high dividends). Multifactor indexes are typically constructed using scoring methodologies and where each factor is scored and where the stock's that exhibits the highest scores are selected and receives the highest weight in the index. However, combining the value factor with performance and quality factors, such as low volatility, high profitability and high growth (or momentum) using scoring methodologies is problematic. The problem arises because value and performance (or quality) factors are uncorrelated factors and for that reason clashes (or opposes each other) making the combined factor premiums to cancel out each other. Consequently, combining the value factor with performance and quality factors, such as high growth, high profitability and low volatility, leads to unintended factor biases as these factors opposes each other, i.e., value factor scores high on low performance (e.g., low growth) and low quality stocks (e.g., low profitability) and the performance and quality factors scores high on these factors leading to final scores that effectively cancel out.

It is appreciated herein that the problem can be found in the conventional value factor (as defined by common valuation multiples, such as the P/E or P/B or a combination of such factors). It is appreciated herein that a security's accounting based fundamental size factors, such as earning (E) or book value (B), or a combination of such factors, does not represent a valid proxy for a stocks fundamental value. The important and related problem of combining the conventional value factor with performance and quality factor in multifactor portfolios (or indexes) is that the resulting portfolio exhibits undesirable implementation characteristics, such as considerably higher annual turnover (and thus higher transaction costs) and considerably lower investment capacity relative to market cap weighted indexes.

According to some aspects, a non-priced based weighting technique of securities is desired is a that allows determining a fundamental value that improves implementation costs, such as providing for higher liquidity, higher investment capacity, lower tracking error, and lower turnover costs relative existing methods and systems. As described in various embodiments herein, an automated non-price based weighting technique is implemented in a special-purpose computer-based system for implementing passive asset management. Passive asset management is a computer-implemented system (non-human) that focuses on reducing costs. Such a system improves over existing non-price based systems in passive asset management by allowing for lower tracking errors which in turn allows for lower turnover costs. The system performs turnover rebalancing faster which recues processing times and memory capacity and thus an improved passive management computer system results.

In some embodiments, what is desired is an improved system and method for selecting and weighting individual securities in an investment portfolio that overcomes one or more shortcomings of existing solutions. More particularly, in some embodiments, what is needed is a new smart beta portfolio weighting technique, that can determine a discount rate, and a fundamental value, which in turn can explain the expected returns across securities exhibiting heterogeneous risk and reward characteristics enabling investors using a resulting portfolio for improved accuracy (and sustainability) in capturing the valuation premium in securities markets while reducing implementation costs over existing system and methods.

What is furthermore desired is a smart beta, i.e., non-priced based, weighting and selection technique that solves the problem of factor clashing in exiting techniques in combining valuation with performance and quality factors allowing for the creation of style indexes (such as value and growth) that overweight underpriced securities and underweights overpriced securities while improving implementation costs over existing smart beta selection and weighting techniques. Moreover, it is desired in a smart beta, i.e., non-priced based, is a weighting and selection technique that allows creating multiple smart beta indexes from a broad (all inclusive) smart beta index (i.e., in where all stocks for a universe of stocks are included), allowing to generate so called style indexes and other desired smart beta indexes without having to redesign index weights, allowing for improved cost efficiency on an overall portfolio of indexes, such indexes may include smart beta growth and value indexes, low volatility indexes, high dividend growth indexes, equity-fixed asset allocation indexes. What is further desired is a smart beta selection and weighting technique that allows bisecting a broad equity universe into growth and value indexes, that provides for a solution to the bleeding problem inherent in conventional methods while retaining high liquidity, high investment capacity and low annual turnover improving over existing smart beta systems and methods.

According to one aspect a portfolio management engine is provided. The engine comprises at least one computer processor, and a non-transitory computer-readable storage medium containing instructions that, when executed by the at least one processor, cause the portfolio management engine to automatically perform operations obtaining, in real-time, factor data updates for one or more securities from one or more data sources (e.g., a proprietary data source), determining, in real-time, values using the obtained factor data updates for the one or more securities, the value determination, for each one of the one or more securities, determining a unit factor volatility using a factor data update for the each one of the one or more securities, determining a discount rate using the unit factor volatility, determining a factor value for the each one of the one or more securities using the factor data update for the each one of the one or more securities, determining the value for the each one of the one or more securities by discounting the size factor value by the discount rate, and providing, in real-time, instructions based on the determined values to a financial services system to adjust an allocation of the one or more securities in a portfolio by executing transactions with the financial services system.

According to one embodiment the factor data update for the each one of the one or more securities comprises a plurality of sub-factor updates, and determining the unit factor volatility comprises generating a composite factor from the plurality of sub-factor updates. According to one embodiment, determining the unit factor volatility comprises determining a factor change over a time interval and a factor volatility over the time interval using the factor data update for the each one of the one or more securities. According to one embodiment, determining the factor change over the time interval comprises determining a compound annual growth rate, a mean growth rate, a median growth rate, or a mode growth rate over the time interval. According to one embodiment, determining the factor volatility comprises determining a plurality of factor changes for sub-intervals of the time interval, and determining the factor volatility as a standard deviation or a semi-deviation of the plurality of factor changes. According to one embodiment, determination of the discount rate further uses a risk-free rate. According to one embodiment, the discount rate does not depend on a share price of the each one of the one or more securities. According to one embodiment, determining the value for the each one of the one or more securities comprises determining the value as the greater of (i) the size factor value discounted by the discount rate, and (ii) a second value determined using a book value for the each one of the one or more securities, wherein the book value is obtained from the proprietary data source.

According to one embodiment, determining the value for the each one of the one or more securities comprises, determining an accumulated distribution value for the each one of the one or more securities over a time interval using distribution information received from the proprietary data source, and determining the value as a sum of (i) the size factor value discounted by the discount rate, and (ii) the accumulated distribution value. According to one embodiment, the operations further comprises monitoring prices for the one or more securities in real-time, based on a determined value and corresponding monitored price for a first security of the one or more securities, providing instructions to a user device to provide an alert via a graphical user interface, the alert indicating the first security, and receiving, from the user device in response to the alert, instructions to execute a transaction with the financial services system concerning the first security. According to one embodiment, the one or more securities includes two or more securities, and the operations further comprise transmitting instructions to a user device to display the two or more securities in a graphical user interface in a descending order of determined value. In some embodiments, distributions are added to both the determined fundamental value and the book value in a process of determining which value is the higher (i.e., selecting the greater of the values) 1) determined value+distributions and 2) book value+distributions.

According to one embodiment, the instructions to adjust the allocation of the one or more securities in the portfolio comprise instructions to replace a security in the portfolio when a determined value of the security is less than a price of the security. According to one embodiment, the security is replaced with an equal amount of one or more fixed income securities. According to one embodiment, the operations further comprises determining the instructions to adjust the allocation of the one or more securities in the portfolio using, the determined values for the one or more securities in the portfolio, and a constant value selected to reduce concentration risk for the portfolio. According to one embodiment, the operations further comprises determining the instructions to adjust the allocation of the one or more securities in the portfolio using valuation premiums for the one or more securities in the portfolio. According to one embodiment, determining the instructions to adjust the allocation of the one or more securities in the portfolio comprises adding the valuation premiums and respective determined values for the one or more securities in the portfolio. According to one embodiment, determining the value for the each one of the one or more securities further comprises determining a factor change over a time interval using the factor data update for the each one of the one or more securities, and the operations further comprises determining forward values for the one or more securities using the determined values for the one or more securities, the determined factor changes for the one or more securities, and a number of time intervals, and determining the instructions to adjust the allocation of the one or more securities in the portfolio using the forward values.

According to one aspect, a method of portfolio management performed by a portfolio management engine comprising at least one computer processor is provided. The system and)method comprises obtaining, by the portfolio management engine in real-time, factor data updates for one or more securities from a one or more proprietary data sources, determining, by the portfolio management engine in real-time, values using the obtained factor data updates for the one or more securities, the value determination, for each one of the one or more securities, comprises determining a factor change over a time interval and a factor volatility over the time interval using a factor data update for the each one of the one or more securities, determining a discount rate using the unit factor volatility and a risk free rate, determining a factor value for the each one of the one or more securities using the factor data update for the each one of the one or more securities, determining the value for the each one of the one or more securities by discounting-the size factor value by the discount rate, and providing, by the portfolio management engine in real-time, instructions based on the determined values to a financial services system to adjust an allocation of the one or more securities in a portfolio by executing transactions with the financial services system.

According to one embodiment, the method further comprises determining the instructions to adjust the allocation of the one or more securities in the portfolio using the determined values for the one or more securities in the portfolio, and a constant value selected to reduce concentration risk for the portfolio.

According to one aspect, a non-transitory computer-readable storage medium containing instructions that, when executed by at least one processor cause a portfolio management engine to automatically perform operations is provided. The system comprises obtaining, by the portfolio management engine in real-time, factor data updates for one or more securities from one or more proprietary data sources, determining, by the portfolio management engine in real-time, values using the obtained factor data updates for the one or more securities, the value determination, for each one of the one or more securities, comprising determining a factor change over a time interval and a factor volatility over the time interval using a factor data update for the each one of the one or more securities, wherein determining the factor volatility comprises, determining a plurality of factor changes for sub-intervals of the time interval, determining the factor volatility as a standard deviation or a semi deviation of the plurality of factor changes, determining a discount rate using the unit factor volatility and a risk free rate, determining a factor value for the each one of the one or more securities using the factor data update for the each one of the one or more securities, determining the value for the each one of the one or more securities by discounting the size factor value by the discount rate, providing, by the portfolio management engine in real-time, instructions based on the determined values to a financial services system to adjust an allocation of the one or more securities in a portfolio by executing transactions with the financial services system.

According to one aspect, a portfolio management engine is provided. The engine comprises at least one computer processor, and a non-transitory computer-readable storage medium containing instructions that, when executed by the at least one processor, cause the portfolio management engine to automatically perform operations comprising obtaining, in real-time, factor data updates for one or more securities from a one or more proprietary data sources, determining, in real-time, adjusted size factors using the obtained size factor data updates for the one or more securities, the adjusted size factor determination, for each one of the one or more securities, comprising determining a unit factor volatility using a factor data update for the each one of the one or more securities, determining a size factor value for the each one of the one or more securities using the factor data update for the each one of the one or more securities, determining the adjusted size factor for the each one of the one or more securities by discounting the obtained size factor value by a function of 1+the unit factor volatility, and providing, in real-time, instructions based on the determined adjusted size factors to a financial services system to adjust an allocation of the one or more securities in the non-price based index of securities by executing transactions with the financial services system.

According to one embodiment the factor data update for the each one of the one or more securities comprises a plurality of sub-factor updates, and determining the size factor value comprises generating a composite factor from the plurality of sub-factor updates. According to one embodiment, determining the size factor value comprises averaging factor values over a trailing period of time. According to one embodiment, determining the size factor for the each one of the one or more securities further comprises determining a factor change over a time interval using the factor data update for the each one of the one or more securities and the operations further comprise determining forward size factors for the one or more securities using the determined size factors for the one or more securities, the determined factor changes for the one or more securities, and a number of time intervals, and determining the instructions to adjust the allocation of the one or more securities in the portfolio using the forward size factors.

According to one embodiment, the operations further comprises determining a fundamental value for the each one of the one or more securities using the size factor for the each one of the one or more securities, a unit factor volatility and a risk free rate, and determining the instructions to adjust the allocation of the one or more securities in the portfolio using the fundamental values for the one or more securities. According to one embodiment, determining the fundamental value for the each one of the one or more securities comprises discounting the size factor for the each one of the one or more securities by a unit factor volatility factor and the risk free rate. According to one embodiment, determining the fundamental value for the each one of the one or more securities comprises determining a first value using the size factor for the each one of the one or more securities a unit factor volatility factor and the risk free rate, determining a second value using a book value for the each one of the one or more securities, the book value received from the proprietary data source, and selecting the as the portfolio weight, the fundamental value for the each one of the one or more securities, the greater of the first value and the second value. According to one embodiment, determining the fundamental value for the each one of the one or more securities further comprises determining an accumulated distribution value for the each one of the one or more securities over a time interval using distribution information received from the proprietary data source, and determining the fundamental value for the each one of the one or more securities as the greater of the first value and the second value, and in where both the first and second value include an accumulated distribution value.

According to one embodiment, the operations further comprises monitoring prices for the one or more securities in real-time, based on a determined fundamental value and corresponding monitored price for a first security of the one or more securities, providing instructions to a user device to provide an alert via a graphical user interface, the alert indicating the first security, and receiving, from the user device in response to the alert, instructions to execute a transaction with the financial services system concerning the first security. According to one embodiment, the one or more securities includes two or more securities, and the operations further comprises transmitting instructions to a user device to display the two or more securities in a graphical user interface in a descending order of determined fundamental value. According to one embodiment, the instructions to adjust the allocation of the one or more securities in the portfolio comprise instructions to replace a first security in the portfolio when a determined fundamental value of the first security is less than a price of the first security. According to one embodiment, the first security is replaced with an equal amount of one or more fixed income securities.

According to one embodiment, the operations further comprises determining a fundamental value for the each one of the one or more securities using the size factor for the each one of the one or more securities, a unit factor volatility and a risk free rate, determining an active valuation weight for the each one of the one or more securities using the fundamental value for the each one of the one or more securities and a valuation premium for the each one of the one or more securities, and determining the instructions to adjust the allocation of the one or more securities in the portfolio using the active valuation weights for the one or more securities. According to one embodiment, determining the active valuation weight for the each one of the one or more securities comprises adding the respective fundamental values and valuation premiums for the one or more securities. According to one embodiment, determining the unit factor volatility comprises determining a factor change over a time interval and a factor volatility over the time interval using the factor data update for the each one of the one or more securities. According to one embodiment, determining the factor change over the time interval comprises determining a compound annual growth rate, a mean growth rate, a median growth rate, or a mode growth rate over the time interval. According to one embodiment, determining the factor volatility comprises determining a plurality of factor changes for sub-intervals of the time interval, and determining the factor volatility as a standard deviation or a semi-deviation of the plurality of factor changes. According to one embodiment, the size factor does not depend on a share price of the each one of the one or more securities. According to one embodiment, the operations further comprises determining the instructions to adjust the allocation of the one or more securities in the portfolio using the determined size factors for the one or more securities in the portfolio, and a constant value selected to reduce concentration risk for the portfolio.

According to one aspect, a method of portfolio management performed by a portfolio management engine comprising at least one computer processor is provided. The method comprises obtaining, by the portfolio management engine in real-time, factor data updates for one or more securities from one or more proprietary data sources, determining, by the portfolio management engine in real-time, volatility adjusted size factors using the obtained factor data updates for the one or more securities, the volatility adjusted size factor determination, for each one of the one or more securities, comprising determining a unit factor volatility using a factor data update for the each one of the one or more securities, determining a volatility adjusted size factor value for the each one of the one or more securities using the factor data update for the each one of the one or more securities, determining the volatility adjusted size factor for the each one of the one or more securities by discounting the obtained size factor by a function of the unit factor volatility, and providing, by the portfolio management engine in real-time, instructions based on the determined volatility adjusted size factors to a financial services system to adjust an allocation of the one or more securities in a portfolio by executing transactions with the financial services system.

According to one embodiment, the method further comprises determining the instructions to adjust the allocation of the one or more securities in the portfolio using the determined volatility adjusted size factors for the one or more securities in the portfolio, and a constant value selected to reduce concentration risk for the portfolio.

According to one aspect, a non-transitory computer-readable storage medium containing instructions that, when executed by at least one processor, cause a portfolio management engine to automatically perform operations is provided. The system comprises obtaining, by the portfolio management engine in real-time, factor data updates for one or more securities from a one or more proprietary data sources, determining, by the portfolio management engine in real-time, adjusted size factors using the obtained factor data updates for the one or more securities, the adjusted size factor determination, for each one of the one or more securities, comprising determining a factor change over a time interval and a factor volatility over the time interval using the factor data update for the each one of the one or more securities, determining a unit factor volatility using the factor change and the factor volatility, determining a size factor value for the each one of the one or more securities using the factor data update for the each one of the one or more securities, determining the adjusted size factor for the each one of the one or more securities by discounting the obtained size factor by a function of the unit factor volatility, and providing, by the portfolio management engine in real-time, instructions based on the determined adjusted size factors to a financial services system to adjust an allocation of the one or more securities in a portfolio by executing transactions with the financial services system.

According to some embodiments, it is appreciated that methods for determining a discount rate has been the most difficult and inadequately performed tasks in asset pricing. The conventional and most widely used method for determining the discount rate is the capital asset pricing model (CAPM). However, mounting empirical evidences show that the CAPM cannot explain the discount rate and a fundamental value in a cross section of risky assets (such as stocks). The theoretical assumptions of the CAPM have been rejected by researchers, including efficient markets, positive relationship between risk and return in capital markets. After sixty years of research in asset pricing, it is appreciated that there is no accurate way to determine a discount rate. It is understood that without a valid discount rate investors cannot accurately determine what a stock (or portfolio of stocks) is reasonably worth (i.e., fundamental value), nor can they adequately allocate assets across stocks and bonds, or mitigate downside risk. In some embodiments described herein, the discount rate can be determined using a holistic multifactor method in which the method considers fundamental value generating factors. In some aspects, the discount rate is used to determine a fundamental value that improves explain the market price for individual stocks, in a cross section of value and growth stocks, under both an efficient and inefficient market hypothesis.

Some embodiments are generally directed to passive asset management and the aim of determining index weights representing a fundamental value for individual securities independent from investors' assessment, i.e., independent from a market price, and which provides for a practical application (i.e., which is particularly useful) under an inefficient market hypothesis (i.e., under the assumption that market prices are not fully efficient). Some embodiments solves problems inherent in conventional methods of determining smart beta index weights by utilizing a holistic multifactor method for determining a discount rate and a fundamental value independent from a price. The discount rate controls for individual securities heterogeneous factor characteristics independent from investor's assessment which allows for determining a fundamental value based on non-price fundamental factors. In some embodiments, improved methods of determining a discount rate may be primarily used in determining a fundamental value in smart beta indexation in passive asset management, but may also be used in trading systems, analytical systems and related systems.

Some embodiments disclosed herein provide methods for determining portfolio weights for individual securities using a holistic multifactor process allowing to dynamically overweight's stocks that exhibit, (i) higher than average growth, (ii) higher than average profitability, (iii) lower than average volatility and (iv) lower than average valuation. It is desired to construct a holistic multifactor portfolio that allows to capture a valuation premium not only in stocks that exhibit low valuation multiples, e.g., low P/E or P/B, but also in stocks that exhibit high valuation multiples, e.g., high P/E or P/B. It is desired that a resulting multifactor portfolio benefits from multiple compensated factor premium, including, but not limited to, high growth, high profitability, high distributions, low-volatility, and low valuation.

It is further desired in one or more embodiments to determining index weights for individual securities in the construction of a broad multifactor portfolio wherein all assets in an equity universe are included and wherein the resulting portfolio exhibits high liquidity, high investment capacity, low tracking error and low transaction costs. It further desired in one or more embodiments disclosed herein to select stocks for an resulting holistic multifactor portfolio that exhibit a profitability rate that equals or exceeds the stocks discount rate and further weight the resulting portfolio based on a determined adjusted size factor or by a determined fundamental value. It is appreciated herein that the various embodiments for determining portfolio weights using holistic multifactor method benefit investors by offering multiple compensated factor premiums, including a valuation premium that can be captured in all stocks regardless of investment style, i.e., regardless if a stock is classified as value (low valuation multiples), growth (high valuation multiples), large, mid or small capitalization stock.

In some embodiments, it is desired that a resulting investment portfolio retain the key benefits of a conventional market cap weighted index, including exposure to large cap stocks, broad participation in equity markets, and capturing the same opportunity set as market cap weighted portfolios by overweighting (tiling towards) highly liquid large cap-growth stocks, providing for low tracking errors, providing for high investment capacity and low annualized turnover costs, while providing for a solution to the problem inherent in market capitalization weighted portfolios (and other existing solutions) of overweighting overvalued stocks and underweighting undervalued stocks. Table 9 illustrates the portfolio tracking error, the determined fundamental value and valuation premium of one embodiment across 50 large cap growth stocks. It is appreciated herein that some embodiments, as disclosed herein, results in a portfolio, that exhibit a lower tracking error than existing (non-price based smart beta) solutions, such as fundamental weighing and equal weighting. These higher costs in existing solutions are commonly also referred to as high implementation costs of smart beta indexes over conventional market cap-weighted indexes.

One or more embodiments are directed to a system and method of constructing a holistic multifactor growth portfolio by selecting stocks that exhibit a profitability rate that is equal to or greater than the stock's determined discount rate and wherein the determined discount rate controls for individual stocks heterogeneous factor characteristics and macroeconomic factors independent from the stocks market price. In some embodiments, it is further desired that the resulting portfolio overweight's stocks that exhibit high growth, high profitability, and low valuation and underweight stocks that exhibit opposite factor characteristics. In some embodiments, it is desired that a resulting investment portfolio is fully scalable in domestic and global markets representing a significant universe of potential asset gathering and across different asset classes, such as stocks and fixed income securities.

In some aspects, a computer-based smart beta asset pricing model is provided as an executable computer system and method that is useful for determining a fundamental value under both an efficient, semi efficient and inefficient market hypothesis. Such a system and computer-based method provides a technical solution to a technical problem in passive asset management, as it provides for more accurate estimates for (individual securities), and by providing for a solution of systematic and unintended biases in the process of determining a fundamental value. This in turn provides for improved cost efficiency, by reducing tracking errors in smart beta passive asset management. It is contemplated that the technical solution may further be useful for improving automated trading systems, analytical systems and the like. Various embodiments of a computer system and computer-based processes and methods are provided for portfolio weighting and portfolio selection using holistic multifactor construction, are disclosed herein.

In one embodiment of a system and method and computer program product for determining index weights in passive asset management using a holistic multifactor construction method and using the determined index weights in smart beta indexation is disclosed, the method comprising the steps for each stock in the plurality of stocks: 1) obtaining a fundamental size factor at present time (t0); 2) computing a growth rate for a period of time (t0-t−n); 3) determining a volatility per unit growth rate at the present time (t0) by computing a deviation rate of the growth rate for the given stock for the period of time (t0-t−n), and then dividing the computed deviation rate by the computed growth rate; 4) determining a discount rate at the present time (t0) by (i) multiplying the determined volatility per unit growth rate by a Risk Free Rate at the present time (t0) and said multiplying generating a volatility premium, and (ii) adding the generated volatility premium to the Risk Free Rate at the present time (t0), said adding resulting in the determined discount rate at the present time (t0) for the given stock, such that the discount rate is determined exclusive of a market price of the given stock; 5) determining an earnings based fundamental value at the present time (t0) by dividing the fundamental size factor at the present time (t0) by the determined discount rate at the present time (t0); 6) generating a non-priced index of stocks by ranking, in descending order, each stocks in the universe of stocks, by its determined fundamental value.

In some embodiments, a solution is provided to the problem of systematic bias inherent in conventional market capitalization weighted portfolios of overweighting overvalued stocks and underweighting undervalued stocks in inefficient equity markets (i.e., providing for a solution to human behavioral or cognitive biases) by determining a fundamental value for each stock in the universe of stocks independent from each stocks market price (e.g., market capitalization). The fundamental value being derived from non-price based fundamental factors and where the volatility premium (and the discount rate) controls for individual stocks heterogeneous risk and reward characteristics independent from the markets (i.e., the collective of investors) assessment.

In another embodiment of a system and method and computer program product for determining index weights using a holistic multifactor construction is provided, the method comprising the steps for each stock in the universe of stocks: 1) obtaining a fundamental size factor at present time (t0); 2) computing a growth rate for a period of time (t0-t−n); 3) determining a volatility per unit growth rate at the present time (t0) by computing a deviation rate of the growth rate for the given stock for the period of time (t0-t−n), and then dividing the computed deviation rate by the computed growth rate; 4) determining a discount rate at the present time (t0) by (i) multiplying the determined volatility per unit growth rate by a Risk Free Rate at the present time (t0) and said multiplying generating a volatility premium, and (ii) adding the generated volatility premium to the Risk Free Rate at the present time (t0), said adding resulting in the determined discount rate at the present time (t0) for the given stock, such that the discount rate is determined exclusive of a market price of the given stock; 5) determining a fundamental value at the present time (t0) by dividing the fundamental size factor at the present time (t0) by the determined discount rate at the present time (t0); 6) determining an index weight, for each stock in the universe of stocks, by selecting the higher of (i) the determined fundamental value at present time (t0) and (ii) the last reported book value at present time (t0); 7) generating an non-price based investable index of stocks at present time (t0) by ranking, in descending order, each stocks in the universe of stocks, by its determined index weight.

The above embodiment avoids unintended factor bias in combining the valuation factor with uncorrelated factors; such as (i) growth, (ii) profitability and (iii) low-volatility in multifactor indexation. The present invention does that by determining a valuation factor that is defined as the positive difference between a stocks determined fundamental value and its market value. The valuation premium is captured by overweighting stocks that exhibit a determined fundamental value that is greater than its market value. It is appreciated herein that the valuation premium may be captured indirectly, that is, if a stocks determined fundamental value at present time (t0) is greater than its market value at present time (t0), the generated investment portfolio at present time (t0) will overweight this stock relative to how the market cap weighted index weight the stock, i.e., by its market capitalization. The embodiment furthermore provides a solution for unintended systematic biases inherent in fundamental weighted indexes; which overweight value stocks, i.e., stocks that exhibit low growth and low profitability. It is understood that by avoiding systematic biases inherent in cap-weighted indexes and unintended systematic factor bias in multifactor and fundamentally weighted indexes improve performance, reduce tracking errors, reduce turnover costs, improve liquidity and improve investment capacity.

Moreover the above embodiment allows for the construction of broad market smart-beta holistic multifactor investment portfolios that cover a broad investment universe and where all investment styles are included, such as value, blend, growth, small, mid and small cap stocks. Further, it is appreciated herein that these smart-beta holistic multifactor investment portfolios have a very similar investable opportunity set as investors have in market cap weighted indexes. That is, the embodiment generally overweight's large cap growth stocks and underweights small cap value stocks providing for broad participation in equity markets, high investment capacity, and low annualized turnover and transactions costs. It is appreciated herein that these favorable portfolio characteristics benefits investors by offering improved portfolio returns, reduced risk, to very similar liquidity, investment capacity, an turnover costs as most market cap weighted indexes. The embodiment moreover improves implementation costs over conventional smart beta index solutions, such as fundamentally weighted indexes, equal weighted indexes, and multifactor indexes.

Table 1 below illustrates an exemplary embodiment across two hypothetical stocks (one growth stocks and one value stock) with the same net earnings (fundamental size factor) but with heterogeneous risk and reward characteristics, such as heterogeneous growth and volatility rates. As can be seen, the growth stock has a lower determined discount rate and a higher determined fundamental value due to its relatively superior risk to reward characteristics (i.e., higher growth/profitability rate and lower deviation rate) relative to the value stock. Further, it shows that the value stocks most recently reported book value is greater than its determined earnings based fundamental value and for that reason the book value represents the fundamental value (the portfolio weight) in a resulting portfolio. Finally, because the growth stock's determined fundamental value is greater that the value stocks book value the resulting portfolio will overweight the growth stock.

TABLE 1
Illustrates two securities (stocks) with the same
net earnings exhibiting heterogeneous long term
risk and reward characteristics (indented).

| | Growth | Value |
|---|---|---|
| Factors/Variables | Stock | Stock |
| Net Earnings (the fundamental size factor) | $10.00 | $10.00 |
| Growth Rate (aka reward) | 10.00% | 5.00% |
| Deviation Rate (aka volatility rate or risk) | 5.00% | 10.00% |
| Volatility Per Unit Growth Rate (aka | 0.50 | 2.00 |
| Unit Factor | | |
| Volatility) | | |
| Volatility Premium | 1.25% | 5.00% |
| Risk Free Rate | 2.50% | 2.50% |
| Discount Rate | 3.75% | 7.50% |
| Earnings based Fundamental Value | $266.67 | $133.33 |
| Book Value | $150.00 | $150.00 |
| Portfolio Weight | $266.67 | $150.00 |
| Portfolio Ranking | 1 | 2 |

Selecting the higher of the determined earnings based fundamental value and the book value for each individual stock allows for an improved (more accurate) representation of stocks that exhibiting heterogeneous ex-post risk and reward characteristics. It is appreciated herein that growth stocks (and most so called blend stocks) will exhibit a portfolio weight based on its determined (earnings based) fundamental value and where many (but not all) value stocks will exhibit a portfolio weight based on its most recently reported book value (as it would be greater than it determined earnings based fundamental value). That is because growth stocks exhibits favorable long term risk and reward characteristics (as measured by fundamental value generating factors, such as higher growth, higher profitability and lower volatility) which allows for a lower determined volatility per unit growth rate, a lower determined discount rate and a higher determined fundamental value. The opposite is typically true for value stocks which are exhibiting weaker fundamental value generating factors which in turn leads to a higher determined volatility per unit growth rate, a higher determined discount rate and a lower determined (earnings based) fundamental value (typically below the most recent reported book value).

In another exemplary embodiment of a system, method and computer program product for determining an index weight using a holistic multifactor construction method, the method comprising the steps for each stock in the universe of stocks: 1) obtaining a fundamental size factor at present time (t₀); b) computing a growth rate at (t0) for a period of time (t0-t−n); c) computing the deviation rate of the growth rate for the period of time (t0-t−n); d) determining a volatility per unit growth rate at present time (t0) by dividing the computed deviation rate at (t0) by the computed growth rate at present time (t0); e) determining a volatility adjusted fundamental size factor at present time (t₀) by dividing the fundamental size factor at present time (t0) by (1+the volatility per unit growth rate) at present time (t0); f) generating an non price based index of stocks by ranking, in descending order, each stocks in the universe of stocks, by its volatility adjusted fundamental size factor. The volatility per unit growth rate may also in this application be referred to as the “unit factor volatility” or consistency rate.

The above embodiment further provides for a solution for systematic biases inherent in fundamental weighted indexes of overweighting stocks that exhibit low valuation multiples (e.g., low P/E or P/B ratios) and underweighting stocks that exhibit high valuation multiples. Table 2 below illustrates the embodiment across two stocks that exhibit heterogeneous risk (deviation rate) and reward (growth/profitability rate) characteristics. It is understood that a fundamental weighted index would assign the same index weight to both stocks ($100) in the table 2 below.

TABLE 2
Illustrates Volatility Adjusted Fundamental Size Factor Across two
stocks that exhibit heterogeneous risk and reward characteristics.

| | Growth | Value |
|---|---|---|
| Factors/Variables | Stock | Stock |
| Fundamental Size (e.g., Book value) | $100.00 | $100.00 |
| Growth Rate (reward) | 10.00% | 5.00% |
| Deviation Rate (volatility or risk) | 5.00% | 10.00% |
| Volatility Per Unit Growth Rate | 0.50 | 2.00 |
| (unit factor volatility) | | |
| Volatility Adj. Fundamental Size Factor | $66.67 | $33.33 |
| Portfolio Weighting | $66.67 | $33.33 |

It is appreciated herein that various embodiments enables for constructing all-inclusive (broad) investment portfolios that may comprise of thousands of stocks in domestic or global equity markets and in where (similar as a market cap-weighted portfolio) large cap growth stocks are generally overweighed and small cap value stocks are generally underweighted.

In another exemplary embodiment, of a system, method and computer program product for selecting and weighting a growth based investment portfolio using a holistic multifactor method is described herein, the method comprising the steps for each stock in the universe of stocks: 1) obtaining a fundamental size factor at present time (t₀); 2) computing a growth rate at (t0) for a period of time (t0-t−n); 3) computing the deviation rate of the growth rate for the period of time (t0-t−n); 4) determining a volatility per unit growth rate at present time (t0) by dividing the computed deviation rate at (t0) by the computing growth rate at present time (t0); 5) determining a volatility adjusted fundamental size factor at present time (t₀) by dividing the fundamental factor at present time (t0) by (1+the volatility per unit growth rate) at present time (t0); 6) determining a fundamental value at present time (t0) by dividing the determined volatility adjusted fundamental size factor at present time (t₀) by the risk free rate at present time (t0); 7) determining a discount rate at the present time (t0) by (i) multiplying the determined volatility per unit growth rate by a risk free rate at the present time (t0) and said multiplying generating a volatility premium, and (ii) adding the generated volatility premium to the risk free rate at the present time (t0), said adding resulting in a determined discount rate at the present time (t0) for the given stock in the universe of stocks and in where the discount rate is determined independent from the market price; 8) selecting each stock in the universe of stocks that exhibit a profitability rate at present time (t0) that is equal or greater than the determined discount rate at the present time (t0); 9) generating a non-price index by ranking, in descending order, each selected stock in the universe of stocks by its determined fundamental value at present time (t0).

The embodiment provides for 1) a solution to systematic biases inherent in conventional market cap weighted growth indexes, 2) a solution to unintended factor biases in existing smart beta growth indexes, 3) a solution to the bleeding problem inherent in conventional process of bisecting a broad equity universe into growth and value indexes, 4) reduced implementation costs, such as reduced tracking error and reduced turn-over costs, improved liquidity and investment capacity over existing smart beta index solutions.

A common problem in conventional style based growth and value indexes is that they to some large extent comprises of the same stocks. This problem is sometimes referred to as style “bleeding”. It is appreciated herein that this problem is a result of that academics and practitioners have not adequately determined what factor characteristics constitutes growth stocks and what factor characteristics constitute value stocks. Hence, the conventional method of bisecting a broad equity universe into growth and value portfolios results in a large group of stocks (known as blend stocks) not being properly classified. More particularly, the conventional method which uses common valuation multiples (e.g., P/E or P/B or a combination of such multiples) and growth factors (such as revenue or earnings growth) cannot adequately classify stocks as either growth or value stocks.

It is understood that the conventional method of bisecting a broad investment universe into value and growth portfolios results in portfolios that exhibits suboptimal long term factor characteristics which negatively affects the resulting portfolios (particularly the growth portfolios) long term risk and return characteristics. Conventionally, growth stocks are characterized as stocks that are overpriced (overvalued) as they exhibit higher market valuation multiples, such as higher P/E or P/B, and value stocks are characterized as underpriced (undervalued) because they exhibit low valuation multiples. Growth stocks may further be characteristic by exhibiting above average growth in revenues and earnings.

The conventional method poses two main problems. First, growth factors (e.g., revenue or earnings growth) are not a fundamental value generating factors per se. That is, the growth factor does not contribute to the long-term growth in a company's fundamental value, unless the company is also profitable. It is appreciated herein, that the profitability factor is the predominant factor because a company's making investments for growth can simply not be sustained over time unless the company is also profitable. Second, characterizing growth stocks as overpriced (expensive) and value stocks as underpriced (cheap) stocks, is misguiding. That is because a fundamental size factor, such as earnings (E) or book value (B) or a combination of such factor, may not be an adequate proxy for a stocks fundamental value.

It is appreciated herein that a) high growth, b) high profitability and c) low growth volatility are fundamental value generating factors. These factors enables a company's to grow its fundamental value at a higher rate. It is appreciated herein that growth stocks exhibits stronger fundamental value generating factors and value stocks weaker fundamental value generating factors. It is furthermore appreciated herein that fundamental value generating factors are discount factors. Hence, it is appreciated herein that fundamental value generating factors are discount rate factors (i.e., fundamental value generating factors explains the discount rate), and that the discount rate in turn determines the fundamental value, thus is a low discount rate, all else equal, translate to a higher fundamental value and a high discount rate to a lower fundamental value. Further, fundamental value generating factors are the predominant factors that enable a company to grow its fundamental value over time.

Some embodiments herein provide for a solution to problems in the conventional method of determining a discount rate and a fundamental value across stocks that exhibit heterogeneous long-term risk and reward characteristics or factor characteristics. It is appreciated herein that some embodiments determines a discount rate and a fundamental value independent from investors assessment, i.e., independent from the market price. It is furthermore appreciated herein that a fundamental value may be determined by discounting a company's net earnings by the determined discount rate and that the discount rate comprising fundamental value generating factors that proxy individual company's long term risk and reward characteristics. It is appreciated herein that the above explanation of factor relationships, and their application, is not well understood in the industry.

It is appreciated herein that a market price (P) may be explained by multiplying a fundamental size factor (e.g., net earnings (E)) with the relevant valuation multiple, such as the price to earnings ratio, the P/E. Hence, a market price (P) of $100 can for example be explained by multiplying a company's net earnings, (e.g., $10) by its P/E ratio (e.g., 10), that is $10*10=$100. Alternatively, a market price (P) can be explained by dividing a company's net earnings (E) by the reciprocal of the P/E, i.e., the E/P (also known as the earnings yield). Hence, a market price (P) can be explained as $10 (E) divided by 10%, (i.e., 1/10 the reciprocal of the P/E), that is $10/10%=$100. It is further appreciated herein that the earnings yield (E/P) proxy the markets (i.e., investors) collective assessment of fundamental generating factors (i.e., the discount rate). Hence, generally a lower earnings yield (lower E/P) proxy stronger fundamental value factor, a low discount rate and a higher fundamental value, all else equal. Conversely, a higher earnings yield (higher E/P) proxy's weaker fundamental value generating factors, a higher discount rate and a lower fundamental value, all else equal. It is appreciated herein that the above relationships as explanation above is not well understood in the industry.

The above teaching explains that the P/E and more particularly the reciprocal, i.e., the E/P (the earnings yield) do not proxy mispricing, as is the conventional explanation, but rather the discount rate, i.e., investor's assessment of a stocks volatility and future growth potential. It is contemplated that one or more embodiments of the present invention improves over the conventional method of determining a discount rate, by determining a discount rate independent from investor's assessment, in a specific way, which allows to avoid investors behavioral biases which in turn allows to avoid systematic biases inherent in standard market cap-weighted indexes.

It is appreciated herein that one aspect of the present invention and its various embodiments provides for a solution to problems in asset pricing, that is explaining the market price (as determined by the collective investors, i.e., humans) by using a discount rate and a fundamental value that controls for individual securities heterogeneous fundamental value generating factors independent from the market price, i.e., independent from investors assessment (the price). The discount rate comprises a volatility premium, that proxy individual stocks fundamental value generating factor characteristics, and macroeconomic factors. Hence, the determined discount rate controls for individual stocks heterogeneous fundamental value generating factors using a holistic multifactor approach in determining a volatility premium and a discount rate, independent from a stocks market price.

Some embodiments further provide a solution to the problem of bisecting a broad equity universe into growth and value portfolios by improving the method of classifying stocks as either growth or value stocks and by providing for a solution to the problem of leaving a large group of stocks undefined, conventionally known as “blend” stocks. More particularly, the embodiments provides for a solution in selecting growth and value portfolios by considering not only valuation multiples and growth factors, such as revenue and earnings growth (as is conventional), but by instead considering a profitability factor and the discount rate in the process of bisecting a broad investment universe into growth and value portfolios.

In some embodiments it is asserted that the profitability factor is the missing factor in the conventional method. Hence, present embodiments selects sufficiently profitable stocks for a growth portfolio and insufficiently profitable stocks for a value portfolio. It is contemplated that this method makes the so called “blend” stocks label redundant. That is, profitable blend stocks would be classified as growth stocks and unprofitable blend stocks would be classified as “value” stocks. It is contemplated that, in most cases, blend stocks are mature growth stocks that exhibit slower growth, but are still be profitable, while lacking investment opportunities.

It is appreciated herein that a company's investment process, the growth (a.k.a. the investment factor), profitability and volatility factors are considered in the discount rate and that a company's profitability rate and its determined discount rate are the predominant factors to be used in classifying stocks, i.e., as either growth or value stocks, for purpose of bisecting a broad (all inclusive) equity universe into growth and value portfolios. It is further contemplated that the profitability factor (a.k.a. profitability rate) is an important factor that is linked to a company's long term investment (and growth) process.

Some embodiments provides for the advantage (over the conventional method) of selecting stocks for a resulting growth portfolios, because the selected stocks exhibit favorable long-term factor characteristics, such as high profitability, high growth and low volatility. These factor characteristics when adequately combined in a holistic multifactor growth investment portfolio offers investors improved long-term performance, such an improved returns and reduces risk, and further provides for improved implementation costs, such as higher liquidity, higher investment capacity and lower turnover costs over existing smart beta solutions.

It is appreciated that profitability, growth and low volatility are fundamental value generating factors. That is, low volatility, high profitability and high growth are factor characteristics that allow a company to grow its fundamental value (and thus in turn also its market value) for its stockholders. The higher the profitability and the higher the growth and the lower the volatility the faster the company can grow its fundamental value.

In one or more embodiments, a valuation premium for each individual stock is determined by subtracting the stocks market value (i.e., price) from its determined fundamental value. Hence, it is appreciated herein that if a stock exhibits a fundamental value that is greater than its market value, the stocks is considered undervalued and thus offers investors a valuation premium. In an alternative embodiment the valuation premium may be determined by dividing the determined fundamental value with the stocks market price.

It is further contemplated that the valuation premium (which may also be referred to as the expected return) may be either positive or negative. Hence, in one or more embodiments of the present invention allows for constructing a holistic multifactor growth investment portfolio that overweight's underpriced growth stocks (i.e., growth stocks that exhibits a determined fundamental that is greater than the stocks market price). It is further contemplated that growth stocks further exhibits a relatively low discount rate, that is, they generally exhibit higher growth, higher profitability and lower volatility relative the market as a whole. Hence, a resulting growth portfolio would comprise of stocks that exhibits favorable long term factor characteristics as such a growth portfolio would overweight stocks (within the portfolio of stocks) that exhibit a low discount rate and low valuation. It is appreciated herein that these embodiments improves over the conventional method of bisecting a broad equity universe and/or selecting growth portfolios.

Table 3 below illustrates the system and method of selecting and weighting a holistic multifactor growth investment portfolio across three hypothetical securities (stocks).

TABLE 3

| | Growth | Blend | Value |
|---|---|---|---|
| Factors/Variables | Stock | Stock | Stock |
| Fundamental Size Factor (e.g., | $10.00 | $10.00 | $10.00 |
| Net Earnings) | | | |
| Growth Rate | 10.00% | 5.00% | 5.00% |
| Deviation Rate | 5.00% | 5.00% | 10.00% |
| Volatility Per Unit Growth Rate | 0.50 | 1.00 | 2.00 |
| Volatility Adjusted Fundamental Size | $6.67 | $5.00 | $3.33 |
| Risk Free Rate | 2.50% | 2.50% | 2.50% |
| Fundamental Value | $266.67 | $200.00 | $133.33 |
| Volatility Premium | 1.25% | 2.50% | 5.00% |
| Discount Rate | 3.75% | 5.00% | 7.50% |
| Profitability Rate | 5.00% | 5.00% | 2.50% |
| Portfolio Selection | Included | Included | Excluded |
| Fundamental Value/Portfolio Weight | $266.67 | $200.00 | $0.00 |
| Portfolio Ranking | 1 | 2 | n/a |

As can be seen in the exhibit above, the blend stock would be included (reclassified as a growth stock) in the growth portfolio because the blend stock exhibit a profitability rate that equals its determined discount rate. It is contemplated that “blend stocks” are mature growth stocks that have limited opportunities to grow its fundamental value through making continued investments for growth in revenues and earnings. To compensate, blend stocks typically pay dividends or if appropriate repurchases its stocks (known as buybacks). Furthermore, blend stocks typically exhibit higher growth in dividends than value stocks which benefits long-term investors.

One or more of these and other objects are achieved by the provision of various embodiments a computer system for holistic multifactor portfolio construction, which are described herein.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF DRAWINGS

Various non-limiting embodiments of the technology will be described with reference to the following figures. It should be appreciated that the figures are not necessarily drawn to scale.

FIG. 1 shows an exemplary system in which various embodiments may be practiced;

FIG. 2 shows a portfolio management engine according to various embodiments;

FIG. 3 shows a computer-based process for monitoring securities, determining values and performing actions according to various embodiments;

FIG. 4 shows a computer-based process for determining value of a security according to various embodiments;

FIG. 5 shows another computer-based process for determining value of a security according to various embodiments;

FIG. 6 shows a computer-based process for weighting a portfolio according to various embodiments;

FIG. 7A shows an interface that displays a ranked list of securities according to some embodiments;

FIG. 7B shows a computer-based interface having an alert and control interface according to various embodiments;

FIG. 8 shows an example computer-based system capable of implementing various embodiments;

FIG. 9 shows various aspects of the computer system, process and interfaces according to various embodiments; and

FIGS. 10A-B show a block diagram of a computer system according to various embodiments.

### DETAILED DESCRIPTION OF INVENTION

What is desired is a system that is capable of determining a discount rate for individual securities that allows to adequately determining a fundamental value in a cross section of assets (e.g., stocks) that exhibit heterogeneous fundamental value generating factors independent from the stocks market price. The determined discount rate is used to determine a fundamental value for all assets in the cross section of stocks. It is further desired that the discount rate determines a fundamental value under both an efficient and inefficient market hypothesis. In some embodiments, it is appreciated that a discount rate and a fundamental value is determined independently from a market price. Some further embodiments relate to selecting and weighting assets within a portfolio. Some further embodiments relate to weighting techniques designed to avoiding systematic biases in existing systems. Other relates to useful tools that can be used in one or more embodiments. Other relate to interfaces, performing control functions, and executing trades responsive to determining fundamental values for assets.

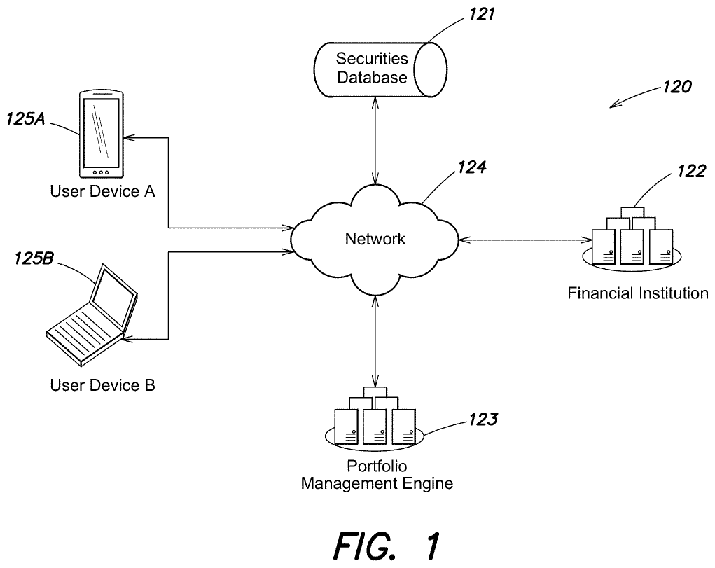

FIG. 1 shows an exemplary system in which various embodiments may be practiced. In particular, FIG. 1 shows a distributed system 120 including one or more computer-based entities connected through one or more networks (e.g., network 124) for the purpose of evaluating assets such as securities. Information regarding such securities may be stored within the securities database 121 and such database may be accessed via network 124. It is understood that the securities database (i.e., the data source) is proprietary and that the embodiments, as disclosed herein, may include one or more proprietary databases and of which one or more databases may be third party proprietary databases.

In some embodiments, it portfolio management engine 123 is provided which is capable of evaluating one or more parameters relating to one or more securities and performing one or more computer-based actions based on the evaluation. Information and/or signals produced by the portfolio management engine 123 may be accessed and/or displayed to one or more other system elements such as user device A (item 125A) which may include a portable device such as a cell phone or other mobile device. Other devices may include, for example, a user device B (item 125B) which may be a personal computer or other type of computer-based workstation. Such information may also be provided or retrieved from one or more financial institutions 122 for the purpose of evaluating, trading, or monitoring trading performance or performing any other computer-based action. It should be appreciated that any computing entity can be used to implement any aspect of the embodiments described herein, by any number of user types or roles, including traders, institutional investors, banks, or any other entity.

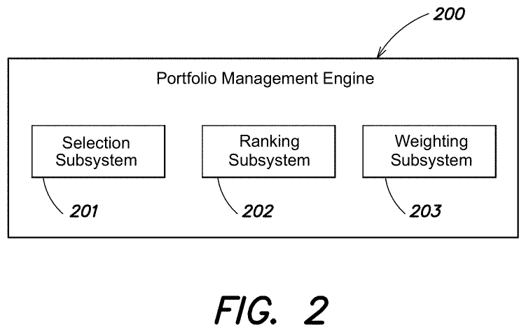

FIG. 2 shows an example portfolio management engine according to various embodiments. Portfolio management engine may, in some embodiments, may be a computer-based special purpose machine capable of performing passive asset management in an automated way (e.g., without human involvement). In particular, FIG. 2 shows an example implementation of a portfolio management engine 123 as shown above with respect to FIG. 1. According to one embodiment, portfolio management engine 200 includes one or more components including, but not limited to, a selection subsystem 201, the ranking subsystem 202, and a weighting subsystem 203. In some embodiments, selection subsystem 201 is capable of selecting one or more assets to be evaluated and/or performing one or more computer-based actions associated with the asset. In some embodiments, information relating to the asset is stored within one or more databases (e.g., securities database 121) and the selection subsystem 201 accesses data elements associated particular securities for the purpose of performing one or more functions. Further, portfolio management engine 123 may have an internal or other type of storage (e.g., cloud) in which security data may be stored.

Portfolio management engine 200 may also include a ranking subsystem 202 that is capable of determining a value associated with one or more securities and/or a relative ranking (or value) in relation to other securities. Ranking subsystem 202 may be capable of accessing one or more parameters associated with particular security (e.g., a security having information stored within one or more databases). Ranking subsystem 202 may be capable of determining a value or ranking of a particular security based on one or more factors. As a practical example, Ranking subsystem 202 may be capable of continuously and automatically retrieving factor data in real time for one or more securities associated with a group of securities. Such information may be communicated to subsystem 202 via one or more networks, memories, or storage entities.

Portfolio management system 200 may also include a weighting subsystem 203 capable of determining one or more weights associated with one or more securities within a portfolio of securities. As discussed herein, a portfolio may be described as a grouping of assets, the assets being one or more types of assets within the group. In some example implementations, the securities may include stocks. Weighting subsystem 203 may be responsive to one or more factors including parameters associated with one or more security databases, one or more values determined, for example as a result of evaluations performed by one or more other entities of the portfolio management engine 200. Such information may include, without limitation, a value of an asset determines automatically and in real time responsive to received market data.

In some embodiments, database 121 serves as a data source (e.g., a proprietary database) from which the system receives or obtains any necessary data for performing the methods described herein. In a further step, the system configures and stores the obtained data (e.g., “raw” data) in an internal database (e.g., in using a two dimensional array or other storage structure (e.g., any order of an array, data file, flat file, object database, or other database format)) in which the data is structured for structural access by the system. In a further step, The system accesses the data (e.g., stored and structured in the two multidimensional array or other storage structure) to perform step by step process that, in some embodiments, results in a determination of a fundamental value. This step by step process, in some embodiments, transforms the input data (e.g., net earnings) to a fundamental value in the last step (the output data).

In some embodiments, data transformation is performed by performing steps that determine the volatility premium and the discount rate. These data transformation steps transform a net earnings to a fundamental value (or other useful weighting approaches as disclosed herein). In some embodiments, the process solves problems in the prior art, in that an index weight is determined which achieves an improved accuracy that further reduces implementation costs over existing systems and methods.

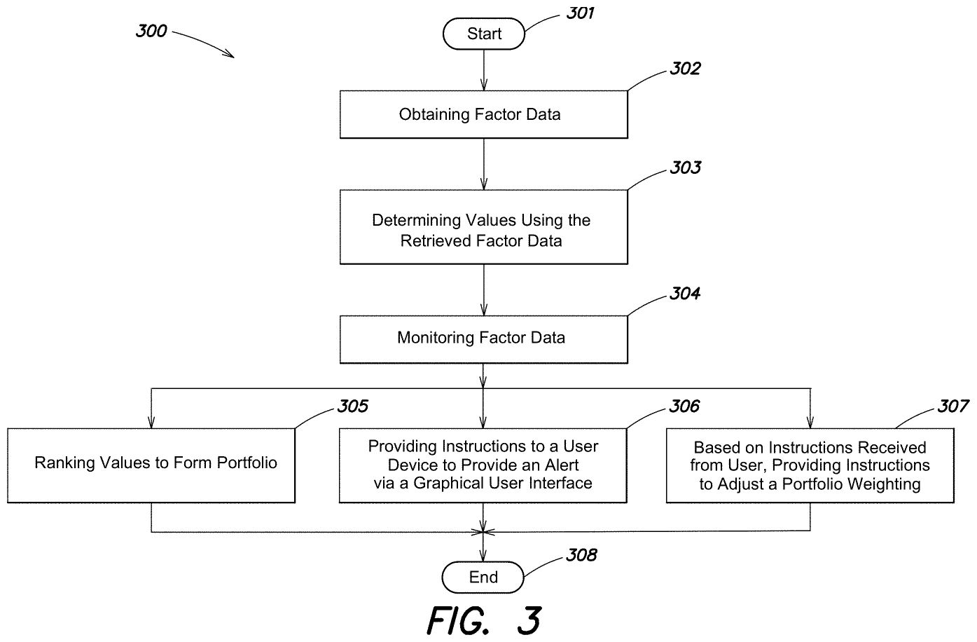

FIG. 3 shows a computer-based process 300 for monitoring securities, calculating values and performing actions according to various embodiments. At block 301, process 300 begins. At block 302, a system (e.g., portfolio management engine 200) or some computing entity retrieves factor data from one or more proprietary databases or proprietary data sources. At block 303, the system determines values (e.g., one or more securities) using the retrieved factory data. In some embodiments, the system may be capable of monitoring real-time data associated with one or more of the securities for which a value has been determined. For instance, the system may be capable of monitoring factor data and other data associated with one or more securities (e.g., at block 304).

It should be appreciated that one or more elements may communicate with other systems, for the purpose of providing an improved system for determining and/or ranking securities. In some embodiments as described herein, there are provided one or more interfaces to the system. Some of these interfaces may be programmatic in nature and may couple one or more systems. In other embodiments, there are provided one or more user interfaces to the system.

For example, the system, at block 306, may be adapted to provide instructions to user device to provide an alert to the user via a graphical user interface responsive to one or more determined values relating to the security. For instance, in one embodiment, and responsive to calculation of value of a particular security, the system may prompt the user to buy or sell a security within an interface view one or more controls presented to the user within a graphical user interface. The system may be configured to perform other actions. The system may be configured to, at block 305, rank values to form a portfolio. Also, in addition to other functions, at block 307, based on instructions or other control input received from a user, the system may be capable of providing instructions to a system to adjust portfolio weighting. It should be appreciated that other types of computer-based actions may be performed responsive to the determined value. It should be appreciated that the system may be capable of generating and providing one or more controls, alerts, or other signal types to one or more computing entities. At block 308, process 300 ends.

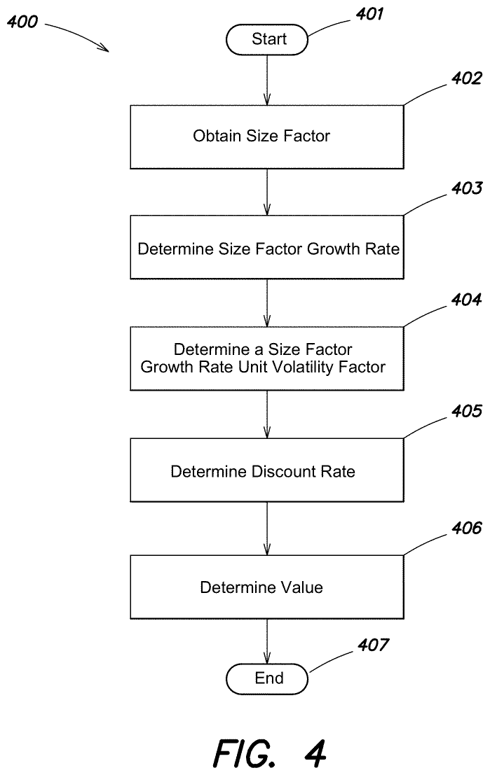

FIG. 4 shows a computer-based process 400 for determining a value of a security according to various embodiments. At block 401, process 400 begins. At block 402, a system (e.g., portfolio management engine 200) or some computing entity obtains a size factor associated with one or more securities to be valued from a proprietary database 121. The size factor data may be stored in one or more databases associated with one or more computing systems as discussed above with reference to FIG. 1. At block 403, the system determines a size factor growth rate associated with the security. At block 404, the system determines a size factor unit volatility factor for the security. Based on the size factor, size factor growth rate, and size factor unit volatility, the system determines the discount rate for the particular security at block 405. At block 406, the system determines a value of the security based on the size factor and the determined discount rate. At block 407, process 400 ends.

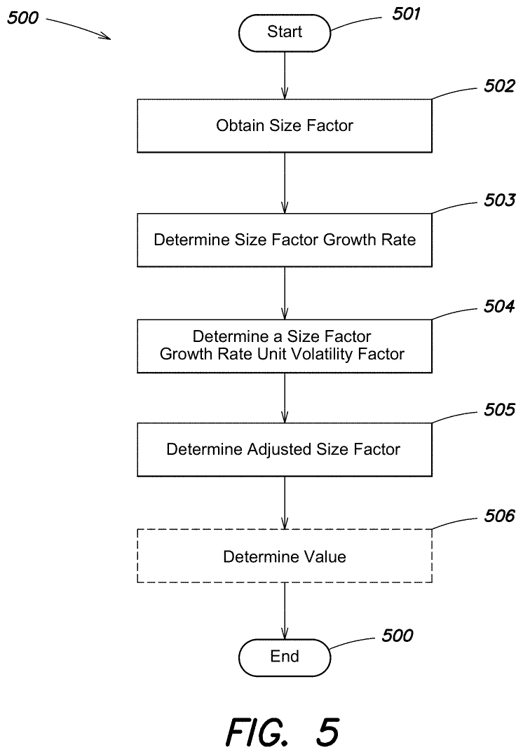

FIG. 5 shows another computer-based process 500 for determining value of a security according to various embodiments. At block 501, process 500 begins. At block 502, the system (e.g., portfolio management engine 200) or some computing entity obtains a size factor associated with one or more securities to be valued from proprietary database 201. As discussed above, the size factor data may be stored in one or more databases or other data sources. At block 503, the system determines a size factor growth rate. For example, a size factor growth rate may be determined by calculating a deviation of a growth rate for a given security for a particular period of time, and then dividing the deviation rate by a growth rate. At block 504, the system may determine a size factor growth rate unit volatility value associated with the security. At block 505, the system determines and adjusted size factor associated with the security. At block 506, the system determines the value of the security. At block 507, process 500 ends.

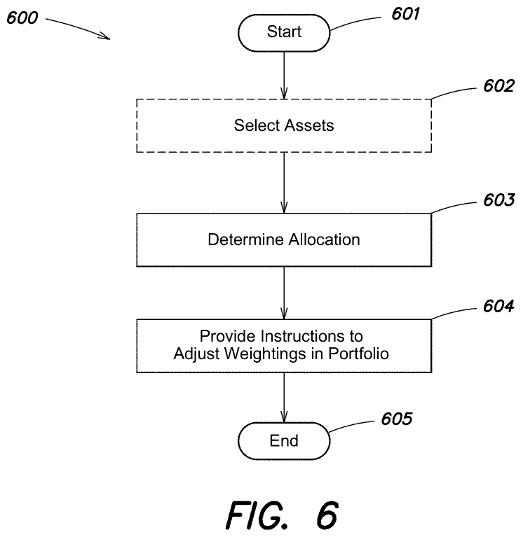

FIG. 6 shows a computer-based process 600 for weighting a portfolio according to various embodiments. At block 601, process 600 begins. At block 602, the system (e.g., portfolio management engine 200) or some other type of computer based system selects one or more assets to be included within a portfolio. At block 603, the system determines the allocation of assets within the portfolio. At block 604, the system provides instructions to a system for adjusting weightings within an investment portfolio. At block 605, process 600 ends.

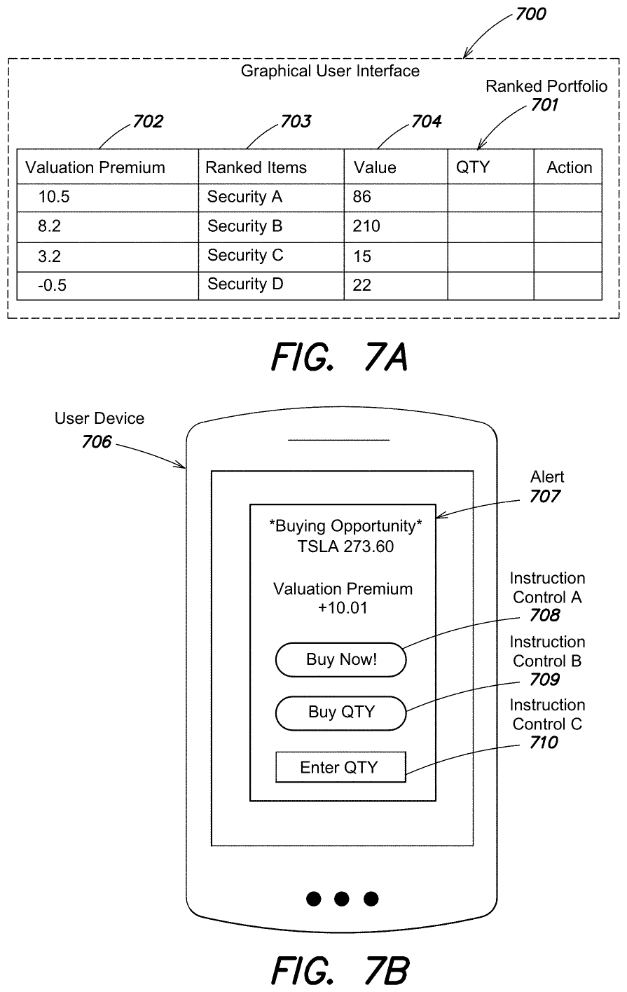

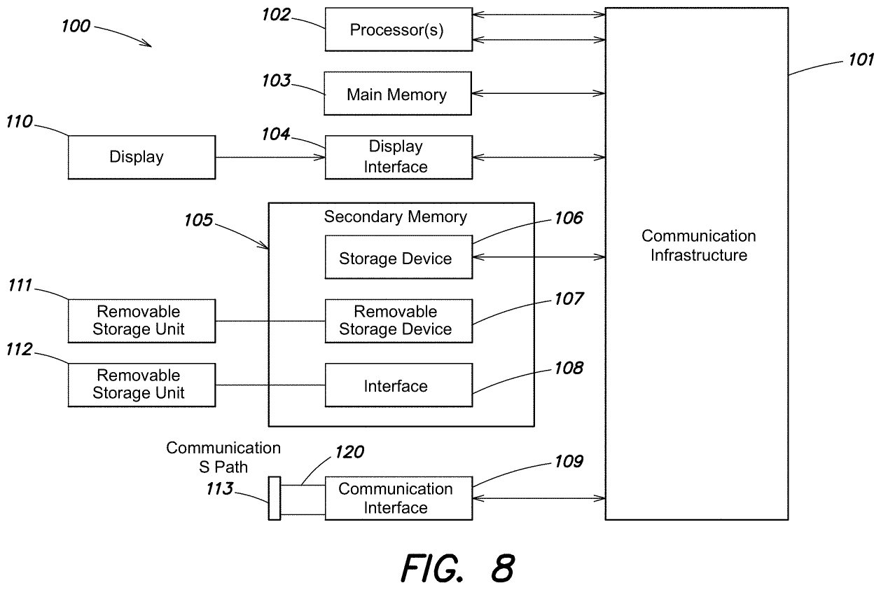

FIG. 7A shows an interface that displays a ranked list of securities according to some embodiments. In particular, FIG. 7A shows a ranked portfolio 701 which includes one or more security data entries associated with particular securities to be evaluated. Such information may be shown, for example, within a graphical user interface 700 which is displayed on one or more computing devices. Portfolio 701 may include, for example one or more securities having corresponding value information, as well as a calculated value premium as determined through one or more methods described above. In some embodiments, the graphical user interface may display quantities of the securities within the portfolio and may display one or more recommended actions to be performed in relation to the one or more securities. Such information may be displayed responsive to one or more valuations of the security as discussed above with reference to FIGS. 4 and 5.

FIG. 7B shows a computer-based interface having an alert and control interface according to various embodiments. In Particular, FIG. 7B shows a user device 706 having one or more user interface elements that display or receive data from a user. In one example, the system may have an interface through which one or more alerts (e.g., alert 707) may be displayed to a user. For instance, responsive to a calculated value, the system may be capable of displaying an alert indicates an opportunity to perform an action in relation to a particular security. For example, within an interface, the system may be capable of displaying instruction control A 708 that allows the user to perform a purchase action (e.g., a “Buy Now!” button). In another example, the system may be capable of displaying instruction control B 709, that, when selected by the user allows the user to buy a particular quantity of the indicated security (e.g., a “Buy QTY” button). Further, the interface may include an instruction control C 710 that, when selected, permits the user to enter a particular quantity of the security to be purchased.

### Exemplary Computer System Embodiments

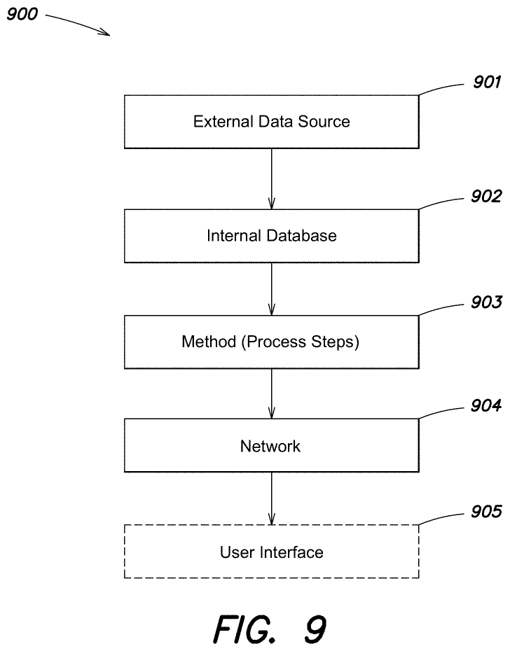

FIG. 8 shows an exemplary computer-based system capable of implementing various embodiments. In particular, FIG. 8 illustrates an exemplary computer system that may be used in implementing one or more exemplary embodiments. Specifically, FIG. 8 illustrates an exemplary embodiment of a computer system 100 that may be used in computing devices such as, e.g., but not limited to, a client and/or a server, etc., according to an exemplary embodiment of the present invention. FIG. 8 illustrates an exemplary embodiment of a computer system that may be used as client device 100, or a server device 100, etc. As described herein, the system of FIG. 8 may be used to implement any of the elements of FIG. 1 above, and is adapted to process and receive data from one or more databases (e.g., such as, for example, securities database as shown in FIG. 1).

Embodiments of the present invention (or any part(s) or function(s) thereof) may be implemented using hardware, software, firmware, or a combination thereof and may be implemented in one or more computer systems or other processing systems. In fact, in one exemplary embodiment, one or more computer systems capable of carrying out the functionality described herein may be provided. An example of a computer system 100 may be shown in FIG. 8, depicting an exemplary embodiment of a block diagram of an exemplary computer system useful for implementing embodiments the present invention. Specifically, FIG. 8 illustrates an example computer 100, which in an exemplary embodiment may be, e.g., (but not limited to) a personal computer (PC) system running an operating system such as, e.g., (but not limited to) MICROSOFT®.WINDOWS® operating systems, etc. available from MICROSOFT® Corporation of Redmond, Wash., U.S.A. However, the invention may not be limited to these platforms. Instead, the invention may be implemented on any appropriate computer system running any appropriate operating system.

In one exemplary embodiment, the present invention may be implemented on a computer system operating as discussed herein. An exemplary computer system, computer 100 may be shown in FIG. 8. Other components of the invention, such as, e.g., (but not limited to) a computing device, a communications device, mobile phone, a telephony device, a telephone, a personal digital assistant (PDA), a personal computer (PC), a handheld PC, an interactive television (iTV), a digital video recorder (DVD), client workstations, thin clients, thick clients, proxy servers, network communication servers, remote access devices, client computers, server computers, routers, web servers, data, media, audio, video, telephony or streaming technology servers, etc., may also be implemented using a computer such as that shown in FIG. 8. Services may be provided on demand using, e.g., but not limited to, an interactive television (iTV), a video on demand system (VOD), and via a digital video recorder (DVR), or other on demand viewing system.

The computer system 100 may include one or more processors, such as, e.g., but not limited to, processor(s) 102. The processor(s) 102 may be connected to a communication infrastructure 101 (e.g., but not limited to, a communications bus, cross-over bar, or network, etc.). Various exemplary software embodiments may be described in terms of this exemplary computer system. After reading this description, it may become apparent to a person skilled in the relevant art(s) how to implement the invention using other computer systems and/or architectures.

Computer system 100 may include a display interface 104 that may forward, e.g., but not limited to, graphics, text, and other data, etc., from the communication infrastructure 101 (or from a frame buffer, etc., not shown) for display on the display unit 110.

The computer system 100 may also include, e.g., but may not be limited to, a main memory 103, random access memory (RAM), and a secondary memory 105, etc. The secondary memory 105 may include, for example, (but not limited to) a hard disk drive 106 and/or a removable storage drive 107, representing any type of memory, storage element, or media including storage drives or devices including magnetic, optical or other types of memory elements. The removable storage drive 107 may, e.g., but not limited to, read from and/or write to a removable storage unit (111) in a well-known manner. Removable storage unit 111, also called a program storage device or a computer program product, may represent, e.g., but not limited to, a FLASH drive, a disk, magnetic tape, optical disk, compact disk, or other storage element which may be read from and written to by removable storage drive 107. As may be appreciated, the removable storage unit 111 may include a computer usable storage medium having stored therein computer software and/or data. In some embodiments, a “machine-accessible medium” may refer to any storage device used for storing data accessible by a computer. Examples of a machine-accessible medium may include, e.g., but not limited to: a magnetic hard disk; a floppy disk; an optical disk, like a compact disk read-only memory (CD-ROM) or a digital versatile disk (DVD); a magnetic tape; and/or a memory chip, or other media type.

In alternative exemplary embodiments, secondary memory 105 may include other similar devices for allowing computer programs or other instructions to be loaded into computer system 100. Such devices may include, for example, a removable storage unit 112 and an interface 108. Examples of such may include a program cartridge and cartridge interface (such as, e.g., but not limited to, those found in video game devices), a removable memory chip, element or drive, and other removable storage units 112 and interfaces 108, which may allow software and data to be transferred from the removable storage unit 112 to computer system 100.

Computer 100 may also include an input device 140 such as, e.g., (but not limited to) a mouse or other pointing device such as a digitizer, and a keyboard or other data entry device (not shown). Computer 100 may also include output devices, such as, e.g., (but not limited to) display 110, and display interface 104. Computer 100 may include input/output (I/O) devices such as, e.g., (but not limited to) communications interface 109, cable 120 and communications path 113, etc. These devices may include, e.g., but not limited to, a network interface card, and modems (neither are labeled). Communications interface 109 may allow software and data to be transferred between computer system 100 and external devices.

In this document, the terms “computer program medium” and “computer readable medium” may be used to generally refer to media such as, e.g., but not limited to removable storage drive 107, a hard disk installed in hard disk drive 106, and signals 120, etc. These computer program products may provide software to computer system 100. The invention may be directed to such computer program products. In some embodiments, such a computer-readable medium may be a non-volatile medium as is known in the art.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used. It should be understood that these terms may be not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm may be here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, objects or the like. It should be understood, however, that all of these and similar terms are to be associated with the appropriate physical quantities and are merely convenient labels applied to these quantities.

Unless specifically stated otherwise, as apparent from the following discussions, it may be appreciated that throughout the specification discussions utilizing terms such as “processing,” “computing,” “calculating,” “determining,” or the like, refer to the action and/or processes of a computer or computing system, or similar electronic computing device, that manipulate and/or transform data within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

In yet another exemplary embodiment, the invention may be implemented using a combination of any of, e.g., but not limited to, hardware, firmware and software, etc.

In one or more embodiments, the present embodiments are embodied in machine-executable instructions. The instructions can be used to cause a processing device, for example a general-purpose or special-purpose processor, which is programmed with the instructions, to perform the steps of the present invention. Alternatively, the steps of the present invention can be performed by specific hardware components that contain hardwired logic for performing the steps, or by any combination of programmed computer components and custom hardware components. For example, the present invention can be provided as a computer program product, as outlined above. In this environment, the embodiments can include a machine-readable medium having instructions stored on it. The instructions can be used to program any processor or processors (or other electronic devices) to perform a process or method according to the present exemplary embodiments. In addition, the present invention can also be downloaded and stored on a computer program product. Here, the program can be transferred from a remote computer (e.g., a server) to a requesting computer (e.g., a client) by way of data signals embodied in a carrier wave or other propagation medium via a communication link (e.g., a modem or network connection) and ultimately such signals may be stored on the computer systems for subsequent execution).

### Exemplary Communications Embodiments

In one or more embodiments, the present embodiments are practiced in the environment of a computer network or networks. The network can include a private network, or a public network (for example the Internet, as described below), or a combination of both. The network includes hardware, software, or a combination of both. From a telecommunications-oriented view, the network can be described as a set of hardware nodes interconnected by a communications facility, with one or more processes (hardware, software, or a combination thereof) functioning at each such node. The processes can inter-communicate and exchange information with one another via communication pathways between them called interprocess communication pathways. On these pathways, appropriate communications protocols are used. The distinction between hardware and software may not be easily defined, with the same or similar functions capable of being performed with use of either, or alternatives.

An exemplary computer and/or telecommunications network environment in accordance with the present embodiments may include node, hardware, software, or a combination of hardware and software. The nodes may be interconnected via a communications network. Each node may include one or more processes, executable by processors incorporated into the nodes. A single process may be run by multiple processors, or multiple processes may be run by a single processor, for example. Additionally, each of the nodes may provide an interface point between network and the outside world, and may incorporate a collection of sub-networks.

As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently.

In an exemplary embodiment, the processes may communicate with one another through interprocess communication pathways (not labeled) supporting communication through any communications protocol. The pathways may function in sequence or in parallel, continuously or intermittently. The pathways can use any of the communications standards, protocols or technologies, described herein with respect to a communications network, in addition to standard parallel instruction sets used by many computers.

The nodes may include any entities capable of performing processing functions. Examples of such nodes that can be used with the embodiments include computers (such as personal computers, workstations, servers, or mainframes), handheld wireless devices and wireline devices (such as personal digital assistants (PDAs), modem cell phones with processing capability, wireless e-mail devices including BlackBerry or other types of devices), document processing devices (such as scanners, printers, facsimile machines, or multifunction document machines), or complex entities (such as local-area networks or wide area networks) to which are connected a collection of processors, as described. For example, in the context of the present invention, a node itself can be a wide-area network (WAN), a local-area network (LAN), a private network (such as a Virtual Private Network (VPN)), or collection of networks.

Improved Computer System

In some embodiments, an improved computer system is provided for performing passive rebalancing of securities. In particular, an improvement is provided in determining index weights results in (among other items) reduced tracking errors over existing systems. This results in improved technology by reducing computer processing needs (i.e., because the computer can faster trade securities when a portfolio (or index) is rebalanced). Further, require less memory is required by the system as a lower amount of securities is traded responsive to the automatic rebalancing.

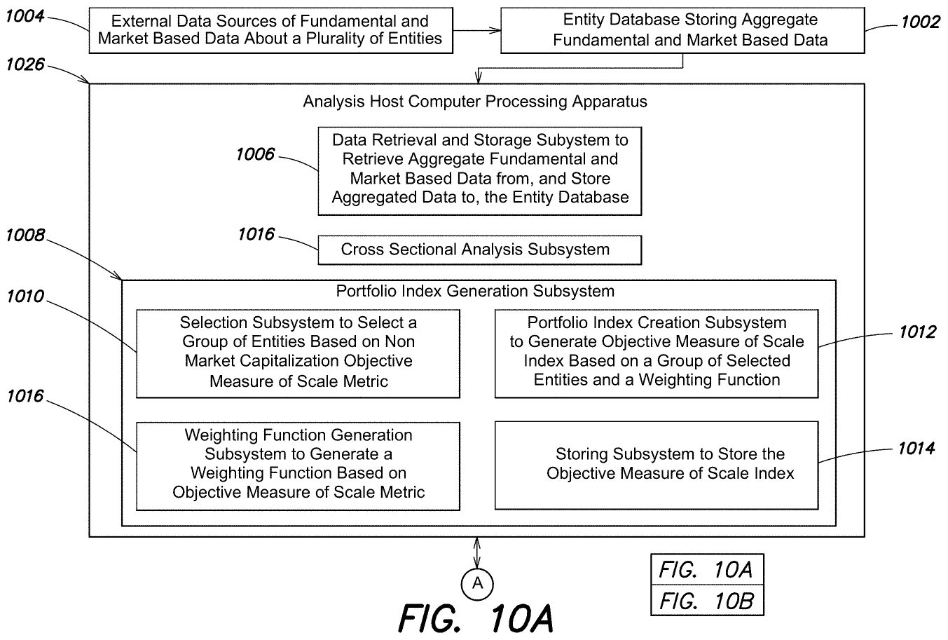

FIG. 9 shows one embodiment of a process and associated computer system implementing various aspects. At block 901, the system retrieves data from one or more data sources, which may include one or more proprietary databases. The system may restructure data and store it in one or more internal database structures at block 902. For instance, as discussed herein, data may be stored in one or more multidimensional arrays. At block 903, the system may perform one or more processing steps on the data, which may result in a transformation of one or more data objects. Further, at block 904, one or more of the transformed data objects (e.g., ranked securities) may be transmitted in real time to one or more computing entities. Further, one or more user interfaces (905) may be configured to receive the transformed data objects where they may be displayed to a user or used by a further computer-based entity (e.g., an executing process).

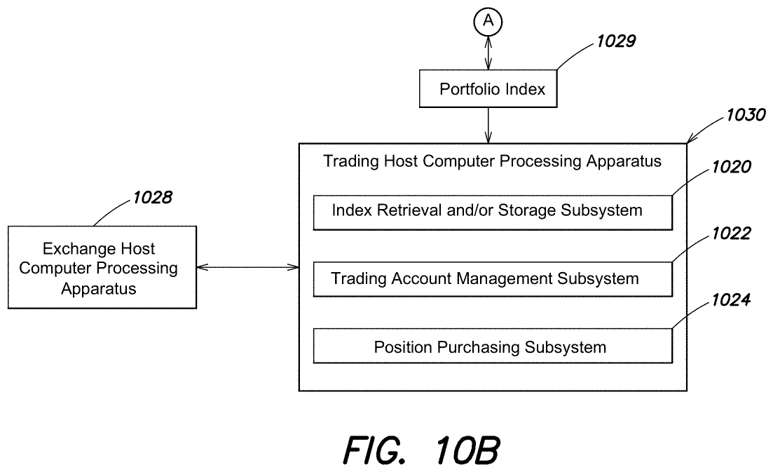

FIGS. 10A-B illustrate a block diagram of an exemplary system according to an exemplary embodiment. The system may include an entity database 1002 that, according to an exemplary embodiment, may store aggregated accounting based data and/or other data, metrics, measures, parameters, technical parameters, characteristics and/or factors about a plurality of entities, obtained from an external data source 1000. The system may include an analysis host computer processing apparatus 1026 coupled to the entity database 1002. The analysis host computer processing apparatus 1026 may include a data retrieval and storage subsystem 1006, according to an exemplary embodiment, which may retrieve the aggregated fundamental and market based data from the entity database and may store the aggregated fundamental and market based data to the entity database 1002. The analysis host computer processing apparatus 1026 may include, according to an exemplary embodiment, a portfolio index generation subsystem 1008, which may include, according to an exemplary embodiment, a selection subsystem 1010 operative to select a group of the entities based on non-market capitalization objective measure of scale or size metric including one or more technical parameters and/or metrics; a weighting function generation subsystem 1016, according to an exemplary embodiment, may be operative to generate a weighting function based on non-market capitalization, non-price related objective measure of scale and/or size metric; an exemplary portfolio index creation subsystem 1012, according to an exemplary embodiment, may be operative to create a non-market capitalization non-price objective measure of scale index based on the group of selected entities and/or the weighting function; and/or a storing subsystem 1014, according to an exemplary embodiment, operative to store the non-market capitalization, non-price related objective measure of scale and/or size based index, and/or multi-dimensional array of data objects. The index or array of data objects may be stored on a storage device, in one exemplary embodiment.

According to one exemplary embodiment, the system may further include a cross sectional analysis, calculation and/or computation subsystem 1016 operative to analyze entity object data to be stored in the entity database 1002. According to another exemplary embodiment, the system may further include a trading host computer system 1030 which may include, according to an exemplary embodiment, an index retrieval subsystem 1020 operative to retrieve and/or store an instance of the non-market capitalization, non-price related objective measure of scale and/or size based index, and/or multi-dimensional array of data objects from a storage device; a trading accounts management subsystem 1022 operative to manage accounts data relating to a plurality of accounts including positions data, position owner data, and position size data, any data of which may be stored in trading accounts database; and/or a purchasing subsystem 1024 operative to purchase from an exchange host system 1028 one or more positions for the position owner, according to the index and/or array of data objects.

Exemplary Process Control System

According to an exemplary embodiment, the system may be used to compute using data objects input via an input/output subsystem, a multi-dimensional array storing database system for storage of a multi-dimensional array computed via a multi-dimensional object array creation subsystem comprising a selection subsystem operative to select one or more objects based on one or more technical parameters, and a weighting subsystem operative to weight the selected one or more objects based on one or more technical parameters, wherein the technical parameters are chosen such that the technical parameters avoid influence of an undesirable predetermined technical criterion and/or criteria, so as to avoid influence of the undesirable predetermined technical criterion and/or criteria. As a result of elimination of the undesirable predetermined technical criterion and/or criteria, the multi-dimensional array selected and/or weighted to avoid influence of the undesirable predetermined technical criterion and/or criteria may as a result perform processing from negative effects from the undesirable predetermined technical criterion and/or criteria. An exemplary embodiment of the selection subsystem may be operative to select objects from a predetermined universe of objects to obtain a subset of the universe, where the selection is based on a technical parameter that is not influenced by the undesirable technical criterion and/or criteria. Following execution of the selection subsystem, according to an exemplary embodiment, an exemplary weighting subsystem may operative to weight the resulting selected objects by a weighted combination of two or more technical weighting criteria, which are not influenced by the undesirable technical criterion and/or criteria. The process may be used for such technical processes as may include, e.g. but are not limited to, industrial automation, production process automation, a manufacturing process, and/or a chemical processing system, among others as described elsewhere, herein.

Table 4 below illustrates an exemplary embodiment of a system and method for determining the discount rate and the fundamental value across two hypothetical stocks with the same net earnings ($10) but that exhibit heterogeneous fundamental value generating factors under an efficient market hypothesis. Table 4 shows that stock A has a higher determined fundamental value ($300) due to its superior fundamental value generating factors, as measured by the volatility per unit growth rate, and a lower determined volatility premium and discount rate. Conversely, table 4 shows that Stock B exhibits a lower determined fundamental value ($100) due to its relatively inferior fundamental value generating factors, a higher volatility premium and a higher discount rate.

TABLE 4
Illustrates the discount rate and the fundamental value across
two hypothetical stocks with the same net earnings but that
exhibit heterogeneous fundamental value generating factors.

| Factors/Variables | Stock A | Stock B |
|---|---|---|
| Net Earnings (a Size Factor) | $10.00 | $10.00 |
| Growth Rate | 15.00% | 5.00% |
| Deviation Rate | 5.00% | 15.00% |
| Volatility Per Unit Growth Rate | 0.33 | 3.00 |
| Volatility Premium | 0.83% | 7.50% |
| Risk Free Rate | 2.50% | 2.50% |
| Discount Rate | 3.33% | 10.00% |
| Fundamental Value | $300.00 | $100.00 |

It is appreciated herein that Stock A may be a Growth Stock and Stock B may be a Value Stock

Table 5 shows that when a stock is fair valued, i.e., when the determined fundamental value (FV) equals the market price (P), the determined discount rate equals the earnings yield (E/P), i.e., investors assessment, in an efficient market. Hence, a stock would be considered “fair” valued when the determined discount rate equals the earnings yield (E/P) and when further the by this application determined fundamental value equals the market price (P) as illustrated in table 5. It is appreciated herein that when a stock is “fair” valued the expected return is zero, i.e., no valuation premium is present.

TABLE 5
Illustrates the fundamental value (FV) and the market price (P) the
earnings yield (E/P) and the discount rate under an efficient market
hypothesis across two hypothetical stocks exhibiting similar net
earnings by dissimilar fundamental value generating factors.

| Variables/Factors | Annotation | Stock A | Stock B |
|---|---|---|---|
| Market Value (P) | (1) (5) | $300.00 | $100.00 |
| Net Earnings (E) (size factor) | | $10.00 | $10.00 |
| Price-Earnings Ratio (P/E) | | 30 | 10 |
| Earnings Yield (E/P) | (4) | 3.33% | 10.00% |
| Growth Rate (aka Size Factor | | 15.00% | 5.00% |
| Growth Rate) | | | |
| Deviation Rate | | 5.00% | 15.00% |
| Volatility Per Unit Growth Rate | | 0.33 | 3.00 |
| (aka Size Factor | | | |
| Growth Rate Unit Volatility) | | | |
| Volatility Premium | | 0.83% | 7.50% |
| Risk Free Rate | | 2.50% | 2.50% |
| Discount Rate | (2) (4) | 3.33% | 10.00% |
| Fundamental Value (FV) | (3) (5) | $300.00 | $100.00 |

Annotation:
(1) The market value (P) = Net earnings (E) divided by the Earnings yield (E/P) or alternatively Net Earnings multiplied by the P/E in a fully efficient market
(2) The discount rate = volatility premium + risk free rate
(3) Fundamental Value (FV) = Net earnings (E) divided by the Discount rate
(4) The determined discount rate equals the earnings yield (E/P) in efficient markets
(5) Both stocks are fair valued, i.e., the determined fundamental value (FV) equals the market value (P)

It is contemplated that conventional teaching would argue that Stock B is cheap (more inexpensive or underpriced) because Stock B exhibit a lower P/E ratio and a higher earnings yield (E/P). Conversely, it is understood that conventional teaching would assert that Stock A is expensive (overpriced) because Stock A exhibit a higher P/E (lower earnings yield (E/P)). It is understood that the present invention (as disclosed in one or more embodiments herein) (and as illustrated in Table 5) disagrees with the conventional teaching by asserting that both stocks are fair valued.

It should be noted that while the earnings based fundamental value is determining by discounting (dividing) a company's (stocks) net earnings by the determined discount rate, it is contemplated that an earnings based fundamental value may also be determined by multiplying a stocks net earnings by 1 divided by the discount rate, (1/discount rate). The former proxy the earnings yield (E/P) and the latter the price to earnings ratio (P/E). While the calculation method appears different, it is understood that both methods generates the same end result.

Some embodiments are directed to a holistic multifactor method for determining a discount rate. The discount rate comprises of a volatility premium and a risk free rate. The volatility premium is designed based on a risk per unit reward factor metric which allows controlling for individual stocks heterogeneous fundamental value generating factors, volatility, growth and profitability. It is further appreciated herein that growth and profitability factors may be considered reward factors and the volatility factor, a risk factor.

Fundamental value generating factors are engineered into a volatility per unit growth metric (or rate) which comes to effectively measure the quality of a stocks ex-post growth rate in fundamental size factors, such as book value, revenues and earnings. It is appreciated herein that a low volatility per-unit growth rate leads to a lower volatility premium (and a lower discount rate) and a high fundamental value, all else equal. Conversely, a higher volatility per-unit growth rate leads to a higher volatility premium and higher discount rate and a lower fundamental value. Hence, a high fundamental value, all else equal, is desired because it requires a low volatility premium and a low-volatility premium because of its superior fundamental value generating factors. It is further contemplated that long-term investors desire to invest (select or overweight) an investment portfolio that comprises securities exhibiting favorable fundamental value generating factors, such as high profitability, high growth, low volatility and which further exhibits low valuation. These and other objects are achieved by the provision of a computer system for holistic multifactor method for determining index weights in smart beta indexation, which are described in various embodiments in this application.

In one embodiment a system, method and computer program product for determining portfolio weights for individual securities using holistic multifactor method, the method comprising the steps for each stock in the universe of stocks: 1) obtaining a net earnings at present time (t0); 2) determining a growth rate for a period of time (t0-t−n); 3) determining a volatility per unit growth rate at the present time (t0) by calculating a deviation rate of the growth rate for the given stock for the period of time (t0-t−n), and then dividing the calculated deviation rate by the determined growth rate; 4) determining a discount rate at the present time (t0) by (i) multiplying the determined volatility per unit growth rate by a Risk Free Rate at the present time (t0) and said multiplying generating a volatility premium, and (ii) adding the generated volatility premium to the Risk Free Rate at the present time (t0), said adding resulting in the calculated discount rate at the present time (t0) for the given stock, such that the discount rate is determined by a holistic multifactor method that is exclusive of a market price of the given stock; 5) determining a fundamental value at the present time (t0) by dividing the fundamental size factor at the present time (t0) by the determined discount rate at the present time (t0); 6) adding distributions at present time (t0) to the determined fundamental value at present time (t0) and to the book value at present time (t0); 7) determining a fundamental portfolio weight, by selecting the higher of (i) the determined fundamental value at present time (t0) and (ii) the book value at present time (t0); 8) generating an investment portfolio at present time (t0) by ranking, in descending order, each stocks in the universe of stocks by its determined fundamental portfolio weight.

A fundamental size factor refers to accounting based factors found in a company's income statement, balance sheet, cash flow statement or the like. A fundamental size factor may be a company's last reported revenues, earnings before interest and taxes, net earnings, cash flow, book value (shareholders equity), dividends, etc. Fundamental size factors may be reported quarterly, annually and on a trailing twelve months (TTM) basis. A fundamental size factor may also be referred to as a fundamental metric in this application. A composite of fundamental size factors may be an equally weighted average of two or more fundamental size factors. Particularly excluded factors (when applied in the process of determining a fundamental value, i.e., the size factor to be discounted) in this application are; a) market capitalization (i.e., market value or price), b) free cash flow, c) dividends, and d) buybacks (a.k.a. stocks repurchases). These factors when used individually, or in a combination, are inappropriate factors because they are not linked to a company's fundamental value generating process. In a preferred embodiment a company's trailing twelve months (TTM) net earnings is the fundamental size factor. Various alternatives may be used, such as earnings before interest, amortization and taxes (EBITA), core earnings (i.e., earnings that excludes extraordinary or one time earnings) and the like. Net earnings may also be referred to as net income.

It is appreciated herein that sometimes a company may exhibit negative earnings and thus the fundamental size factor will be negative and the determined fundamental value will consequently also be negative. Under such circumstances the company's book value will constitute the fundamental value (or fundamental index weight) for this company. In the case a company (within an investable universe of stocks) should exhibit both a negative net earnings and at the same time a negative book value, it is appreciated herein that such a company does not exhibit any quantifiable fundamental value and thus will be excluded from the resulting investment portfolio. However, these cases are rare.

It is appreciated herein that standard valuation models, such as the discounted cash flow model (DCF) and the dividend discount model (DDM) are impractical models, for at least two reasons. First, free cash flow and dividends are not fundamental value generating factors. Companies invest to generate growth is revenues and earnings to create more value for investors, i.e., grow its fundamental value. The problem is that the standard DCF model treats cash investments for growth as a negative. Hence, when a company makes investments for the purpose of growth in revenues and earnings, the company's free cash flow decreases and thus also decreases the fundamental size factor to be discounted. The net result is that a company that makes cash investments for the purpose of growth decreases its fundamental value by decreasing the fundamental size factor (i.e., the free cash flow), all else equal. It is appreciated herein that fundamental value generating companies generate cash but they also consume cash to do so. Often fundamental value generating companies' (growth companies) exhibit free cash flows that are often negative, but earnings are positive and growing. Hence, when a company invests for growth, the free cash flow decreases while revenues, earnings and the fundamental value increase. Second, the standard discounted cash flow model (DCF) model commonly uses the standard capital asset pricing model (CAPM) as the proxy for the discount rate. It is well known that the CAPM fails to explain risk (the risk premium) across stocks that exhibit heterogeneous risk and reward characteristics, such as heterogeneous volatility, growth and profitability. In other words, the CAPM cannot separate stocks that invest for growth (growth stocks) from companies that does not invest for growth (value stocks) based on risk. This problem is sometimes referred to as the “value premium puzzle” in finance. In all, the standard discounted cash flow (DCF) model does not offer investors a practical application, i.e., a valuation model that works in the real world.

Similarly, dividends are used as the fundamental size factor (in the numerator) in the standard dividend discount model (DDM). This is impractical for several reasons. First, not all companies pay dividends (typically not growth stocks) and as a result a fundamental value cannot be determined for these companies. Second, dividend is not a fundamental value generating factor. Dividend payouts reduce available cash that could be used for growth investments for the purpose of growing a company's fundamental value and for that reason the dividend factor (also known as the income factor) is not linked to the fundamental value generating process within a company. Further, the missing link between fundamental value generation and dividends leads to a problem in forecasting dividends as it is difficult to forecast pay-out ratios. Similarly, a stock buybacks (repurchase of its own stocks) transmit cash from a company to its investors and are, in that sense, not different from dividends. In all, standard valuation models, such as the DDM and DCF as well as the standard capital asset pricing model (CAPM), are misguiding and for that reason impractical models as they do not provide for a solution to valuation (i.e., determining a fundamental value) that works in the real world.

It is appreciated herein that stocks that exhibit superior fundamental value generating factors, such as higher growth, higher profitability and lower volatility may be referred to as “growth” stocks and stocks that exhibit inferior fundamental value generating factors such as lower growth, lower profitability and higher volatility may be referred to as “value” stocks. It is further contemplated that growth stocks are profitable stocks, i.e., stocks that can economically justify additional or continued investments for growth in revenues and earnings. Typically, a growth stock does not pay dividends, instead they typically use operating cash flow for additional or continued investments for growth. Conversely, a value stock, which exhibit low profitability, typically cannot economically justify additional or continued investments for growth in revenues and earnings. As a result, a value stock exhibit slow, sometimes declining, growth in revenues, earnings and fundamental value, and for that reason typically compensates their stockholders by paying dividends. In this application it asserted that profitability (i.e., the profitability factor) and the discount rate factor are the dividing factors that separate growth and value stocks based on economic justification (or business rationale). That is, a growth stock exhibits a profitability rate that exceeds or equals its determined discount rate (the hurdle rate) while a value stock exhibits a determined discount rate that is greater than its profitability rate.

Based on this rationale it is contemplated that the standard label ‘blend’ stocks becomes redundant. That is because a “blend” stock may either be sufficiently profitable or not. Hence, based on this rationale (as discussed above) allows to bisect a broad (all style inclusive) equity universe into growth and value portfolios without leaving a large part (typically ⅓) labeled blend stocks. This technique opposes the conventional method of separating growth from value stocks by common valuation multiples, such as the P/E and/or P/B ratios, and mere growth factors, such as revenue and earnings growth.

In this application it is appreciated that a new style classification system, in where growth stocks are defined as stocks that exhibit a profitability rate that is equal or greater than the determined discount rate and in where value stocks are defined as stocks that exhibit a determined discount rate that is greater than the profitability rate, solves for problems inherent in the conventional method of bisecting a broad equity universe into growth and value portfolios.

It is contemplated that the classification system (as disclosed herein) improves over the conventional method by providing for a method or technique that is justified in economic rationale. This allows investors that prefer growth portfolios would invest in companies (stocks) that exhibit superior fundamental value generating factors, and investors that prefer value portfolios would invest in companies that pay dividends. This in turn improves performance over conventional methods and improves performance and well as implementation costs in non-price based smart beta methods.

It is understood that growth stocks must be sufficiently profitable to economically justify investments for continued growth in asset, revenues and earnings. Hence, the profitability rate and the discount rate (which comprises fundamental value generating factors) are the predominant factors that separate growth from value stocks. It is contemplated that a high profitability rate is always good. The same is not true for a high growth rate, per se. When the profitability rate equal or exceeds the discount rate, faster growth creates value for investors. However, when the profitability rate does not equal or exceed the discount rate, investments for growth destroys value, making the point when the profitability rate equals the discount rate the dividing line between creating and destroying value for investors (stockholders). It is appreciated herein that this dividing line between creating and destroying value is what separate growth from value stocks. It explains why growth stocks utilize operating cash flows for making investments for continued growth and why value stocks use free cash flows to pay dividends (return cash) to its stockholders. It is appreciated that a company starts its life as a growth stock and typically end its life as a value stock. Table 6 below, illustrates the style classification system for bisecting a broad (all style inclusive) equity universe into growth and value portfolios.

TABLE 6
Style Classification System (business life
cycle and key factor characteristics)

| | | Factor Characteristics |
|---|---|---|
| Style | Growth | and Rationale |
| Growth | High Growth | Profitability Rate => Discount Rate |
| Growth | Moderate | Profitability Rate => Discount Rate |
| | Growth | |
| Growth | Slow Growth | Profitability Rate => Discount Rate |
| (late stage | | |
| growth/mature | | |
| growth stocks) | | |
| Value | Slow Growth | Discount Rate > Profitability Rate |

Conventionally, broad equity universes (such as the Russell 1000 and the S&P 500) comprise of growth, value and blend stocks. Blend stocks are stocks that seem to exhibit both growth and value characteristics and for that reason conventionally are included (randomly) in both value and growth indexes. This problem may be referred to as a “style bleeding” problem. It is contemplated that the present classification system provides for a solution to the style “bleeding” problem inherent traditional growth and value indexes. In short, Growth stocks are stocks that exhibit a profitability rate=>the discount rate; value stocks are stocks that exhibit a profitability rate<the discount rate. It is appreciated herein that, as a result, the conventional style label “bend stocks” becomes redundant and the style bleeding problem, across growth and value indexes, can be avoided.

The growth rate may be determined as the average growth rate based on one or more fundamental size factors over an ex post period of time. The ex post growth rate measurement may be based on a company's quarterly data or annual data which may be a calendar year or fiscal year. An ex post period may be three to six calendar years. The growth rate may be based on calendar years data and trailing twelve month (TTM) data, and where the TTM data is used for the most recent period. The growth rate may further be based on one or more profitability factors or a combination of one or more fundamental size factors and profitability factors. Profitability factors may be a company's return on equity (ROE), return on assets (ROA), return on invested capital (ROIC) or the like. Because sufficient profitability is necessary for sustaining long-term growth, it may be advantageous to consider profitability when determining a growth rate. It is appreciated herein that if a stock exhibits high growth rate in revenues and earnings and a low profitability rate would result a lower growth rate as the lower profitability factor would lower the average growth rate for the stock as compared with a growth rate that is determined only by growth in revenues and earnings. It is further contemplated that “growth” stocks, exhibits higher growth in revenues and earnings and higher profitability, while value stocks exhibits relatively low growth rates in revenues and earnings and low profitability rates. It is contemplates that bend stocks generally exhibit low growth rates but higher profitability rates.

A growth rate may be determined as (i) an average growth rate (ii) a compounding annual growth rate (CAGR), (iii) a mean growth rate, (iv) a median growth rate, (v) a mode growth rate (vi) or similar measures. It is further contemplated that a growth rate may be negative. It is appreciated herein that a negative growth rate would result in a negative (i) volatility per unit growth rate, (ii) a negative volatility premium, (iii) a negative discount rate and (iv) a negative fundamental value. It is appreciated herein that under these circumstances a company's last reported book value (shareholders equity) will be the proxy of the company's fundamental value. In a preferred embodiment the growth rate is determined by calculating the composite average growth rate of; (i) revenues, (ii) net earnings and (iii) return on assets (ROA). (best mode). Table 7 illustrates an exemplary embodiment for determining a growth rate based on two fundamental size factors, revenues and net earnings and one profitability factor, return on assets (ROA). It is appreciated herein that Johnson & Johnson conventionally may be classified as a “blend” stock as the company exhibits an average low growth rate (1.12%) and a clearly higher profitability (ROA on average (11.97%) which results in a determined growth rate of 6.55%. However, under the classification system, as disclosed herein, Johnson & Johnson would be classified as a growth stocks (and consequently be allocated to a Growth portfolio), for reasons discussed above.

TABLE 7
Illustrates an exemplary embodiment for determining a Growth rate
Amounts in $ million: Data: FactSet

| Ref. | | | | | | | | |
|---|---|---|---|---|---|---|---|---|
| Nbr | | JOHNSON & JOHNSON | 2013 | 2014 | 2015 | 2016 | TTM | AVERAGE |
| 1 | Input data | Revenue | $71,312 | $74,331 | $70,074 | $71,890 | $72,174 | $72,117 |
| 2 | Input data | Net Income | $13,831 | $16,323 | $15,409 | $16,540 | $16,505 | $16,194 |
| 3 | Calculation | Composite | $42,572 | $45,327 | $42,742 | $44,215 | $44,340 | $44,156 |
| | | Average (ref. 1&2) | | | | | | |
| 4 | Calculation | YOY Growth | | 6.47% | −5.70% | 3.45% | 0.28% | 1.12% |
| | | Rate | | | | | | |

| | | | | | | | |
|---|---|---|---|---|---|---|---|
| 5 | Input data | Profitability - Return on | 12.41% | 11.68% | 12.05% | 11.75% | 11.97% |
| | | Assets (ROA) | | | | | |
| 6 | Calculation | Composite Average Growth- | 9.44% | 2.99% | 7.75% | 6.02% | 6.55% |
| | | Profitability Rate (ref. 4&5) | | | | | |

In some embodiments, the volatility per-unit growth rate combines multiple fundamental value generating factors into a coherent multifactor risk measure. These fundamental value generating factors includes, fundamental growth factors, such as growth in revenues and earnings, profitability, such as return on assets (ROA), and fundamental growth volatility (i.e., the deviation rate). The volatility per unit growth rate is determined by calculating a deviation rate of the growth rate for a given stock over an ex-post period of time (t0-t−n), and then dividing the calculated deviation rate by the determined growth rate. The resulting risk measure considers the quality (or sustainability) of fundamental growth, by considering not only growth per se, but also profitability (a necessary factor for a company to sustain a long term growth rate) and volatility (that is a factor, when it's high, is detrimental for long term sustainability in growth). Hence, for a company to experiencing high long-term growth in its fundamental value, the company must exhibit strong fundamental value generating factors, such as high fundamental growth, high profitability and low growth volatility. It is appreciated herein that growth volatility is also referred to as the deviation rate in this application. A high volatility per-unit growth rate high unit factor volatility) indicates higher risk (i.e., higher uncertainty in future growth) and a low volatility per-unit growth rate indicate lower risk (i.e., lower uncertainty in future growth). It is appreciated herein that a risk free asset exhibits no (zero) volatility per-unit growth rate. In this way the volatility per-unit growth risk measure further link to the risk free rate (i.e., the risk free growth rate).

In one embodiment, the deviation rate of the growth rate may be determined as either a standard deviation or a semi deviation. It may be preferred to exclude profitability factors when determining the deviation rate. Hence, the deviation rate may be calculated based on a composite average measure of (i) revenues and (ii) net earnings only. It is appreciated herein that by dividing the deviation rate by the determined growth rate, allows to determine a volatility per unit growth rate (metric or factor), that provides for a two dimensional view of the strength in fundamental value generating factors. That is, not only growth and profitability are considered but also the consistency (i.e., the deviation rate) in determining the overall strength in fundamental value generating factors.

It is appreciated herein that a high growth rate and a low deviation rate results in a low volatility per unit growth rate, a low volatility premium, a low discount rate and a high determined fundamental value for a company, all else equal. Conversely, a low growth rate and a high deviation rate results in a high volatility per unit growth rate, a high volatility premium, a high discount rate and low determined fundamental value, all else equal. The deviation rate may also be referred to as a volatility rate in this application.

In one embodiment, the discount rate comprises of a volatility premium and the risk free rate. The volatility premium controls for individual stocks heterogeneous fundamental value generating factor through the volatility per unit growth rate. A high volatility premium indicates high risk and a low volatility premium indicates low risk. A security that exhibits zero volatility per unit growth is (per definition) a risk free asset. The risk free rate controls for macroeconomic risk which is common for all stocks. The discount rate is determined by multiplying the determined volatility per unit growth rate by a risk free rate at the present time (t0) and said multiplying generating a volatility premium, and (ii) adding the generated volatility premium to the risk free rate at the present time (t0), said adding resulting in the determined discount rate at the present time (t0) for individual stocks. It is appreciated herein that the volatility premium and the discount rate is determined by a holistic multifactor method that controls for individual securities heterogeneous fundamental value generating factors and the risk free rate independent from investors assessment, i.e., independent from the market price of the security. Table 8 below illustrates the relationship between the volatility premium and the discount rate across two risky assets (stocks) and one risk free asset.

TABLE 8

| | Risky | Risky | Risk Free |
|---|---|---|---|
| Factors/Variables | Asset A | Asset B | Asset C |
| Growth Rate | 5.00% | 15.00% | 2.50% |
| Deviation Rate | 15.00% | 5.00% | 0.00% |
| Volatility Per Unit Growth Rate | 3.00 | 0.33 | 0.00 |
| Risk Free Rate | 2.50% | 2.50% | 2.50% |
| Volatility Premium | 7.50% | 0.83% | 0.00% |
| Discount Rate | 10.00% | 3.33% | 2.50% |

As shown in table 8, risky Asset A exhibits a higher volatility per unit growth rate, a higher volatility premium and a higher discount rate, relative to risky Asset B because risky Asset A clearly exhibits relatively inferior fundamental value generating factors. The risk free Asset C exhibits, contrary to Asset A and B, a zero deviation rate, and thus exhibits a volatility per unit growth rate that is zero, and a volatility premium that is zero and is for that reason considered risk free. That is, a risk free asset exhibits a certain growth rate. It is appreciated herein that the volatility per unit growth rate and the volatility premium allows for an improved determination of a discount rate across securities that exhibit heterogeneous fundamental value generating factors, and across asset classes, such as stocks and bonds.

The fundamental value for a stock is determined by discounting (dividing) a fundamental size factor, such as net earnings, by the determined discount rate. It is appreciated herein that the fundamental value is determined without reference to a market price, i.e., without reference to the markets assessment. This is important because investors may be subject to behavioral biases (also known as cognitive biases) which may lead to errors in the determination of a stocks fundamental value which leads to mispricing of the stock. The term fundamental value may also be referred to as an intrinsic value or simply a fair value in this application.

It is appreciated herein that determining the fundamental value independent from a price, is paramount for capturing the (bonda fide) valuation premium in equity markets. That is because the essence of investing is to select (or overweight stocks) that are underpriced by the market. Hence, if a fundamental value cannot be adequately determined, the valuation premium cannot be captured (harvested) efficiently in equity markets, nor can investors adequately allocate assets across stocks and bonds (fixed income), or mitigate downside risk. It is further contemplated that conventional methods have failed to satisfactory (accurately) determine a fundamental value independent from a market price.

It is appreciated herein that in one or more preferred embodiments of the present invention the valuation premium is captured indirectly (i.e., by not directly considering the market value in the embodiment) across individual stocks by indirectly overweighting stocks that exhibit a fundamental value that is greater than its market price. It is appreciated herein that if a stocks determined fundamental value is greater that the stocks market price, the stock will be overweighed relative to the stocks weight in a market cap weighted portfolio and vice versa. Table 9 below illustrates the determined fundamental value, the market value and the valuation premium across 50 large cap stocks.

TABLE 9
Illustrates a Generated Investment Portfolio Across 50 Large Cap Stocks
Determined Fundamental Value vs Market Value and the Valuation Premium
Amounts in $ million: Data Factset: As of Aug. 31, 2017

| | | Fundamental | | Market | | Valuation | |
|---|---|---|---|---|---|---|---|
| Rank | Company Name | Value | Weight % | Value | Weight % | Premium | Sector |
| 1 | Apple Inc. | $843,064 | 10.24% | $753,718 | 9.55% | $89,346 | Information Technology |
| 2 | Alphabet Inc. Class A | $484,169 | 5.88% | $540,107 | 6.84% | ($55,938) | Information Technology |
| 3 | Microsoft Corporation | $417,511 | 5.07% | $508,935 | 6.45% | ($91,424) | Information Technology |
| 4 | Johnson & Johnson | $364,519 | 4.43% | $337,642 | 4.28% | $26,877 | Health Care |
| 5 | Altria Group, Inc. | $355,334 | 4.32% | $138,513 | 1.76% | $216,821 | Consumer Staples |
| 6 | Walt Disney Company | $320,017 | 3.89% | $179,298 | 2.27% | $140,719 | Consumer Discretionary |
| 7 | Facebook, Inc. Class A | $282,096 | 3.43% | $334,552 | 4.24% | ($52,456) | Information Technology |
| 8 | Home Depot, Inc. | $226,612 | 2.75% | $176,624 | 2.24% | $49,988 | Consumer Discretionary |
| 9 | Amgen Inc. | $226,324 | 2.75% | $120,738 | 1.53% | $105,586 | Health Care |
| 10 | Oracle Corporation | $218,479 | 2.65% | $183,556 | 2.33% | $34,923 | Information Technology |
| 11 | Comcast Corporation Class A | $213,083 | 2.59% | $177,903 | 2.25% | $35,180 | Consumer Discretionary |
| 12 | Gilead Sciences, Inc. | $198,200 | 2.41% | $88,788 | 1.12% | $109,412 | Health Care |
| 13 | UnitedHealth Group Incorporated | $186,076 | 2.26% | $158,246 | 2.01% | $27,830 | Health Care |
| 14 | CVS Health Corporation | $173,356 | 2.11% | $80,517 | 1.02% | $92,839 | Consumer Staples |
| 15 | Intel Corporation | $170,851 | 2.08% | $170,539 | 2.16% | $312 | Information Technology |
| 16 | Coca-Cola Company | $157,749 | 1.92% | $182,153 | 2.31% | ($24,404) | Consumer Staples |
| 17 | Honeywell International Inc. | $156,013 | 1.90% | $95,193 | 1.21% | $60,820 | Industrials |
| 18 | Visa Inc. Class A | $155,421 | 1.89% | $165,122 | 2.09% | ($9,701) | Information Technology |
| 19 | Mastercard Incorporated Class A | $149,184 | 1.81% | $119,061 | 1.51% | $30,123 | Information Technology |
| 20 | Accenture Plc Class A | $143,360 | 1.74% | $74,336 | 0.94% | $69,024 | Information Technology |
| 21 | McDonald's Corporation | $140,899 | 1.71% | $105,641 | 1.34% | $35,258 | Consumer Discretionary |
| 22 | Philip Morris International Inc. | $140,501 | 1.71% | $175,136 | 2.22% | ($34,635) | Consumer Staples |
| 23 | PepsiCo, Inc. | $129,352 | 1.57% | $159,763 | 2.02% | ($30,411) | Consumer Staples |
| 24 | IBM Corporation | $125,920 | 1.53% | $163,604 | 2.07% | ($37,684) | Information Technology |
| 25 | 3M Company | $124,330 | 1.51% | $114,338 | 1.45% | $9,992 | Industrials |
| 26 | Boeing Company | $112,924 | 1.37% | $107,546 | 1.36% | $5,378 | Industrials |
| 27 | NIKE, Inc. Class B | $110,488 | 1.34% | $73,855 | 0.94% | $36,633 | Consumer Discretionary |
| 28 | Texas Instruments Incorporated | $106,949 | 1.30% | $80,531 | 1.02% | $26,418 | Information Technology |
| 29 | Reynolds American Inc. | $106,586 | 1.30% | $89,862 | 1.14% | $16,724 | Consumer Staples |
| 30 | General Electric Company | $106,057 | 1.29% | $258,782 | 3.28% | ($152,725) | Industrials |
| 31 | Pfizer Inc. | $96,532 | 1.17% | $203,725 | 2.58% | ($107,193) | Health Care |
| 32 | QUALCOMM Incorporated | $94,015 | 1.14% | $84,694 | 1.07% | $9,321 | Information Technology |
| 33 | HCA Healthcare Inc | $91,259 | 1.11% | $32,984 | 0.42% | $58,275 | Health Care |
| 34 | United Parcel Service, Inc. Class B | $90,364 | 1.10% | $73,954 | 0.94% | $16,410 | Industrials |
| 35 | TJX Companies Inc | $87,766 | 1.07% | $51,053 | 0.65% | $36,713 | Consumer Discretionary |
| 36 | Northrop Grumman Corporation | $86,630 | 1.05% | $41,527 | 0.53% | $45,103 | Industrials |
| 37 | Allergan plc | $86,618 | 1.05% | $80,092 | 1.01% | $6,526 | Health Care |
| 38 | Lowe's Companies, Inc. | $86,514 | 1.05% | $70,541 | 0.89% | $15,973 | Consumer Discretionary |
| 39 | Anthem, Inc. | $84,425 | 1.03% | $43,723 | 0.55% | $40,702 | Health Care |
| 40 | Southwest Airlines Co. | $82,157 | 1.00% | $33,076 | 0.42% | $49,081 | Industrials |
| 41 | Verizon Communications Inc. | $78,389 | 0.95% | $198,869 | 2.52% | ($120,480) | Telecommunication |
| | | | | | | | Services |
| 42 | AbbVie, Inc. | $76,033 | 0.92% | $103,860 | 1.32% | ($27,827) | Health Care |
| 43 | Walgreens Boots Alliance Inc | $75,026 | 0.91% | $89,645 | 1.14% | ($14,619) | Consumer Staples |
| 44 | Time Warner Inc. | $70,428 | 0.86% | $75,660 | 0.96% | ($5,232) | Consumer Discretionary |
| 45 | Kraft Heinz Company | $69,442 | 0.84% | $110,528 | 1.40% | ($41,086) | Consumer Staples |
| 46 | Express Scripts Holding | $67,421 | 0.82% | $39,119 | 0.50% | $28,302 | Health Care |
| | Company | | | | | | |
| 47 | Amazon.com, Inc. | $67,326 | 0.82% | $423,031 | 5.36% | ($355,705) | Consumer Discretionary |
| 48 | Starbucks Corporation | $66,101 | 0.80% | $85,098 | 1.08% | ($18,997) | Consumer Discretionary |
| 49 | Biogen Inc. | $64,449 | 0.78% | $59,032 | 0.75% | $5,417 | Health Care |
| 50 | Lockheed Martin Corporation | $62,759 | 0.76% | $77,557 | 0.98% | ($14,798) | Industrials |
| TOTAL | | $8,229,078 | 100.00% | $7,892,367 | 100.00% | $336,711 | |

| | |
|---|---|
| Valuation Premium - Portfolio $ | $336,711 |
| Valuation Premium - Portfolio % | 4.09% |

As illustrated in table 9, the determined fundamental value better correlates to the market capitalization (i.e., the market price) both for individual stocks and the portfolio as a whole. This in turn allows for reduced tracking errors which in turn reduce turnover costs which improves over existing non price based smart beta solutions, such as fundamental and equal weighted indexes. Further, liquidity and investment capacity is improved.

In determining a company's fundamental value, the fundamental value based index weight may be determined as the higher of, (i) the determined fundamental value, (as determined by discounting a company's net earnings by the determined discount rate), and (ii) the company's last reported book value. The determined fundamental value (as determined by discounting a company's net earnings by the determined discount rate) may also be referred to as an (earnings based) fundamental value. Both these values, i.e., the earnings based fundamental value and the book value, may further include distributions. It is appreciated herein that in various embodiment only the net earnings is discounted using the determined discount rate. In this application, dividends and buybacks are collectively referred to as “distributions”. The term “distributions” refer to dividends and buybacks paid (or performed) by a company. The sum of dividends and buybacks most recently paid or performed by a company are added to (i) the determined fundamental value and to (ii) the most recently reported book value. The book value refers to a company's shareholders equity (a.k.a. net worth).

The rationale for adding distributions (i.e., dividends and buybacks) to the determined fundamental value, and to the most recent book value of a company, is that distributions for many companies (about 60% of a broad equity universe) are the only factor that can be used for compensating stockholders. In other words, companies that exhibit week (inferior) fundamental value generating factors and thus exhibit low growth in their fundamental values commonly use distributions to compensate stockholders for lack of growth in there fundamental value (and thus also a low appreciation in its market price). It is not uncommon that so-called deep value stocks (i.e., stocks that exhibits low P/E or P/B ratios) also exhibits a book value (shareholders equity) that exceeds its determined fundamental value. In these situations it's contemplated that the most recently reported book value represents the stocks fundamental value.

In this application the term distributions refers to dividends and buybacks paid or performed by a company. It is appreciated herein that dividends and buybacks are not fundamental value generating factors. Rather dividends are usually paid by companies that do not exhibit a sufficient profitability rate, i.e., a profitability rate that cannot economically justify for additional and continued investments for growth. Buybacks may be performed regardless of the strength of a company's fundamental value generating factors. Buybacks (i.e., a company's repurchases of its own stocks) is typically conducted when a company's management believes their stocks are underpriced by the market. It is appreciated herein that companies that pay dividends and/or perform buybacks add value to their stockholders.

In a preferred embodiment distributions are determined for each individual stock by adding the trailing twelve months paid dividends to the trailing twelve months performed buybacks. The sum of these two factors is subsequently added to each stocks determined fundamental value and to its most recently reported book value.

The higher of the determined fundamental value and the most recently reported book value represents the fundamental portfolio weight for each individual stock. In this application it is appreciated herein that the term “company” and the term “stock” may mean the same thing and may be used interchangeably throughout various discussions in this application.

The term “investment portfolio” refers to the end result of the various embodiments discussed in this application. Hence the term investment portfolio refers to the resulting portfolio created by using a holistic multifactor method for determining a discount rate and a fundamental value for individual stocks and for selecting and weighting a plurality of investment securities. The resulting investment portfolio is constructed by ranking each individual stock within a universe of stocks in descending order by its determined fundamental portfolio weight.

In an alternative embodiment of a system, method and computer program product for determining an portfolio weight using a holistic multifactor technique, the method comprising the steps for each stock in the universe of stocks: 1) obtaining a fundamental size factor at present time (t0); 2) determining a growth rate at (t0) for a period of time (t0-t−n); 3) determining the deviation rate of the growth rate for the period of time (t0-t−n); 4) determining a volatility per unit growth rate at present time (t0) by dividing the determined deviation rate at (t0) by the determined growth rate at present time (t0); 5) determining a volatility adjusted fundamental size factor at present time (t₀) by dividing the fundamental size factor at present time (t0) by (1+the volatility per unit growth rate) at present time (t0); 6) determining a portfolio weight at present time (t₀) by dividing the volatility adjusted fundamental size factor at present time (t₀) by the risk free rate at present time (t₀); 7) generating non-price based investment portfolio by ranking, in descending order, each stocks in the universe of stocks by its determined portfolio weight.

The above embodiment provides for a solution to a problem known as unintended factor bias in existing solutions. For example, fundamentally weighted indexes overweight's stocks that exhibit low price multiples, such as low P/E or P/B ratios which is not an intended factor bias. Rather, fundamental indexes intend to overweight underpriced stocks. Unfortunately, that is not the case, and instead a fundamental weighted index overweight stocks that exhibit a high earnings yield (a high discount rate as discussed herein) which proxy interior fundamental value generating factors. Hence, fundamentally weighted indexes fail in adequately determining a fundamental value and thus also fail in capturing the valuation premium in equity markets. It is appreciated herein that various embodiments provides for a solution to the problem of unintended factor biases in existing smart beta systems and methods.

Further, some embodiments provide for a solution systematic biases inherent in market cap weighted indexes of overweighting overpriced stocks and underweighting underpriced stocks, while retaining key benefits of market cap weighted portfolios, such as high liquidity, high investment capacity and low turnover costs. In other words, the various embodiments disclosed herein allows for an investment portfolio to capture a very similar investable opportunity set within equities, such as overweighting large cap growth stocks and underweighting small cap value stocks, as is inherent in the conventional market cap-weighted portfolios. It is appreciated herein that a market cap-weighted portfolio represents an investable opportunity set that reflects investor's opinions about individual stocks fundamental values. Table 9 illustrates fundamental value weights and market cap weights across 50 large cap stocks. It is appreciated herein that the term “portfolio” may mean the same as the term “index”.

Further, some embodiments avoid unintended factor bias inherent in smart beta multifactor indexes, by allowing for a solution in combining; (i) the valuation factor with fundamental value generating factors of (ii) growth, (iii) profitability, (iii) low volatility. Conventionally, multifactor indexes combine conventional valuation multiples, such as the P/E or the P/B and/or the like, (known as the value factor) with performance and quality factors, such as profitability, low volatility, etc., using a scoring method and the like. The problem with conventional methods is that the value factor cannot be efficiently combined with performance and quality factors as the value factor is uncorrelated to such factors. Thus, the conventional way of constructing smart beta multifactor portfolios leads to unintended factor biases, also known as factor clashing. That is, the desired factor premiums of a resulting multifactor portfolio effectively cancel out each other. It is appreciated herein that the conventional value factor (e.g., P/E or P/B), which connotes conventional valuation multiples, is misguided because neither net earnings (E), nor the book value (B) provides for an adequate proxy of a company's fundamental value. Hence, P/E or P/B when used to indicate mispricing (i.e., under or overpricing by the market) is misguiding.

Further, it is appreciated herein that conventional methods for multifactor construction using various methodologies, such as mixing (i.e., selecting factor sleeves) and integration methods (i.e., selecting a combination of factors by using scoring methods) are suboptimal methodologies that results in unintended factor bias, high concentrations in few stocks and high implementation costs.

It is appreciated herein that the present application and the various embodiments determine and defines the valuation factor by comparing a stocks determined fundamental value weight (which comprises the process of considering multiple factors) with the stocks market price weight, i.e., market capitalization. The valuation premium is present (and positive) when a stock exhibits a determined fundamental value that is greater than the stocks market price. It is appreciated herein that the resulting investment portfolio overweight's stocks are underpriced by the market by overweighting individual stocks that exhibit a determined fundamental value that is greater than its market price. It is appreciated herein that the valuation premium is captured indirectly, that is, if a stocks determined fundamental value at present time (t0) is greater than its market value at present time (t0), the generated investment portfolio at present time (t0) will overweight this stock relative to the market, i.e., the market capitalization. Table 9 illustrates the determined fundamental value, the market value and the valuation premium across 50 large cap stocks. It is appreciated herein that a valuation premium may be positive or negative. Hence a stock that exhibits a market price that is greater than its determined fundamental value exhibits a negative valuation premium. A valuation premium may also be referred to as an expected return, which in turn may be positive or negative.

It is appreciated herein that the objective with the present invention, and the various embodiments disclosed in this application is: (i) determining a risk (volatility) premium and a discount rate that allows to more accurately determining a fundamental value across stocks that exhibit heterogeneous fundamental value generating factors, such as heterogeneous growth, profitability, and volatility, (ii) determining a valuation premium that can be captured (or harvested) in all stocks regardless of investment style, that is regardless if a stock is classified as a growth, blend, value, large, mid or small cap stock, (iii) determining index weights that improves explaining a fundamental value (independent from the market price) which provides for reduced tracking errors to standard market cap-weighted indexes, while retaining high liquidity, high investment capacity and low turnover cost, (iv) selecting securities for a portfolio (also known as bisecting a broad equity universe into growth and value portfolios) that exhibit sufficiently strong (superior) fundamental value generating factors and thus improve performance and implementation costs, (v) provide for improved implementations costs, such as improving liquidity, investment capacity and turnover costs over existing (smart beta) index solutions. It is understood that the various embodiments achieve this by using a holistic multifactor method for selecting securities and for determining index weights that are independent from the market price.

Some embodiments provide a solution for (i) systematic bias inherent in conventional market cap weighted indexes of overweighting overpriced stocks and underweighting underpriced stocks when stock market exhibits inefficiencies (i.e., when a stocks or group of stocks determined fundamental value deviates from their market price), (ii) systematic bias inherent in conventional fundamental weighted and equal weighted indexes of generally overweighting stocks that exhibit low valuation multiples, such as low P/E or P/B. It is appreciated herein that stocks that exhibits low valuation multiples also typically exhibits inferior fundamental value generating factors, such as low growth, low profitability, high growth volatility, (iii) systematic bias inherent in existing multifactor indexes such as unintended factor bias arising when combining the conventional value factor with uncorrelated performance and quality factors, such as, high growth and high profitability.

Further, the present invention provides for a solution to the problem inherent in the conventional capital asset pricing model (CAPM) by providing for a discount rate that allows determining a fundamental value for individual securities exhibiting heterogeneous risk and reward characteristics, as measured by fundamental value generating factors. It is appreciated herein that the CAPM cannot explain the discount rate, the fundamental value and the valuation premium in a cross section of securities exhibiting heterogeneous risk and reward characteristics, such as value and growth stocks. Moreover, it is appreciated herein that conventional valuation models, such as the discounted cash low model (DCF) and the discounted dividend model (DDM) and the like, are misguiding (flawed models) and that the present embodiments in this application provides for a solution to problems inherent in such conventional methods.

Some embodiments in this application overweight's large cap growth stocks and underweights small cap value stocks (all else equal) providing for a resulting investment portfolio that enables for a broad participation in equity markets, and which further allows for improved implementation costs, such as high portfolio liquidity, high investment capacity, and low annualized turnover. It is appreciated herein that these and other favorable portfolio characteristics benefits investors by offering improved long term performance such as higher portfolio returns and reduced risk but also by providing for reduced implementation costs over existing portfolio solutions.

It is appreciated herein that the various embodiments improves over existing smart beta index solutions, such as fundamentally weighted indexes, equal weighted indexes, and multifactor indexes by uniquely engineering or combining multiple fundamental factors in determining a discount rate, a fundamental value and a valuation premium in a cross section of investment styles, e.g., value, growth, blend, large cap, mid cap and small cap stocks. It is furthermore appreciated herein that by more accurately (without prior art errors) determining a discount rate, a fundamental value and a valuation premium further offers important, and by existing solutions unachieved, improvements. By allowing for more accurately determining an fundamental value (as a portfolio weight) further improves implementation costs, by 1) reducing tacking errors over existing solutions, 2) which in turn reduces portfolio turnover costs (improves cost efficiency) and 3) improves investment capacity (by reducing capacity constraints). Moreover, because the determined portfolio weights assigns higher weights to large cap-growth stocks and smaller weights to small cap-value stocks, the liquidity of the portfolio is improved over existing smart beta methods. Higher liquidity provides for ease (faster) of trade which further reduces transactions costs. It is appreciated herein that various embodiments allows capturing the by existing solutions unachieved large cap-growth valuation premium in equity markets.

It is appreciated herein that various embodiments allows for a low tracking error relative to existing non price based smart beta solutions, such as fundamentally weighted portfolios, equally weighted and multifactor portfolios, which provides for unprecedented low implementation costs. It is further appreciated herein that the some embodiments benefit users by offering, a) improved long term investment returns, b) reduced downside risk (achieved by severing the portfolio weighting method from the market price, which may be subject to investors behavioral biases), c) reduced performance cyclicality (improved performance in both advancing (bull) markets and declining (bear) markets) due to that the higher portfolio weights capitalize on multiple compensated factor premium, such as higher growth (investments) in revenues, earnings, and dividends, higher profitability and lower growth volatility. It is appreciated herein that one or more embodiments in this application enables for constructing an all-inclusive (broad) investment portfolio that may comprise of thousands of stocks in domestic or global equity markets and in where large cap growth stocks are overweighed and small cap value stocks are underweighted.

In some embodiments, a fundamental size factor used in various embodiments may be based on one or more fundamental size factors and where a fundamental size factor may further be determined by an ex-post trailing average of one or more fundamental size factors. Further, a fundamental size factor (or a combination of one or more fundamental size factors) may be adjusted for volatility using the volatility per unit growth metric. Table 10 below illustrates one embodiment of the present invention across two stocks exhibiting heterogeneous risk (volatility) and reward (growth/profitability) characteristics in where the fundamental size factor is adjusted for volatility using the determined volatility per unit growth metric.

TABLE 10

| Ref: | Factors/Variables | Stock A | Stock B |
|---|---|---|---|
| A | Fundamental Size Factor | $100.00 | $100.00 |
| B | Growth Rate | 10.00% | 5.00% |
| C | Deviation Rate | 5.00% | 10.00% |
| D | Volatility Per Unit Growth | 0.50 | 2.00 |
| | Rate (C/B) | | |
| E | Volatility Adj. Fundamental | $66.67 | $33.33 |
| | Size Factor (A/(1 + D)) | | |
| F | Portfolio Weighting (E) | $66.67 | $33.33 |

By dividing a fundamental size factor (or a combination of fundamental size factors) by 1+the volatility per unit growth rate allows for controlling for individual stocks heterogeneous volatility and growth characteristics, i.e., fundamental value generating factors. As a result, a stock that exhibits superior long term performance characteristics (i.e., superior fundamental value generating factors) (i.e., stock A) also exhibits a higher portfolio weight as compared to stock B which exhibits relatively inferior fundamental value generating factors, i.e., a lower growth rate and a higher deviation rate. It is appreciated herein that this particular embodiment does not consider the risk free rate, and thus the portfolio weights are not affected by changes in risk free rate. It is further contemplated that a fundamental value may be determined by dividing the volatility adjusted fundamental size factor by a risk free rate. It is appreciated herein that making a volatility adjustment for a fundamental size factor controls for individual stocks heterogeneous volatility and growth characteristics, i.e., fundamental value generating factors.

It is appreciated herein that the determined volatility adjusted fundamental size factor and the determined fundamental value is a present value that considers not only the present size of a company but also the company's unique fundamental value generating factors, such as growth, profitability and volatility. It is appreciated herein that growth and profitability may be viewed as rewarding factors while volatility may be viewed as a risk factor. It is appreciated herein that high volatility is an adverse (not desired) factor as it has a negative effect on a company's long-term growth in its fundamental value.

In various embodiments it may be advantageous to factor in a stocks future growth potential because stocks exhibits various future growth potentials, as measured by fundamental value generating factors. It could be argued that growth stocks (which exhibit superior growth as explained by fundamental value generating factors) deserve a higher portfolio weight reflecting these factors (all else equal). Hence, it may be advantageous to factor in future growth potential in the portfolio weights. One way of achieving this is to make a volatility adjustment of the ex post growth rate (i.e., demonstrated historical performance) and further extrapolate the ex post growth rate into a future looking growth rate. Consequently, a determined volatility adjusted fundamental size factor (or alternatively the determined fundamental value) may be adjusted to reflect future growth expectations, which may be determined, by multiplying the determined volatility adjusted fundamental size factor (or alternatively the determined fundamental value) by ((1+the volatility adjusted growth rate at t0)\hat{ }number of periods). It is appreciated herein that a growth adjustment may be used in some of the embodiments in this application.

Table 11 below illustrates volatility-adjusted-growth-rates across two hypothetical stocks exhibiting heterogeneous fundamental value generating factors but with similar (the same) present fundamental values.

TABLE 11
Volatility Adjusted Growth Rate and
Forward Looking Fundamental Value

| Ref. | Factors/Variables | | Stock A | Stock B |
|---|---|---|---|---|
| A | Growth Rate | | 15.00% | 5.00% |
| B | Deviation Rate | | 5.00% | 15.00% |
| C | Volatility Per Unit | (B/A) | 0.33 | 3.00 |
| | Growth Rate | | | |
| D | Volatility Adjusted | (A/(1 + C)) | 11.25% | 1.25% |
| | Growth Rate | | | |
| E | Fundamental Value | | $100.00 | $100.00 |
| | (present value) | | | |
| F | One Year Forward | (E*(1 + D)) | $111.25 | $101.25 |
| | Looking Fundamental | | | |
| | Value | | | |

As illustrated in the table 11, stock A (a hypothetical growth stock) would exhibit a higher forward looking fundamental value due to its higher volatility adjusted growth rate as compared to stock B (a hypothetical value stock) which exhibits a lower volatility adjusted growth rate.

It is appreciated herein, when one set aside the question of valuation (as illustrated in table 11), that an investment portfolio exhibiting superior fundamental value generating factor benefits investor's long term investment performance. Hence, a portfolio that exhibit a sufficient profitability rate (i.e., when a stock's profitability rate that equals or exceed its determined discount rate) higher growth in revenues and earnings and lower growth volatility would be desired for investors seeking long term appreciation in value, such as in fundamental value and in market price.

In one embodiment of a system, method and computer program product for selecting and weighting an investment portfolio using a holistic multifactor method is provided herein, the method comprising the steps for each stock in the universe of stocks: 1) obtaining net earnings at present time (t0); 2) determining a growth rate at (t0) for a period of time (t0-t−n); 3) determining the deviation rate of the growth rate for the period of time (t0-t−n); 4) determining a volatility per unit growth rate at present time (t0) by dividing the determined deviation rate at (t0) of the determined growth rate at present time (t0); 5) determining a volatility adjusted fundamental size factor at present time (t₀) by dividing the fundamental factor at present time (t0) by (1+the volatility per unit growth rate) at present time (t0); 6) determining a fundamental value at present time (t0) by dividing the volatility adjusted fundamental size factor at present time (t₀) by the risk free rate at present time (t0); 7) determining a discount rate at the present time (t0) by (i) multiplying the determined volatility per unit growth rate by a risk free rate at the present time (t0) and said multiplying generating a volatility premium, and (ii) adding the generated volatility premium to the risk free rate at the present time (t0), said adding resulting in the determined discount rate at the present time (t0) for the given stock in the plurality of stocks; 8) selecting each stock in the universe of stocks that exhibit a profitability rate at present time (t0) that is equal or greater than the determined discount rate at the present time (t0); 9) determining a fundamental value at the present time (t0) by dividing the obtained net earnings at present time (t0) by the determined discount rate at the present time (t0); 10) generating a non-price based growth index by ranking, in descending order, each selected stock in the universe of stocks by its determined fundamental value at present time (t0).

The embodiment provides a solution for problems inherent in traditional (conventional) growth indexes, e.g., Russell 1000 growth index, of systematically overweighting overpriced stocks and systematically underweight underpriced stocks. Further, at least one embodiment provides for an improved method for selecting a growth portfolio from a broad investment universe comprising all styles (e.g., value and growth stocks). It is appreciated herein that the conventional method of selecting growth stocks makes use of common valuation multiples (such as P/E or comparable ratios) and growth measures, such as revenue and earnings growth. The conventional approach leads to growth portfolios that may include unprofitable (i.e., not sufficiently profitable) value and blend stocks, which should belong to a value index. This problem is known as a bleeding problem, i.e., both value and growth portfolios to some large extent comprises of the same stocks. This, in all, gives rise to a performance problem in conventional value and growth indexes, which can be summarized as, overweight overpriced stocks and underweight overpriced stocks, and mixing styles which dilute the performance characteristics that should define each index type. That is, if a growth portfolio include stocks that exhibit insufficient profitability (i.e., inferior fundamental value generating factor) these stocks will dilute the otherwise superior long term factors characteristics (as defined by fundamental value generating factors) of a growth portfolio.

Hence, as is disclosed herein, what is desired is a growth portfolio that adequately considers valuation, i.e., overweighting underpriced growth stocks and underweighting overpriced growth stocks, which further capitalizes on superior fundamental value generating factors, that improves long term performance. This, in all, provides for higher growth in the fundamental value of the growth portfolio (and thus also in its market price given that the market is reasonably efficient) which further is improved by overweighting underpriced growth stocks and overweighting overpriced growth stocks.

It is appreciated herein, that in accordance with some embodiments, appropriate consideration of profitability factors from conventional approaches is missing, such as return on assets or comparable measures. In one embodiment, a growth portfolio is selected by marking use of a profitability factor. Hence, a growth portfolio comprises stocks that exhibit a profitability rate that is equal or greater than its determined discount rate. By selecting a growth portfolio this way assures that the selected stocks exhibits strong fundamental value generating factors, such as higher than average growth, adequate profitability and low volatility. It is appreciated herein that the growth factor may also be referred to as the investment factor.

In some embodiments described herein it is appreciated that fundamental value generating factors are factors that support (or aid) the long-term growth in a company's fundamental value. These factors include (i) growth in one or more fundamental size factors, such as revenues and net earnings, (ii) profitability, such as return on assets (ROA) and the like, and (iii) low growth volatility in fundamental size factors. It is appreciated herein that a company that exhibits high profitability, high growth in revenues and earnings, and low growth volatility exhibits strong (superior) fundamental value generating factors and thus grows a company's fundamental value at a higher rate than a company that exhibit weaker (inferior) fundamental value generating factors. These superior (fundamental value generating) factor exposures are necessary for a company to justify for continued investments for sustained long-term growth in its fundamental value. It is appreciated herein that high growth in fundamental value typically also leads to a high growth in a company's market value, i.e., market capitalization.

It is appreciated herein that the profitability factor is a paramount factor. That is because a company must exhibit a sufficient profitability rate in order for the company to economically justify additional and continued investments for growth. More particularly, a company must exhibit a profitability rate that equals or exceed the discount rate in order to economically justify investments for growth and thus qualify as a “growth” stock. It is further contemplated that the faster a company can grow its revenues and earnings by investing more capital at rates of return (i.e., a profitability rate) that exceeds the discount rate, the more fundamental value the company creates for its shareholders. For any level of investment for earnings growth, the fundamental value increases with improvements in profitability, e.g., the return on invested capital.

A high profitability rate is always good. The same is not true for growth. When the return on invested capital (i.e., the profitability rate) equal or exceeds the hurdle rate (i.e., the discount rate), faster growth increases fundamental value. However, when the profitability rate does not equal or exceed the discount rate, making investments for growth destroys value for investors, making the point where when the profitability rate equals the discount rate the dividing line between creating and destroying value for investors (stockholders) through investments for growth. It is appreciated herein that the dividing line between creating and destroying value is what, (based on sound economic rationale) truly separate growth from value stocks. Growth stocks exhibit a profitability rate that exceeds or equals the discount rate while value stocks exhibit a discount rate that exceeds the profitability rate. This explains why, (profitable) growth stocks use operating cash flows for making additional and continued investments for growth in revenue and earnings while (unprofitable) value stocks generally use free cash flows to pay dividends (return cash) to its stockholders.

In this application it is appreciated herein that a growth stock is a company that exhibit a profitability rate that is equal or greater than its determined discount rate, and for that reason growth stocks are (defined as) companies that can economically justify investments for long-term growth in revenues and earnings. Conversely, a value stock is a company that exhibits a determined discount rate that is greater than its profitability rate. It is appreciated herein that blend stocks are mature growth stocks or alternatively young value stocks (i.e., a mature company that may further operate in a mature industry). These stocks are stocks that exhibit both growth and value factor characteristics such as high profitability and low growth and for that reason has been difficult to properly classify, (i.e., are they value or growth). For that reason, “blend” stocks typically are mixed up in conventional value and growth indexes (creating what is (known as a bleeding problem in traditional value and growth indexes). It is appreciated herein that some embodiments solves this problem by the use of the discount rate factor and the profitability factor. Hence, blend stocks generally exhibits low growth in revenues and earnings, but still exhibit sufficient profitability (i.e., profitability rate that equals or exceeds its determined discount rate) would be classified as growth stocks. By making use of a profitability factor in selecting a growth portfolio would more accurately (based on rationale as discussed herein) allowing to bisect an in inclusive broad equity universe into growth and value portfolios. Further, it is understood that the standard label “blend” stocks would become redundant as such stocks would either be classified as growth or value stocks. Hence, the present embodiment allows selecting a well-diversified growth portfolio considering a more business-like method that provides for a solution to problems in the conventional method of selecting and weighting a growth (as well as the opposed value) portfolio.

It is appreciated herein that (i) growth (also known as the investment factor), (ii) profitability (also known as a quality factor), and (iii) low growth volatility (a performance factor) are fundamental value generating factors. Within these three broad factor categories various factors may be used. For example, growth may be measured as growth in book value, revenues, net earnings, or comparable factors. Similarly, profitability may be measured as return on invested capital, return on assets or comparable factors. The growth volatility factor will be based on the growth factors chosen. It is furthermore understood that dividends and comparable factors such as stock repurchases (buybacks) do add value for investors (stockholders) but are not fundamental value generating factors. Dividends and buybacks return capital to investors (stockholders) and consequent reduces available cash that could be used for investments. Dividends are generally paid by value stocks and blend stocks (stocks that either cannot justify for additional investment for growth or profitable blend stocks that simply lack investment opportunities) as compensation to their stockholders, i.e., for exhibiting slow growth in revenues, earnings and thus growth in their fundamental value. As a result value and blend stocks tend to exhibit slow (if any) long term appreciation in market value as well. Thus the only way to compensate investors (stockholders) is by paying regular dividends and/or marking buybacks when appropriate.

Based on this rationale, growth stocks would make use of operating cash flow to make additional and continued investments for growth and not pay dividends. Conversely, value stocks would not use cash flows for making investments for growth, but rather return cash to their stockholders by paying dividends. However, in the real world, growth stocks may also pay dividends for various reasons unrelated to the rationale disclosed in this application. One such reason may be that investors believe that dividends provide a “valuation floor” that reduces downside investment risk in dividend paying companies. It is appreciated herein that a growth company's management may offer dividends to adhere to this common investor perception. Another reason may be that investors appreciate regular dividends payments and that dividends are perceived as less risky as opposed to a company that is making additional and continued investments for growth. Another reason may be that a highly profitable company lacks adequate investment opportunities and for that reason temporarily cannot grow its fundamental value and for that reason makes a decision to use excess cash to pay dividends, e.g. Apple. Growth in fundamental value vs. dividends is ultimately related to a company's position in its lifecycle.

In bisecting a broad equity universe into growth or value portfolios, it is appreciated herein, that the main elements and the predominant factors are a company's long term profitability rate (which may be determined by using an average profitability rate over an ex post period of time) and the determined discount rate. It is appreciated herein that, according to some embodiments, the determined discount rate may proxy a company's cost of capital. Hence, a company would be able to economically justify investments for growth when the profitability rate equals or exceed the determined cost of capital as determined by the discount rate. Table 12 below illustrates an embodiment of the classification system (i.e., the method for bisecting a broad equity universe in to growth and value portfolios) across three hypothetical stocks with similar net earnings but with heterogeneous fundamental value generating factors.

TABLE 12

| Factors/Variables | Stock A | Stock B | Stock C |
|---|---|---|---|
| Market Value | $300.00 | $160.00 | $100.00 |
| Net Earnings (the Fundamental | $10.00 | $10.00 | $10.00 |
| Size Factor) | | | |
| Earnings Yield (E/P) | 3.33% | 6.25% | 10.00% |
| Price-Earnings Ratio (P/E) | 30 | 16 | 10 |
| Fundamental Value Generating | | | |
| Factors: | | | |
| (1) Growth Rate | 15.00% | 5.00% | 5.00% |
| (2) Deviation Rate (aka | 5.00% | 7.50% | 15.00% |
| Volatility Rate) | | | |
| (3) Profitability Rate | 7.50% | 7.50% | 5.00% |
| Volatility Per Unit Growth Rate | 0.33 | 1.50 | 3.00 |
| Volatility Premium | 0.83% | 3.75% | 7.50% |
| Risk Free Rate | 2.50% | 2.50% | 2.50% |
| Discount Rate | 3.33% | 6.25% | 10.00% |
| Fundamental Value | $300.00 | $160.00 | $100.00 |
| Conventional Classification | Growth | Blend | Value |
| Method | | | |
| New Classification Method | Growth | Growth | Value |
| (as disclosed in this | | | |
| application) | | | |

As can be seen in table 12 above, Stock A and Stock B exhibits a profitability rate that is greater than their respective determined discount rates and therefore Stock A and Stock B classifies as growth stocks and would consequently be selected for a resulting growth investment portfolio. However, that is not the case for Stocks C, which exhibits a profitability rate that is far below its determined discount rate and thus would not be included in a resulting growth portfolio.

It is appreciated herein that conventionally Stock A is considered a “growth” stock, Stock B is considered a “blend” stock (because it exhibits a lower growth rate and an average valuation multiple, e.g., an average P/E and Stock C is considered as value stock because it exhibits a comparable low growth and a low P/E ratio. However, when the profitability rate and other fundamental value generating factors are considered using a holistic multifactor method for determining the discount rate, as it is disclosed herein it is appreciated that Stock B would be classified as a growth stock because the profitability rate is greater than its determined discount rate (7.5% vs 6.25%).

It is appreciated herein that “blend” stocks are mature growth stocks which exhibiting slower growth due to operating in a mature industry and thus may lack opportunities for making additional and continued investments for growth in revenues and earnings. However, blend stocks are contrary to value stocks (typically) profitable, (i.e., exhibiting profitability rate that equals or exceed its discount rate). Further, as compared to value stocks, blend stocks tend to exhibit a lower risk (volatility) premium due more stable growth (which may be explained by a sustained competitive advantage) and therefore allows to compensate their shareholders by offering higher and more consistent growth in dividends. Hence, blend stocks differentiate from value stocks by exhibiting stronger fundamental value generating factors while similar as value stocks primarily mainly compensates its stockholders by paying dividends.

Some embodiments as provided herein improve on selecting a growth portfolio by improving the classification system of growth and value stocks by utilizing a holistic multifactor method based on fundamental value generating factors for determining a discount rate. Consequently, companies that exhibit a profitability rate that equals or is greater than the determined discount rate will be selected for the resulting growth portfolio. It is appreciated herein that the selection method disclosed in this application and its various embodiments provides for a solution to the “bleeding” problem inherited in the conventional method of bisecting a broad equity universe into growth and value portfolios.

Some embodiments described herein provide long-term performance advantages as a holistic multifactor growth portfolio benefits from multiple compensated factor premiums (combined in a discount rate) by overweighting stocks that exhibit (i) low valuation (ii) high growth (in revenues, earnings and dividends), (iii) high profitability and (iv) low volatility equity premiums. In other words, valuation and fundamental value generating factors not only allows determining a fundamental value and a valuation premium, but also allows individual stocks and the portfolio as a whole to benefit from higher growth in their fundamental value(s). It is appreciated herein that paying dividends (i.e., returning capital (cash) to stockholders) does not benefit growth companies. However, since blend stocks are reclassified as growth stocks and blend stocks typically pay dividends it is appropriate to include dividends in determining the overall fundamental value (i.e., portfolio weights) for individual stocks in the resulting growth investment portfolio. It is further appreciated herein that various embodiments do this by adding the most recent paid dividends and conducted buybacks to the determined fundamental value. Hence, in a preferred growth portfolio embodiment the resulting portfolio weights benefits not only from fundamental value generating factors, such as higher growth, higher profitability, lower volatility per unit growth rate and the valuation premium, but also on higher (on average) dividend growth and buybacks premiums.

It is appreciated herein that a stock may exhibit various factor characteristics, such as for example low growth and high profitability or high growth and low profitability. The former factor characteristics are common for so called “blend stocks” as discussed. However some companies, conventionally labeled “growth stock” and thus included in traditional growth indexes, are stocks that exhibit high growth in revenues and earnings while exhibiting inadequate profitability, i.e., a profitability rate that is lower than the determined discount rate. It is appreciated herein that a company that makes continued investments for growth in assets, revenues, earnings, etc., (either organically or through acquisitions) without an adequate profitability cannot be economically justified as unprofitable growth cannot be sustained over time. Such companies may be competing for customers for the purpose to gain economic scale and for that reason priorities growth over profitability. For such companies making additional and continued investments for growth is the current priority while profitability would be a secondary priority when the investment for growth objective is achieved. Example of companies that exhibit insufficient profitability (e.g., low return on capital) while making aggressive investment for growth are, Tesla, Netflix and Amazon.com, at least historically. It is appreciated herein that companies that make investments for growth despite exhibiting insufficient profitability exhibit higher downside risk which may lead to unsatisfactory long-term investment returns for their stockholders. It is appreciated herein that the description of profitable-growth vs. non-profitable growth illustrates empirical facts; that is, companies with high investment, despite low profitability, fail in large to provide strong long term returns to shareholders, and in contrast, companies with high profitability, paired with investments for growth, deliver sustainably high growth in revenues and earnings, exhibits lower downside risk and higher long term appreciation in market values.

Nonetheless, not sufficiently profitable growth stocks create a classification problem for the portfolio selection process. As discussed, it may not be appropriate to classify Tesla, Netflix and Amazon as “value” stocks, as value stocks are classified as stocks that exhibit low growth in revenues and earnings due to lower profitability in mature industries. It is further appreciated herein that Tesla, Netflix and Amazon cannot be said to exhibit low growth as they are unquestionably exhibiting high growth in revenues and earnings and are relatively young companies that offers useful new products and/or services in their respective industries. To solve for this problem, it may be advantageous to combine the growth factor with the profitability factor in determining the growth rate. That may be achieved by calculating a composite average of these two factors over an ex post period of time. Hence, if a stock exhibits a high growth rate (e.g., 10%) and a low profitability rate (e.g., 2%) the overall growth-profitability rate becomes 6%, (10%+2%/2). Hence, the higher growth rate is mitigated by the lower profitability as the growth-profitability rate is the average of the two factors. It is appreciated herein that the combined growth-profitability rate may be used as the comparing factor (in the selection process). i.e., that needs to equal or exceed the hurdle rate, i.e., the determined discount rate. Conversely, a stock that exhibits a low growth rate (e.g., 2%) and a high profitability rate (e.g., 10%), which is common “blend” stocks characteristics, would exhibit a similar overall growth-profitability rate of 6%, (2%+10%/2). Hence, both profitable growth stocks and non-profitable growth stocks would classify as “growth stocks”. It may seem counterintuitive to the teaching in this application to classify non-profitable stocks as growth stocks, but it is a necessary tradeoff for classification purposes. It is appreciated herein that non-profitable growth stocks are typically found in either new industries (such as internet “Amazon.com”) and/or in companies offering innovative and/or disrupting new products and services (such as Tesla and Netflix). It is appreciated herein that not many stocks exhibit high non-profitable growth characteristics as making investment for growth for these companies only make economic sense for the above discussed reasons. Consequently, the growth-profitability factor may be a sufficient factor to be matched against the determined discount rate in the “growth” portfolio selection process.

Having discussed the growth and the profitability factors we now turn to the discount rate. One potential disadvantage using the determined discount rate as hurdle rate is that it comprises the risk free rate. If the risk free rate increases (decreases) the discount rate also increases (decreases). For instance, if the risk free rate increases (e.g., due to inflation concerns) the discount will also increase, all else equal, which may lead to that the determined discount rate may exceed a company's profitability rate (or alternatively growth-profitability rate) for a number of stocks in a growth portfolio at the time of rebalancing a growth portfolio. In other words, it is contemplated that the discount rate for a stock may move more over time than the profitability rate. It is appreciated herein that this may create an undesired migration effect across the classifications “growth” and “value” stocks, which in turn leads to higher transactions costs for a resulting growth investment portfolio over time.

To provide for a solution to this problem it may be advantageous to use a hurdle rate that do not include movements for the risk free rate. Instead of using the determined discount rate as the hurdle rate we may redesign the hurdle rate for this particular purpose. One such solution could be determining a hurdle rate by multiplying the determined volatile-per-unit-growth rate by the determined growth rate (or alternatively by the growth-profitability rate). Under this determination the hurdle rate would measure individual stocks heterogeneous fundamental value generating factors independent from the risk free rate. Table 13 below illustrates this determined hurdle rate across three hypothetical stocks with the same net earnings but with heterogeneous fundamental value generating factors.

TABLE 13

| Factors/Variables | Stock A | Stock B | Stock C |
|---|---|---|---|
| Market Value | $300.00 | $160.00 | $100.00 |
| Net Earnings (the Fundamental | $10.00 | $10.00 | $10.00 |
| Size Factor) | | | |
| Earnings Yield (E/P) | 3.33% | 6.25% | 10.00% |
| Price-Earnings Ratio (P/E) | 30.00 | 16.00 | 10.00 |
| Fundamental Value Generating | | | |
| Factors: | | | |
| Growth Rate | 15.00% | 5.00% | 5.00% |
| Deviation Rate (aka | 5.00% | 7.50% | 15.00% |
| Volatility Rate) | | | |
| Profitability Rate | 7.50% | 7.50% | 2.50% |
| Volatility Per-Unit Growth Rate | 0.33 | 1.50 | 3.00 |
| Hurdle Rate | 5.00% | 7.50% | 15.00% |
| Volatility Premium | 0.83% | 3.75% | 7.50% |
| Risk Free Rate | 2.50% | 2.50% | 2.50% |
| Discount Rate | 3.33% | 6.25% | 10.00% |
| Fundamental Value | $300.00 | $160.00 | $100.00 |
| Conventional Classification | Growth | Blend | Value |
| Method | | | |
| Profitability Rate => Hurdle Rate | YES | YES | NO |
| New Classification | Growth | Growth | Value |
| (as disclosed in this application) | | | |

The hurdle rate is determined by multiplying the determined volatility per-unit growth rate by the determined growth rate. As shown in the table 13 above, for Stock A the hurdle rate would be 0.33*15%=5%; for Stock B 1.5*5%=7.5% and stocks C, 3.0*5%=15%.

It is appreciated herein that the hurdle rate when determined without reference to a risk free rate may be more stable over time and for that reason avoids a potential higher level of migration across classifications “growth” vs. “value” portfolios due to changes in the risk free rate and thus also, at the time of rebalancing, the resulting growth investment portfolio would benefit from lower turnover and transactions costs due to a lower level of migration.

It is appreciated herein that a resulting growth investment portfolio benefits from multiple compensated factor premiums, high growth in revenues and earnings (high investments for growth), high profitability, low growth volatility (low downside risk), low valuation and high dividend growth. This is achieved by overweighting stocks that exhibit superior fundamental value generating factors, high dividends and low valuation. It is appreciated herein that by using a holistic multifactor method dividend payouts would be linked to a company's fundamental value generating process. This benefits dividend income seeking investors because a company that exhibits strong fundamental value generating factors also typically exhibits more stable and growing dividends. It is contemplated that such companies (typically) are mature growth stocks which exhibit moderate to slow growth in revenues and earnings but still exhibits a sufficient profitability rate and stable revenues and earnings (i.e., low growth volatility). It is further appreciated herein that net earnings (or a related fundamental size measures, such as earnings before interest, tax and amortization EBITA or the like) is an appropriate fundamental size factor to be discounted.

Free cash flow and dividends used in the conventional discounted cash flow models (DCF) and dividend discount model (DDM) are not appropriate fundamental size factors to be discounted. That is because valuation is linked to a company's investment policy and not its dividend policy. It is appreciated herein that companies that exhibits superior fundamental value generating factors also typically pay more consistent and growing dividends over time. In other words, companies that exhibits superior fundamental value generating factors (profitable growth stocks) also typically exhibits long term growth in dividends. Conversely, stocks that exhibit inferior fundamental value generating factors (i.e., unprofitable value stocks) tend to exhibit higher volatility and slow (if any) growth in dividends. It is contemplated that the best dividend stocks may be moderate to mature growth stocks.

It is appreciated herein that that the valuation factor is the predominant factor for long term investment performance. That is, fundamental value generating factors primarily affect the long term growth in a company's fundamental value and are thus unrelated to mispricing. Rather, mispricing (i.e., over or under valuation) of individual stocks (in a portfolio) is captured by overweighting stocks that exhibits a fundamental value that is greater than the stocks market price. Consequently, (and opposed to the conventional teaching) all stocks, regardless of they are classified as growth stocks or value stocks, large or small cap stocks, may be either over or underpriced by the market.

It is appreciated herein that a resulting portfolio is weighed based on individual stocks determined fundamental value and that stocks that exhibits superior fundamental value generating factors exhibits a higher fundamental value, it is appreciated herein that a resulting portfolio overweight's stocks that exhibit superior fundamental value generating factors, higher than average dividend growth and low valuation.

It is appreciated herein that higher growth in fundamental values generally also leads to higher market price appreciation for a resulting growth investment portfolio. Further, the resulting growth investment portfolio overweight's underpriced growth stocks and underweights overpriced growth stocks which furthermore improves over conventional growth indexes (portfolios). Moreover, the resulting growth investment portfolio may also benefits from improved returns from dividends as discussed above. That is because stocks that exhibit strong fundamental value generating factors (and thus also higher growth in fundamental values and market prices) typically also exhibit higher dividend growth and more consistent dividend payments. In other words, dividends payouts are tied to (on linked to) the fundamental value generating process within a company. Additionally, because growth stocks (tend to be, but not always) be underpriced stocks, growth stocks typically also benefit from higher levels of buybacks. It is appreciated herein that dividend and buybacks are NOT fundamental value generating factors but nonetheless add value for a company's stockholders for reason discussed in this application. It is furthermore appreciated herein that stocks that exhibits slow growth in revenues and earnings (such as mature growth stocks and value stocks) typically compensates its stockholders by paying dividends (as opposed to make investment for continued growth).

It is appreciated herein that conventional market cap weighted growth indexes (e.g., Russell 1000 Growth or S&P 500 Growth indexes), are designed as the inverse of value (i.e., by selecting stocks that exhibit high valuation multiples and high growth in revenues and earnings). Conventionally, growth stocks are interpreted as expensively (overpriced) priced stocks while value stocks are inexpensive (underpriced) stocks. It follows that more expensive stocks should underperform cheaper stocks. Unsurprisingly, traditional growth indices, inspired by this definition of growth, have underperformed historically.

In this application it is asserted that the conventional definition of growth and value is misguiding. It is appreciated herein that growth stocks cannot be labeled as overpriced (expensive) stocks and value stocks not as underpriced (inexpensive stocks). This misconception is related to the conventional argument that stocks exhibiting low valuation multiples (such as low P/E or P/B ratios) are underpriced and stocks that exhibit high valuation multiples are overpriced. It is appreciated herein that such arguments is based on a flawed reasoning.

Conventionally, growth and value indexes are defined by common valuation multiples, such as price-to-earnings ratio of the book to market ratio or a combination of similar ratios. In this application it is appreciated that these common valuation multiples do not indicate mispricing, but rather indicate investors assessment of individual stocks risk and growth (reward) characteristics (see earnings yield and discount rate discussion herein). Hence, it is appreciated that the conventional method for bisecting a broad investment universe into value and growth indexes is effectually based on the size of the discount rate, rather than on valuation (i.e., under or overvaluation due to mispricing). It is appreciated herein that various embodiments as disclosed herein provides for a solution to this problem.

It is appreciated herein that the according to some embodiments, a system (and method) determines if a stock (or a portfolio of stocks) is mispriced by comparing the determined fundamental value to the stocks market price. The determined fundamental value represents an improved method (improved accuracy over existing methods) in assessing an the true value of a stock, by considering not only a fundamental size factor (such as net earnings “E”) but by also consider the stocks heterogeneous fundamental value generating factors, such as heterogeneous growth, profitability and volatility, independent from the market price “P”, i.e., independent from investors assessment, the market price. It is appreciated herein that if stock markets where efficient (i.e., in accordance with the efficient market hypothesis “EMH”) a stock's (and a portfolio's) fundamental value would match (equal) its market price. Hence, if the determined fundamental value deviates from the market price for individual stocks and for a portfolio as a whole would indicate mispricing by the market.

It is appreciated herein that the some embodiments improve on the conventional method of selecting and weighting a growth indexes by allowing for overweighting underpriced growth stocks and underweighting overpriced growth stocks. Moreover, a resulting growth portfolio offers investors a very similar investable opportunity set as conventional market cap weighted growth indexes, and for that reason benefit from high liquidity, high investment capacity and low turnover costs. It is appreciated herein that no existing smart beta, single or multifactor portfolio (index), can achieve the above benefits.

It is appreciated herein that the steps performed in the various exemplary embodiments in this application should be characterized by the comprehension of the steps as intimately interconnected (holistic) and explicable only by reference to the whole. In other words, the utility of the invention explained by solutions to problems in the technical field is solved by the various exemplary embodiments and where the solutions can only be comprehended by utilizing all the steps, i.e., in an ordered combinations of steps, to recite a practical application. It is furthermore understood that some embodiments are directed to particular solutions to particular problems and a particular way to achieve a desired outcome in the field of passive asset management-requires computer technology to achieve the desired outcome.

It is appreciated herein that the computer system achieves desired utility by operating in real time to achieve the desired outcome. It is appreciated herein that in order to capture the valuation premium, as defined as the difference between a stocks determined fundamental value (and its related index weight) and the stocks most recent market value, the system must operate in real-time. That is because the market price is a real time factor. In other words, it is appreciated herein that the market price move in real time and for that reason the valuation premium (i.e., the difference between a stocks determined fundamental value and its market price) is a real time factor. It is appreciated herein that the valuation premium may be positive (i.e., indicate underpricing) or negative (indicate overpricing).

In this application a financial object may refer to data received from a proprietary database and stored in a multidimensional array. Financial objects may further refer to accounting based fundamental data, financial ratios, bond market data, bond yields, Treasury yields, stock market data and the like.

In some embodiments as described herein, the following describes some terms as used herein, and in some embodiments, such terms may have different meanings, such as the common meaning is understood in the art. It should be appreciated that some embodiments may use their common meaning unless recited to the contrary.

In this application (t0) represent present time; (t−n) is a point in time in the past; (tn) is a point in time in the future.

The term Fundamental Value refers to the value of a company, or stock, determined through fundamental analysis without reference to a market price. It may also be referred to an intrinsic value or simply a fair value.

The term Universe of Stocks or Investment Universe refers to a group of stocks in domestic or globally markets. An investment universe of stocks may include all listed stocks in the US or in global markets. An investment universe may also be an index, such as the S&P500, the Russell 1000, Russell 1000 Growth, Russell 1000 Value or Wilshire 5000 Total Market or MSCI World Index. It may further refer to the capitalization of stocks, such as large, mid or small cap-stock universes or investment styles, such as value, blend or growth stocks. An investment universe may also be referred to as an investable opportunity set.

In this application, the term tracking error refers to how closely portfolio weights correlate to standard market cap-weights, which is the benchmark. A high tracking error results in higher turnover costs, such as higher two-way transactions costs. A low tracking error results in lower turnover costs. A tracking error of zero (0) means that a portfolio has the same weights as a market cap-weighted portfolio (the benchmark).

A market cap weighted portfolio represents investor's collective (i.e., the markets) option of individual stocks fundamental value (i.e., intrinsic or fair value). All investors can invest in a market cap weighted without capacity constraints. Hence, a market cap-weighted index equilibrium prices provide for an unprecedented (high) liquidity, (high) investment capacity and (low) annualized turnover (if any). It is appreciated herein that turnover costs (i.e., a two way transaction cost) only occur when a market cap weighted index is reconstituted, i.e., when new stocks are included or excluded from the index.

A cap weighted index (the benchmark) represents an investable opportunity set that reflects investor's opinions about individual stocks fundamental fair values. It is appreciated herein that a market cap weighted index overweight's large cap growth stock and underweights small cap value stocks. It is appreciated herein that various embodiments in this application represents a similar investable opportunity set as a market cap weighted index, that is the present invention resulting portfolios overweight large cap growth stocks and underweight small cap value stocks and further exhibit high liquidity, high investment capacity and low transactions costs. It is furthermore contemplated that existing smart beta indexes, such as fundamental weighted indexes, equal weighted indexes, single and multifactor indexes, low volatility indexes, dividend income indexes, etc., do not represent a similar investable opportunity set available investors in market cap weighted indexes and for that reason exhibit, liquidity constraints, such as lower liquidity in stocks that comprises these indexes, which further leads to investment capacity constraints, i.e., not all investors can invest in these indexes, and when, what is known as overcrowding, occurs in these smart beta indexes the indexes factor exposures becomes expended, exposing investors to unintended suboptimal factor exposures. For example when too many investors and too much capital are invested in value indexes, these indexes becomes overpriced, which opposes the index objective, that is value indexes intend to provide exposure to cheap or underpriced stocks. Another example is low volatility and high dividends indexes, which intend to provide exposure to safe (low risk) stocks and high dividend paying stocks. However, when these indexes becomes overcrowded, the stocks becomes overpriced which may cancel out the intended premiums of low risk and high dividend income. Further, exiting smart beta indexes have higher transactions costs (than market cap weighted indexes) due to higher tracking errors and thus have higher turnover rates (i.e., higher two way transaction costs). In other words, not all investors can invest in existing smart-beta because these indexes does not provide for a similar investable opportunity set as standard market cap weighted indexes which results in higher implementation costs, such as liquidity constrains, limited investment capacity, and higher transactions costs.

A simple example illustrates the advantage of a market cap weighted index and disadvantages of existing smart beta indexes (in term of capacity constraints). Consider a $10 million market capitalization composed of only two stocks: $8 million of Stock 1 and $2 million of Stock 2. A cap-weighted index of this market, will assign 80% weight to Stock 1 and 20% weight to Stock 2, and would have three desirable properties. First, such market cap weighted index would properly represent the investment opportunities available to investors, reflecting the fact that the investable opportunity set is highly skewed toward Stock 1. Second, the market cap weighted index would show the returns of the average investor; some investors may obtain higher returns and some lower returns, but on average they would obtain the return of this market cap-weighted benchmark portfolio. And third, it would enable all investors to link their portfolios to this benchmark at current market prices; that is, the index weights in this benchmark are at equilibrium values. Assume that the two company's Stocks 1 and 2 exhibit the same earnings and pays the same dividends. Consider an alternative smart beta portfolio weighted by these fundamental measures. A fundamental weighted index and a dividend weighted index, would give a 50% weight to each stock, and that would lead to three problems. First, the 50-50 weights would not properly represent the investment opportunities available to investors; at current prices, the investable opportunity set simply does not have equal amounts of Stocks 1 and 2. Second, the index would not reflect the returns of the average investor. And third, not all investors could link their portfolios to this portfolio; an attempt to do so would imply substantial changes in the prices of both stocks. It is thus clear, that smart beta indexes (such as for example fundamental or dividend weighted indices) does not represent a similar investable opportunity set as inherent in market cap weighted indexes and therefore suffers from capacity constraints as not all investors can invest in these smart beta indexes.

The term “smart beta”, in this application, refers to portfolio weighting that is not market cap weighted. In other words, in a smart beta portfolios individual stocks portfolio weights are not linked to the market price (i.e., market capitalization). Rather, smart beta portfolios may be weighted based on a single factor (typically so called factor anomalies to the CAPM and/or the EMH) or multiple factors. A smart beta index may also be referred to a factor index or multifactor index.

In this application the term investment portfolio (or simply a portfolio) refers to an investable portfolio that is constructed using a holistic multifactor method for selecting or weighting a portfolio of securities as disclosed in this application and in various exemplary embodiments. It is appreciated herein that in this application the term portfolio and the term index, indexing, indexation and the like generally mean a portfolio of securities that is based on a computerized, systematic, and/or rules based process for selecting and weighting an investment portfolio.

The term data or data objects or data metrics and the like refer to various financial data that is used in the various exemplary embodiments in this application. In various exemplary embodiments financial data is obtained from one or more proprietary databases, which may be maintained by financial institutions and/or by third party data provider. Financial data is updated in real time to ensure timeliness. Proprietary databases are constantly updated and accordingly updated data may be constantly (in real time) received from these proprietary data bases. In order to create a resulting investment portfolio, as disclosed in the various exemplary embodiments in this application, the system communicate with one or more databases which provides the required data feeds.

The term “fundamental size factor” refers to accounting based data found a company's income statement, balance sheet, cash flow statement and the like. A fundamental size factor may be a company's last reported revenues, earnings before interest and taxes, net earnings, cash flow, book value (shareholders equity), dividends, etc. Fundamental size factors may be reported quarterly, annually and/or on a trailing twelve months (TTM) basis. A fundamental size factor may also be referred to as a fundamental metric in this application. A composite of fundamental size factors may be an equally weighted average of two or more fundamental size factors. In a preferred embodiment a company's last reported trailing twelve months (TTM) net earnings is the fundamental size factor to be discounted. It is appreciated herein that fundamental size factors may be received from a third part proprietary database, e.g., Compustat, Thomson Reuters DataStream, Bloomberg, or FactSet. It is appreciated herein that such database providers operate in an oligopoly market and that access to proprietary database requires a subscription. It is further contemplated that systems and methods as disclosed in the various embodiments in this application receive and process financial data provided from one or more fully maintained (real time) proprietary databases.

The term “growth rate” refers to a measure of historical (or demonstrated) growth in one or more fundamental size factors and/or related financial metrics over an ex post period (historical) of time. The growth rate may be determined by calculating the growth rate based on a composite average of a multiple fundamental size factors; such as a company's (i) book value, (ii) revenues, and (iii) net earnings. An ex post growth measurement may be based on a company's quarterly data or alternatively annual data which may be a based on calendar year or fiscal year data. A sufficient ex post period may be a three to six calendar years period. The growth rate may be based on four calendar years data and where trailing twelve month (TTM) data, is used for the most recent period. Alternatively the growth rate is based on an average profitability rate over an ex-post period of time. A profitability rate (or factor) may be a company's return on equity (ROE), return on assets (ROA), return on invested capital (ROIC) or similar profitability factors. The growth rate may furthermore be based on a combination of fundamental size factors and profitability factors. The advantage of using one or more profitability factors in determining a growth rate is that it provides for an adjustment for profitability, which is contemplated to be a paramount factor for a company to sustain a long term growth rate as discussed in this application. It is appreciated herein that the risk free rate constitutes the growth rate for a risk free asset. A growth rate may be determined based on a compounded annual rate (CAGR), an average rate, a mean rate, a median rate or a mode rate. In a preferred embodiment the growth rate is determined as the composite average of two fundamental size factors (i) revenues, (ii) net earnings and one profitability factor (iii) return on assets (ROA) for an ex post period of time. Table 14 below illustrates the step of determining a growth rate for one stock, exemplified by Johnson & Johnson (a US large cap company) using data from FactSet.

TABLE 14
illustrates the step of determining a growth rate, exemplified by Johnson & Johnson (J&J)
Amounts in $ million: Data: FactSet

| Ref. | | | | | | | | |
|---|---|---|---|---|---|---|---|---|
| Nbr | Data | J&J | 2013 | 2014 | 2015 | 2016 | TTM | AVG. |
| 1 | Received data | Revenue | $71,312 | $74,331 | $70,074 | $71,890 | $72,174 | $72,117 |
| 2 | Received data | Net Income | $13,831 | $16,323 | $15,409 | $16,540 | $16,505 | $16,194 |
| 3 | Received data | Dividend Paid | $7,286 | $7,768 | $8,173 | $8,621 | $8,723 | $8,321 |
| 4 | Received data | Stock Repurchase | $3,538 | $7,124 | $5,290 | $8,979 | $9,932 | $7,831 |
| 5 | Determination | Composite | $42,572 | $45,327 | $42,742 | $44,215 | $44,340 | $44,156 |
| | | Average (ref. 1 &2) | | | | | | |
| 6 | Determination | YOY Growth | | 6.47% | −5.70% | 3.45% | 0.28% | 1.12% |
| | | Rate | | | | | | |

| | | | | | | | |
|---|---|---|---|---|---|---|---|
| 7 | Received data | Profitability - Return on | 12.41% | 11.68% | 12.05% | 11.75% | 11.97% |
| | | Assets (ROA) | | | | | |
| 8 | Determination | Composite Average Growth- | 9.44% | 2.99% | 7.75% | 6.02% | 6.55% |
| | | Profitability Rate (ref. 6&7) | | | | | |

The volatility per-unit growth rate may also in this application be referred to as a risk per-unit reward rate. The term “rate” may also be referred to as a “factor” or a “factor rate” in this application. The volatility per-unit growth rate is determined by calculating a deviation rate of the growth rate for a given stock for an ex-post period of time (t0-t−n), and then dividing the calculated deviation rate by the determined growth rate. The deviation rate may be calculated as the standard deviation or the semi deviation of the growth rate. It may be preferred to exclude the profitability factor when calculating the deviation rate. Hence, the deviation rate may be calculated on a composite average measure of (i) revenues and (ii) net earnings. It is appreciated herein that by dividing the determined volatility per-unit growth rate by the determined growth rate provides for a two dimensional view of risk. That is, it is not only the volatility of the growth rate (the deviation rate) that is considered but also the growth rate itself. It is appreciated herein that if a company exhibits a high growth rate and a low deviation rate (and thus a low volatility per-unit growth rate, a low volatility premium and discount rate) the company exhibits a strong fundamental value generating process, i.e., these factors in combination provides for high and consistent growth in the company's fundamental value.

The volatility premium may be determined by multiplying the Volatility Per-Unit Growth rate with (by the) the Risk Free Rate. By multiplying the Volatility Per-Unit Growth rate with (by the) the risk free rate, establishes a coherent link between risky assets (e.g., stocks) and risk free assets (e.g., Treasury Bonds). It is appreciated herein that risky assets exhibits volatility (i.e., a deviation rate) and thus exhibit downside risk while risk free assets by definition do not exhibit volatility, i.e., no downside risk. Hence, a risk free asset exhibits a zero volatility per-unit growth rate and as a result the volatility premium for risk free assets is zero. It is further appreciated herein that the yield of a risk free asset may represent the risk free assets growth rate. Table 15 below illustrates the volatility per-unit growth rate and the volatility premium across two hypothetical stocks (risky assets) and one risk free asset.

TABLE 15
The volatility premium across two risky
assets (stocks) and one risk free asset

| | | | Risk Free |
|---|---|---|---|
| Factors/Variables | Stock A | Stock B | Asset |
| Growth Rate (Yield) | 5.00% | 15.00% | 2.50% |
| Deviation Rate | 15.00% | 5.00% | 0.00% |
| Volatility Per Unit Growth Rate | 3.00 | 0.33 | 0.00 |
| Risk Free Rate | 2.50% | 2.50% | 2.50% |
| Volatility Premium | 7.50% | 0.83% | 0.00% |

As illustrated in the table 15 above the volatility premium is higher for securities that exhibit a higher volatility per-unit growth rate. Hence stock A (the hypothetical value stock) exhibits a higher volatility premium than stock B (the hypothetical growth stock). The risk free asset by definition exhibits zero volatility per-unit growth rate and volatility premium. It is appreciated herein that the volatility per-unit growth rate and the volatility premium provides for a coherent measure of risk (as measured by volatility of the growth rate) across the asset classes equity securities (stocks) and fixed income securities (bonds). It is appreciated herein that the volatility per unit growth rate may be expressed in either percentage or as a number (factor) as shown in table 15 above.

The discount rate is determined by adding the volatility premium to the risk free rate. The discount rate (or discount factor) hence proxy both unsystematic (i.e., stocks specific risk) and systematic risk (i.e., risk that affects all stocks). It is appreciated herein that the risk-free-rate proxy systematic risk and the volatility premium unsystematic risk (company specific risk). The risk free rate may further proxy inflation risk. It is appreciated herein that the volatility per-unit growth rate, the volatility premium and the discount rate, as determined in this application, provides for a solution to known problems inherent in conventional risk measures, such as the CAPM and the standard deviation (SD).

In is appreciated herein that the discount rate, as disclosed in this application, provides for a holistic multifactor technique that allows to determine a discount rate and a fundamental value for stocks that exhibit high valuation multiples, such as a high PIE ratio. The fundamental value in turn allows determining the valuation premium (as measured by the difference between a stocks determined fundamental value and its market price). The discount rate furthermore allows determining a hurdle rate which when used to compare to a stock's determined profitability rate allows for bisecting an equity investment universe into growth and value portfolios based on economic rationale as discussed in this application.

The discount rate comprises of fundamental value generating factors, growth (investment), profitability and low growth volatility, combined in a volatility per unit growth metric in determining a volatility (risk) premium and when combined with the risk free rate determines a discount rate that considers both company specific risk (the volatility premium) as well as macroeconomic risk (the risk free rate).

It is contemplated that a company that exhibits higher growth, higher profitability and lower growth volatility also exhibits a low volatility premium, a low discount rate and a high fundamental value. Conversely, a stock that exhibits lower growth, lower profitability and higher growth volatility also exhibits a high volatility premium, a high discount rate and a low fundamental value. It is furthermore contemplated that the volatility premium (and thus also the discount rate) allows to explain risk and reward across stocks that exhibit heterogeneous fundamental value generating factors, i.e., heterogeneous growth, profitability and growth volatility. It is furthermore appreciated herein that stocks that exhibit stronger fundamental value generating factors may be referred to as “growth stocks” and stocks that exhibit weaker fundamental value generating factors may be referred to as “value stocks”. It is appreciated herein that the methods as discoursed in this application, allows for a classification system that in the process of bisecting a broad equity universe into growth and value portfolios making the conventional style label “blend” stocks redundant. Hence, the resulting portfolios would benefit investors by adequately classify blend stocks as either growth or value stocks based on fundamental value generating factors as disclosed in this application.

It is appreciated herein that the discount rate provides for a solution to the long lasting “value premium puzzle” in finance. Contrary to conventional methods the system, and method, as disclosed herein, allows to explain expected returns (valuation premiums) across stocks exhibiting heterogeneous risk and growth (reward) characteristics. It is appreciated herein that the conventional capital asset pricing model (CAPM) and the standard deviation (SD) cannot achieve these important objectives in asset pricing.

It is further appreciated herein that the discount rate proxy a company's hurdle rate, which may also be referred to as a required return or cost of capital. The discount rate may be used to classify stocks as either growth or value stocks. If a company exhibits a discount rate that exceeds the company's profitability rate the stock is classified as a value stocks. All remaining stocks comprising a broad investment universe will consequently be classified as “growth” stocks. This classification system improves over the conventional classification system by eliminating so called “blend” stocks and thus providing for a more business like method for style classification of stocks. As a result, some embodiments described herein provide for a new and improved system and method for creating growth and value investment portfolios. It is appreciated herein that the classification system, as disclosed in this application, for bisecting a broad equity universe (e.g., Russell 1000) into a growth and a value investment portfolio provides for a more accurate and more economically sound, and business-like approach.

It is appreciated herein that a company's profitability rate must equal or exceed (equal or be greater than) the company's determined discount rate in order for the company to be able to justify for additional and continued investments for growth. For example, if a company's profitability rate (e.g., return on assets) is 5% and the determined discount rate is 10% then the company cannot justify additional or continued investments for growth. It is appreciated herein that in this application such a company would be classified as a “value” stock. Based on this rationale, it is understood that value stocks generally compensate its stockholders for this deficiency by paying dividends, i.e., providing its stockholders with a compensatory source of reward such as income (dividends). It this context, the discount is the required return (minimum profitability rate required) that investors demand (or require) for making additional and continued investments for growth in assets, revenues, and earnings.

A profitability factor refers to a class of financial metrics that are used to assess a business's ability to generate earnings as compared to its assets, expenses and other relevant costs incurred during a specific period of time. Examples of profitability factors are return on assets (ROA), return on equity (ROE) and return on invested capital (ROIC) and the like. A profitability rate may refer to an average profitability rate of a company measured over an ex post period of time. A profitability rate may furthermore be determined by a composite average of one or more profitability factors. The ex-post period of time over which an average is determined may correspond to the ex-post time period used to calculate the growth rate using one or more fundamental size factors. In a preferred embodiment a return on assets (ROA) is the profitability factor in determining a profitability rate.

The term “distributions” refer to dividends and stock repurchases paid and/or performed by a company over an ex-port period of time. Stock repurchases may also be referred to as “buybacks”. Distributions may be determined by adding (i) the most recent dividends paid by a company and (ii) the most recently performed stock buybacks by a company. In a preferred embodiment distributions are determined as (i) dividends plus (ii) buybacks as measured over a most recent trailing twelve months (TTM) period.

Book Value refers to a company's shareholders equity which is commonly defined as the difference between total assets of a company and its total liabilities. It is appreciated herein that a book value is an accounting based fundamental size factor.

A Risk Free Rate refers to the best competitive rate of return that does not involve taking a risk. Both the return of the original capital and the payment of interest are completely certain, i.e., carry no volatility. It is appreciated herein that a risk free rate may be a theoretical rate. In determining a risk free rate (it may be advantageous) to use a moving average of a risk free rate over an ex post period of time. The risk free rate may be a return (yield or rate) derived from a risk free asset. It is contemplated that the risk free rate may vary depending on which country (or geographic zone) an embodiment is implemented. In a preferred US embodiment, the ten-year US Treasury note yield represents the risk free rate.

A Risk Free Asset may refer to fixed income securities. A risk free asset may be a Treasury Security, such as treasury bills, treasury notes and bonds, inflation adjusted Treasury bonds (TIPS) but may further refer to a money market account or other asset that has a fixed return and the like. It is appreciated herein that Treasury Inflation-Protected Securities or TIPS provide protection against inflation. The principal of an inflation adjusted Treasury bonds increases with inflation and decreases with deflation, as measured by the Consumer Price Index. When an inflation adjusted Treasury bond matures, they are pay the adjusted principal or the original principal, whichever is greater.

Expected Return on Investment (Expected ROI): may be determined by dividing the determined fundamental value by a stocks market price. An investment margin may be determined either in absolute or in relative terms. It is appreciated herein that an expected return on investment for a stock may be either positive or negative. It is further appreciated herein that an expected return may further be referred to a positive or negative valuation premium.

The term value (or values) may also be referred to as a fundamental value, volatility adjusted value, and the like or portfolio or index weight in this application. Further, a value may be referred to as a financial object.

In this application, a fundamental value for a security (such as stocks) may be determined as the higher of 1) an earnings based fundamental value, which is determined by discounting an earnings based fundamental size factor (e.g., net earnings) and 2) a book value, (a fundamental size factor). Further, as disclosed herein, both these fundamental values my include distributions. It is understood (from an accounting perspective) that an earnings based fundamental size factor is received from company's income statement and the book value from a company's balance sheet. Fundamental size factors may also be referred to as factor data. It is understood that factor data are obtained from one or more proprietary data bases, which may further be referred to data sources in this application.

A Common Constituent Weight (CCW) refers to a fixed and one time portfolio weight that are added for each security's determined portfolio weight in an investment portfolio. A CCW may be added to a determined fundamental value (that may further include distributions) (or other portfolio weight) for each stock in a portfolio of stocks for the purpose of reducing concentration risk by smoothening (or rescale) the portfolio weights in a portfolio. The advantage of a CCW is that it reduces concentration risk in an investment portfolio. A CCW can be of any size. The greater (or higher) the CCW is, the higher the smoothing and lower the concentration risk (i.e., the higher the CCW, the closer the portfolio weights becomes to resemble an equal weighting). To illustrate, consider a portfolio comprising of three stocks with the following determined fundamental values, stock A $100, stock B $50, and stock C $10. The total portfolio weight for the stocks is consequently $160. Such a portfolio would be highly concentrated in Stock A. In order to reduce this concentration risk across the three stocks a CCW of $100 may be added to each stocks determined fundamental value. Table 16 below illustrates a Common Constituent Weighting (CCW) across three hypothetical stocks.

TABLE 16
Common Constituent Weighting (CCW) of $100

| | | | | Adj. Index | |
|---|---|---|---|---|---|
| | Determined | | | Weight | (New) Adj. |
| | Fundamental | Index | | (FV + | Index |
| | Value (FV) | Weight % | CCW | CCW) | Weight % |
| Stock A | $100 | 62.50% | $100 | $200 | 43.50% |
| Stock B | $50 | 31.30% | $100 | $150 | 32.60% |
| Stock C | $10 | 6.30% | $100 | $110 | 23.90% |
| Total | $160 | 100.00% | $300 | $460 | 100.00% |

As illustrated in table 16, the CCW reduces the concentration risk by lowering the relative weight for stock A and increasing the relative weights for stock B and C. It is appreciated herein that a CCW adjusted investment portfolio improves over an equal weighted portfolio by allowing smoothen portfolio weights while still providing an exposure to growth stocks, i.e., exposure to fundamental value generating factors. This is achieved by keeping the CCW weight constant over time, i.e., not making any changes to the CCW. This provides for cost benefits as compared to the conventional equal weighted portfolio which exhibits high implementation costs (i.e., high turnover costs). It is understood that an equal weighted portfolio tilts towards value stocks, i.e., stocks that exhibit a higher discount rate (i.e., inferior long term fundamental value generating factors). It is appreciated herein that investors (asset managers) may prefer growth portfolios over value portfolios when considering these two investments styles. Hence, it is appreciated herein, that the teaching in this application departs from the conventional view (teaching), which asserts that value portfolios would be preferred over growth portfolios because value portfolios comprise of underpriced stocks and growth portfolios comprise of overpriced stocks and thus value portfolios would be preferred for long term investors.

Another important advantage of CCW adjusted portfolios is that they do not require frequent rebalancing. A CCW portfolio may be rebalanced once every three years, or five years or even once every ten years. It is appreciated herein that a CCW adjusted portfolio benefits investors by allowing for a significantly lower implementation costs, i.e., lower transactions costs related to rebalancing the portfolio, as compared to conventional equal weighted indexes, which requires frequent rebalancing to maintain an equal weight and for that reason exhibits high implementation costs. Table 17 below illustrates a Common Constituent Weighting (CCW) of $1000 across the same three hypothetical stocks.

TABLE 17
Common Constituent Weighting (CCW) of $1000

| | | | | Adj. Index | |
|---|---|---|---|---|---|
| | Determined | | | Weight | (New) Adj. |
| | Fundamental | Index | | (FV + | Index |
| | Value (FV) | Weight % | CCW | CCW) | Weight % |
| Stock A | $100 | 62.50% | $1,000 | $1,100 | 34.81% |
| Stock B | $50 | 31.25% | $1,000 | $1,050 | 33.23% |
| Stock C | $10 | 6.25% | $1,000 | $1,010 | 31.96% |
| Total | $160 | 100.00% | $3,000 | $3,160 | 100.00% |

As illustrated in table 17 above, a higher CCW (now $1000 as opposed to $100) further reduces concertation risk in an investment portfolio. Such CCW adjusted investment portfolio may only be rebalanced every firth or tenth year which provides for improved implementation costs over conventional and existing methods. It is further contemplated that a common constituent weight (CCW) may not only be added to a determined fundamental value as illustrated in table above, but may also be added to a market cap-weight and the like.

A Forward Looking Fundamental Value may be determined by multiplying a company's current fundamental value with ((1+the determined growth rate)\hat{ }number of periods). It is appreciated herein that a forward looking fundamental value may be adventurous over a present determined fundamental value as the forward looking fundamental value by further considering an additional weight favoring stocks that exhibit stronger long term growth rates, i.e. stocks that exhibit stronger fundamental value generating factors.

The term “valuation premium” refers to the higher expected return of stocks that exhibit a determined fundamental value that is greater than its market price. The valuation premium for a stock may be determined by subtracting the stocks market price from its determined fundamental value. A positive valuation premium indicates undervaluation and a negative valuation premium indicate overvaluation. Table 9 illustrates the valuation premium across 50 large cap growth stocks.

An “active valuation weight” for a stock may be determined by adding the valuation premium to the stocks determined fundamental value or alternatively its volatility adjusted fundamental size factor and the like. Such an active valuation weight allows for further increasing the portfolio weight for stocks that are underpriced by the market and decreasing the portfolio weight for stocks that are overpriced by the market, i.e., providing additional exposure to the valuation premium in underpriced stocks in a resulting investment portfolio. Table 18 below illustrates the valuation premium and active valuation weights across three hypostatical stocks.

TABLE 18
Active Valuation Weight

| | Determined | | Valuation | Active Valuation |
|---|---|---|---|---|
| | Fundamental | Market | Premium (3) | Weight |
| | Value (1) | Value (2) | (1 − 2) | (1 + 3) |
| Stock A | $100 | $80 | $20 | $120 |
| Stock B | $100 | $100 | $0 | $100 |
| Stock C | $100 | $120 | ($20) | $80 |
| Total | $300 | $300 | $0 | $300 |

It is appreciated herein that an active value weighting system may be employed in various embodiments of the present invention.

A stocks portfolio weight refers to an absolute or relative composition of a particular asset in a portfolio. The determination of a portfolio's relative weight (for each stock on the plurality of stocks) is computed by dividing the fundamental value by the stocks determined fundamental value. For example, Stock A has a fundamental value of $400 and the total portfolio's fundamental value is $2,000. The portfolio weight of stock A would be 20%. (400/2,000=0.20 or 20%). A portfolio weight may also be referred to as an index weight.

Asset allocation refers to allocating risky assets (stocks) to fixed income securities (risk free assets) in an investment portfolio when individual stocks are overpriced by the market. Conversely, asset allocation may mean replacing fixed income securities with stocks (at a time when) stocks are underpriced by the market. Asset allocation benefits investors by reducing downside risk based on valuation. More particularly, a stock is allocated (or replaced by) to a fixed income security (e.g., 10 year Treasury notes) when the stocks market price exceeds the stocks determined fundamental value (or other portfolio weights discoursed in this application). Conversely, a fixed income security is replaced by a stock when the stock become underpriced by the market, i.e., when the stocks determined fundamental value is greater than its market price. Hence, the relative composition between stocks and bonds in an investment portfolio is based on the market valuation of individual stocks comprising the portfolio. An asset allocation may occur at the time the investment portfolio is rebalanced. It is appreciated herein that the term asset allocation may mean replacing stocks with risk free assets in order to reduce long-term downside investment risk. It is appreciated herein that when a stock (or group of stocks) within an investment portfolio exhibit a market price that is greater than a stocks determined fundamental value the stock may be considered overvalued. In this situation it may be advantageous to replace the overpriced stocks determined fundamental value (or other determined index weight as disclosed in this application) with risk free assets of an equal value at the time of rebalancing. Table 19 illustrates asset allocation across two hypothetical stocks.

TABLE 19

| Factors/Variables | Stock A | Stock B |
|---|---|---|
| Net Earnings (Fundamental size | $10.00 | $10.00 |
| factor) | | |
| Growth Rate | 15.00% | 5.00% |
| Deviation Rate | 5.00% | 15.00% |
| Volatility Per Unit Growth Rate | 0.33 | 3.00 |
| Volatility Premium | 0.83% | 7.50% |
| Risk Free Rate | 2.50% | 2.50% |
| Discount Rate | 3.33% | 10.00% |
| Determined Fundamental Value | $300.00 | $100.00 |
| Market Value | $290.00 | $120.00 |
| Valuation Premium | $10.00 | ($20.00) |
| Portfolio Weighting | $300.00 | $100.00 |
| Asset Allocation (Remain vs | Stock A | Stock B |
| Replaced) | (Remain) | (Replaced) |
| Portfolio Composition (Stocks | Stocks 75% | Risk Free |
| vs Risk Free Assets) % | | Assets 25% |

In table 19 above it is clear that Stock B exhibits a negative valuation premium and thus has a higher downside risk as it is overpriced by the market. Hence, it may be advantageous to replace stock B's determined fundamental value ($100) by risk free assets (e.g., Treasury bills) of an equal amount, i.e., $100, in order to reduce the downside valuation risk in an investment portfolio. As a result the investment portfolio would comprise of stock A's portfolio weight of $300 and risk free assets of $100 (i.e., the equal amount or value as stock B's determined fundamental value). Hence, as illustrated in table 19, the resulting investment portfolio would comprise of 75% stocks and 25% fixed income securities. It is appreciated herein that the present invention and its various embodiments may employ an asset allocation system as disclosed in this application. It is further contemplated that the asset allocation system and method, as disclosed in this application, improves over the conventional 60/40 rule of thumb method and the so called Fed model which allocates stocks to fixed income securities based on conventional valuation multiples, such as a stocks earnings yield (E/P) and Treasury yields.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware or with one or more processors programmed using microcode or software to perform the functions recited above.

In this respect, it should be appreciated that one implementation of the embodiments of the present invention comprises at least one non-transitory computer-readable storage medium (e.g., a computer memory, a portable memory, a compact disk, etc.) encoded with a computer program (i.e., a plurality of instructions), which, when executed on a processor, performs the above-discussed functions of the embodiments of the present invention. The computer-readable storage medium can be transportable such that the program stored thereon can be loaded onto any computer resource to implement the aspects of the present invention discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

In some embodiments and the processes and methods using holistic multifactor techniques for selecting and weighting a non-price investment portfolio, as disclosed in the various embodiments in this application, it is appreciated herein that the terms portfolio, resulting portfolio, index, indexing, indexation and the like refers to a computer based implementation of a systematic and rules based methodology for selecting and weighting individual stocks in a multifactor investment portfolio used in automated “passive” investment products, such as passive index funds, exchange traded funds (ETF's), trading systems, valuation systems or similar products. Rules based and systematic computer based portfolio construction and management is sometimes also referred to as factor or smart beta indexes, and users the use these indexes may be referred to as smart beta index funds or smart beta enhance traded funds (ETF's).

Although the invention has been described with reference to a particular arrangement of parts, features and the like, these are not intended to exhaust all possible arrangements or features, and indeed many other modifications and variations will be ascertainable to those of skill in the art.

It is appreciated herein, and as is known in the art, passive asset management and smart beta indexation rests on an automated process to achieve its desired objectives. This particular business discipline (a.k.a. the index fund industry) achieves unprecedented cost benefits which in turn lead to performance advantages over active asset management. Smart beta indexation further improves passive asset management by removing (human) behavioral biases and other systematic biases in standard market capitalization based indexes commonly used in passive asset management. Applicants claimed invention makes improvements in smart beta indexation by providing for a particular solution to problems known as systematic biases (or unintended factor biases) in smart beta indexation. One or more embodiments of the present invention improve smart beta indexation and automated asset management by providing for reduced implementation costs by the use of use a specific technique and computer technology.

It is understood that the various embodiments requires one or more proprietary data bases (data sources) that are connected to the portfolio management engine, as disclosed herein, to allow the system to perform the embodiments. Hence, it is understood that the methods and techniques as disclosed herein cannot be performed (merely) on a general purpose computer but rather requires a special purpose computer. Hence, it is clear that in some embodiments, a holistic multifactor method for portfolio management system (as a whole), as discussed herein, receives one or more proprietary databases (data sources).

It is appreciated herein that the claimed invention, as disclosed in the various embodiments, obtains data from one or more proprietary databases in the specific process of computing new improved index weights in smart beta indexation which allows for several improvements over existing system, methods and techniques. Hence, the present invention improves the technical filed (existing technology), by the use of a particular machine, and by improving the processes of selecting and weighting a smart beta portfolio which improves, accuracy, performance, liquidity, investment capacity and implementation costs. Hence, it is appreciated that the claimed invention, as discoursed in various embodiments herein, requires a particular machine (a special purpose computer) that is designed, configured using specialized hardware and proprietary software necessary to permit the claimed process (method) to be performed.

Various aspects of the present invention may be used alone, in combination, or in a variety of arrangements not specifically discussed in the embodiments described in the foregoing and are therefore not limited in their application to the details and arrangement of components set forth in the foregoing description or illustrated in the drawings. For example, aspects described in one embodiment may be combined in any manner with aspects described in other embodiments.

Also, embodiments of the invention may be implemented as one or more methods, of which an example has been provided. The acts performed as part of the method(s) may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

Some objects consistent with at least some aspects, as disclosed herein, is to improve passive asset management, by providing for particular solutions to problems in conventional industry practices, including, 1) determining portfolio weights for individual securities that allows for improving, a) tracking errors, liquidity, and implementation costs over existing solutions, b) allowing for improved performance by enabling capturing a valuation premium in all securities, i.e., independent of investment styles, growth, blend, value, large, mid or small cap stocks, 2) providing for a solution to problems in conventional industry practices of bisecting a broad equity universe into growth and value portfolios, providing for a solution to the bleeding problem in the conventional method, 3) providing for a solution to the problem of factor clashing when combining the conventional value factor with quality and performance factors, 4) providing for an improved method of asset allocation across stocks and risk free fixed income securities, 5) providing for a new and improved method for mitigating concentration risk, 6) providing for a particular method that allows for increasing the exposure to the valuation premium in equity markets.

The by the inventor considered innovative elements or claim or process steps or techniques and other related features (including teaching) are 1) the process, method and technique for determining the discount rate, and the fundamental value across stocks that exhibiting heterogeneous volatility, and growth factor characteristics, 2) the process, method and technique for determining a volatility adjusted fundamental size metric, allowing for controlling for individual stocks heterogeneous volatility and growth factor characteristics, 3) the process, method and technique for determining the valuation premium, 4) the process, method and technique for multifactor arrangement in determining a volatility premium across stocks that exhibits heterogeneous volatility, and growth factor characteristics, 6) the realization that the process of determining a discount rate should consider fundamental value generating factors, 7) the realization that dividends and buybacks are not fundamental value generating factors, but still adds value for investors, and thus should be considered in determining a fundamental value and consequent portfolio weights, 8) the realization that the growth (investment), profitability and low volatility factors are fundamental value generating factors that defines a risk (volatility) premium and which together with the risk free rate constitute a non-price based discount rate, 9) the realization that the risk (volatility) premium (as part of the discount rate) must consider both risk and reward factors simultaneously, and thus must be engineered into a volatility per unit reward metric, 10) the realization that reward factors, such as growth or profitability, contributes equally to the volatility factors index determining a risk (volatility) premium, 11) the realization that the discount rate (comprising fundamental value generating factors and the risk free rate) and profitability are the predominant factors that separates growth from value stocks, and which farther makes the standard label “blend” stocks redundant, 12) the realization that the determined discount rate and a profitability factor are useful elements (factors) in the process of bisecting a broad equity universe into growth and value indexes, 13) the realization that when fundamental value generating factors, when engineered into the discount rate, and when used in determining a fundamental value, reducing tacking errors and implementations costs, while improving capacity (reducing capacity constraints) relative existing smart beta indexes, 14) the realization that when the discount rate when engineered in a particular way, as disclosed herein, provides for a solution to the problem of factor clashing in existing multifactor indexes, 15) the realization that free cash flow and dividends (which are used in standard valuation models such as in the DCF and in the DDM) are not appropriate fundamental size factors to be discounted in the process of determining a fundamental value. 16) the realization that the equity-fixed income equilibrium volatility premium provides a coherent link across risky assets (stocks) and risk free assets (fixed income) which in turn allows for the construction of valuation based equity-fixed income asset allocation indexes independent from investment style considerations, 17) the realization that a common constituent weight (CCW), allows reducing concertation risk while (contrary to existing solutions) providing exposures to superior fundamental value generating factors, i.e., the resulting index retains an exposure towards large cap growth stocks, which provides for an improvement over conventional equal weighted indexes, 18) the technique of active valuation weighting that is allowing to improve index exposures to the valuation premium and fundamental value generating factors.

The above innovative elements or claim or process steps or techniques and other related features, as discoursed herein, improves over the conventional processes, methods, or techniques of determining portfolio (index) weights in investment (index) portfolios (be they market cap or smart beta indexes), growth and value portfolios, equal weighted portfolios, multifactor portfolios, asset pricing, valuation systems, policy making systems, trading systems and the like. Moreover, other techniques and systems disclosed herein, such as, constituent common weight (CCW), a simple method for reducing concertation risk while allowing for retained exposures to strong (superior) fundamental value generating factors is useful, when applied, not only to smart beta portfolios but also to market cap weighted portfolios. It is appreciated herein that a CCW portfolio improves over conventional equal weighted indexes which provides for opposite factor exposures, i.e., tilting towards (or overweighting) stocks that exhibit weaker (inferior) fundamental value generating factors.

Among its several aspects, the present embodiments provides a new method/technique for computers and software that enables to more accurately, (without errors) determining a discount rate and a fundamental value, (used as portfolio or index weights) that improve over conventional industry practices, and by further allowing for reduced tracking errors, reduce capacity constraints, improving liquidity, and more cost-efficiently managing passive investment portfolios, by reducing (two way) transaction costs (known as turnover costs) and speeds up user rebalancing (because less securities need to be traded both ways (i.e., selling and buying) which in turn reduces processing time, and memory usage.

These and other aspects of the invention are expanded upon throughout the specification. Aspects of the present invention address deficiencies in existing approaches and provide advantageous alternatives thereto so that new computer based processes, approaches, methods, tools and techniques are provided to users of various aspects as defined by the claims.

Some embodiments are being directed towards new and useful methods, by which computer technology can detect and remove systematics biases (human errors) inherent in conventional and existing methods. The same embodiments further improve smart beta (non-price based) indexation by allowing for a method that provides for a solution for unintended systematic bias (constructive errors) inherent in existing smart beta methods, while retaining high liquidity (ease of trade), high investment capacity (reduced investment constraints) and low annual turnover costs (improved cost efficiency due to reduced tracking errors). Hence, these embodiments are directed to a new method for determining index weights for individual securities in non-price based indexation that provides for a specific solution to problems inherent in existing methods and thus are directed to a new and useful end.

The embodiments, as disclosed herein, improves passive asset management by providing for specific solutions to problems in passive asset management which allows for improved cost efficiency in managing passive investment portfolio. It is understood that that passive asset management make use of specific computer based processes to achieve desired objectives. These objectives include, improving investment performance by allowing for reduced costs in managing investment portfolios. It is further understood that passive asset management opposes active (human) asset management. It is further understood that the specific processes, methods, techniques, as are disclosed herein, cannot be performed by humans (accurately, without prior art errors) and thus not as cost efficiently. It is furthermore understood the various embodiments herein improves existing technology by providing for a specific automation that improves over the manual (human) process performed by generic machinery. The various embodiments, as disclosed herein, provides for specific methods that improves over existing technology (computer implemented existing technology) in smart beta indexation and passive asset management to achieve improved accuracy, performance, liquidity, investment capacity and cost efficiency.

It is further appreciated that the embodiments, as disclosed herein, improves existing technology, i.e., smart beta indexation in automated passive asset management, and that the various embodiments are directed to a specific process that performs functions not previously performable by computers that provides for a solution to a technical problem (human and unintended systematic biases) in determining non-price index weights in smart beta indexation. Hence, the various embodiments, as disclosed herein, are directed to specific solutions to problems (biases) in existing technology and these new functions are thus not generic computer functions.

According to some embodiments, the specification makes clear that the focus of at least some inventive concepts is to improve on processes, methods, and techniques allowing to more sufficiently and more cost-efficiently systematically managing “smart beta” investment portfolios passive asset management. It is understood that passive asset management is inherently rooted in computer technology to achieve its desired objectives and benefits, such as allowing for increased cost efficiency. The embodiments, disclosed herein, provides for improvements in passive asset management by providing for solutions to problems, such as mitigating systematic bias inherent in standard market cap weighting and unintended factor bias in smart beta weighting. Further, the process is more accurate, performs calculations and ranking faster, and provides a better passive management system.

It is further appreciated that the present embodiments provides for a method to use a multidimensional array as a data storage and retrieval system and a computer memory, and means for configuring said memory according to a logical table, said logical table including: a plurality of logical rows, each said logical row including an object identification number (OID) to identify each said logical row, each said logical row corresponding to a record of information comprising a financial object, a plurality of logical columns intersecting said plurality of logical rows to define a plurality of logical cells, each said logical column including an OID to identify each said logical column providing the means for same beta indexing of financial objects stored in the multidimensional array.

Some embodiments of the present invention further improves existing passive asset management by providing for particular solutions to problems as discussed in this application. Thus, some aspects of the present invention improves conventional industry practices (i.e., existing technology) by providing for new processes, methods and techniques for selecting and weighting smart beta portfolios. It is appreciated herein that the processes, methods and techniques as disclosed herein are integral with computer technology to provide for improved implementations costs (cost efficiency) over existing processes, methods and techniques. Hence, it is clear from the specification that the invention depends on computer technology to provide the claimed benefits. Accordingly, the computer/apparatus is integral to the claimed method to sufficiently aid the method to achieve the desired result and thus provides for a practical application (i.e., the new and useful result) of the present invention. It is appreciated herein that the improvements over existing systems, results in an improved process, method, techniques which further provides for an improved user interface for electronic devices, allowing users to more accurately and more cost efficiently manage an investment portfolio (e.g., transformation of that raw data into a particular visual depiction of a physical object on a display).

Some embodiments of the present invention is directed to improvement in existing technology (computer related technology) by providing new functionality and capabilities that provides for specific solutions to problems and thus provides for an improvement in the functioning of a computer by providing for new improved technological processes. It is appreciated herein that the various embodiments, as disclosed herein, is directed to improvement in computer-related technology by allowing computer performance of functions not previously performable by a computer.

Further, it is appreciated herein that the portfolio management engine, as disclosed in at least some embodiments herein, are directed to a special purpose computer (a particular machine) which is designed and configured using specialized hardware, and proprietary software databases, which are necessary components to permit the claimed processes methods and techniques, as disclosed herein, to be performed. It is appreciated that the portfolio management engine plays a significant part in permitting the claimed processes, methods, and techniques to be practically performed. As such, the claimed invention cannot be practically performed unless connected to one or more proprietary databases (data-feeds) which is an essential requirement for the claim invention to be performed. Hence, it is understood that the portfolio management engine recites a particular machine, (a special purpose computer) which is a significant part in permitting the processes, methods or techniques as described in various embodiments to be performed.

Furthermore, it is understood that the claims and the embodiments, as disclosed herein, when considered as a whole, are directed to solutions to problems in conventional industry practices and thus the claims and embodiments provides for an improvement to existing technology, such as improving selecting and weighting smart beta index portfolios in such manner that it allows to achieve one of several expressly desired objectives as described herein. It is further appreciated that the various embodiments recite specific techniques, methods and processes, elements or process steps, and when considered in an ordered combination, are not well understood, routine and conventional activities in the industry. Rather, the various embodiments provide a clear and distinct improvement to existing technology or technical field. Hence, the embodiments and its limitations as a whole recite an inventive concept and thus more than the performance of well-understood, routine, and conventional activities previously known in the industry. It is appreciated that the present invention, as disclosed in various embodiments herein, enhances smart beta indexation and passive asset management by providing for an improved process over conventional and existing methods which provides for several important benefits in passive asset management as described in this application. It is the combination of elements, i.e., the claimed process or method, as a whole, that operates in an unconventional manner to achieve an improvement in computer functionality.

It should be noted that, while various functions, systems and methods have been described and presented in a sequence of steps, the sequence has been provided merely as an illustration of advantageous embodiment, and that it is not necessary to perform these functions in the specific order illustrated. It is further contemplated that any of these steps may be moved and/or combined relative to any of the other steps. In addition, it is still further contemplated that it may be advantageous, depending upon the application, to utilize all or any portion of the functions described herein. While embodiments of the present invention, have been described herein for purposes of illustration, modifications and changes will become apparent to those skilled in the art. Accordingly, the appended claims are not intended to encompass all such modifications and changes as fall within the true spirit and scope of this invention. While various embodiments of the present invention have been described in this application, it should be understood that they have been presented by way of example only, and not limitation. Thus, the breadth and scope of the present invention should not be limited by any of the above-described exemplary embodiments, but should instead be defined in accordance with the following claims and their equivalents. Further, while this invention has been particularly shown and described with references to example embodiments thereof, it will be understood by those skilled in the art that various changes in form and details may be made therein without departing from the scope of at least one embodiment encompassed by the appended claims.

What is claimed is:

1. A computer system for computing non-price based index weights for individual stocks and utilizing the determined index weights in non-price based indexation of an investable universe of stocks, said system comprising:
a computer connected to a communication network, said computer obtains through a proprietary database connected to the network real-time data associated with an investable universe of stocks, the computer storing obtained data in a multidimensional array, a storage medium connected to said computer and having a program stored thereon, the program executed by the computer in real time computing index weights for each given stock in the investable universe of stocks, by for each given stock automatically:
a. obtaining a net earnings, for each given stock at present time (t0), the net earnings being obtained from the multi-dimensional array in the storage medium;
b. computing a volatility per unit growth rate for the given stock at present time (t0); the computed volatility per unit growth rate being stored in the multidimensional array in the storage medium;
c. computing a discount rate for the given stock at present time (t0), independent from a price of the given stock, the computed discount rate being stored in the multidimensional array in the storage medium;
d. determining an earnings based fundamental value for the given stock at present time (t0); the earnings based fundamental value being computed exclusive of a price of the given stock, the earnings based fundamental value being stored in the multidimensional array in the storage medium;
e. determining a non-price index weight for the given stock by selecting the higher of, (i) the determined earnings based fundamental value and (ii) the book value for the given stock at present time (t0), such as the index weight is computed exclusive of a price of the given stock, the computed non-price index weight being stored in the multidimensional array in the storage medium in real time;
f. automatically ranking each given stock in the universe of stocks in descending order based on each given stocks determined non-price index weight at present time (t0);
g. transmitting non-price index weights, for each given stock, in the universe of stocks, at present time (t0), to users over the computer network in real time, so that each user, has immediate access to up to date non-price index weights;
the computer system according to the program automatically performs steps a. through g. for each given stock in the investable universe of stocks, resulting in: for each given stock the obtained net earnings is transformed to a non-price index weight independent of a market price of the given stock, and
wherein the computer system automatically in real-time updates the given stocks non-price index weight and stores the non-price index weight in the multidimensional array, resulting in indexation of stocks and in where each given stock is ranked in descending order based on each stock's determined non-price index weight.

2. The computer system according to claim 1, wherein the computed volatility per unit growth rate at present time (t0) is computed either on one or more fundamental size factors or one or more financial metrics for a period (t0-t−n).

3. The computer system according to claim 1, wherein the computed volatility per unit growth rate at present time (t0) is computed on a combination of one or more fundamental size factors and profitability metrics for a period (t0-t−n).

4. The computer system according to claim 1, wherein the computed volatility per unit growth rate at present time (t0) is based on a growth rate that is computed on a combination of revenues, net earnings and return on assets (ROA) for a period (t0-t−n).

5. The computer system according to claim 1, wherein the computed volatility per unit growth rate at present time (t0) is computed based on a standard deviation or semi deviation for the period (t0-t−n).

6. The computer system according to claim 1, wherein distributions during a period of time (t0-t−n) are included in the computed index weight for each given stock at present time (t0), the distributions being obtained from the multidimensional array in the storage medium.

7. The computer system according to claim 1, wherein the book value is either (i) the last reposted book value at present time (t0) or (ii) an average book value determined over a period of time (t0-t−n), the book value being obtained from the multidimensional array in the storage medium.

8. The computer system according to claim 1, wherein the operations further comprise replacing each given stock in the investable universe of stocks by fixed income securities at present time (t0), at a time a given stock's market price is greater than the stocks computed index weight.

9. The computer system according to claim 1, the operations further comprise instructions to adjust the index weight for each given stock in the investable universe of stocks by including a common constituent weight for each given stock, the common constituent weight being a constant value and the same constant value for each given stock, in the investable universe of stocks.

10. The computer system according to claim 1, wherein the computer system is configured to apply an active valuation weight at present time (t0) for each given stocks in the investable universe of stocks.

11. The computer system according to claim 1, further comprising computing a forward looking index weight at present time (t0).

12. The computer system according to claim 1, wherein the computer network further comprises a graphical user interface (GUI) configured to display the ranking based on each stock's determined non-price index weight.
